(19) United States
(12) Patent Application Publication
(10) Pub. No.: US 2024/0362898 A1
(43) Pub. Date: Oct. 31, 2024

(54) SYSTEMS AND METHODS FOR RESOLVING SALIENT CHANGES IN EARTH OBSERVATIONS ACROSS TIME

(71) Applicant: Impact Observatory, Inc., Washington, DC (US)

(72) Inventors: Steven P. Brumby, Washington, DC (US); Amy E. Larson, White Rock, NM (US); Melanie Corcoran, Mclean, VA (US); Peter Kerins, Washington, DC (US); Mark Mathis, Española, NM (US)

(21) Appl. No.: 18/634,502

(22) Filed: Apr. 12, 2024

Related U.S. Application Data
(60) Provisional application No. 63/458,870, filed on Apr. 12, 2023.

(51) Int. Cl. G06V 10/774; G06V 10/143; G06V 10/62; G06V 10/762; G06V 10/764; G06V 20/13

(52) U.S. Cl. CPC G06V 10/774; G06V 10/143; G06V 10/62; G06V 10/762; G06V 10/764; G06V 20/13

(57) ABSTRACT

Systems and methods are described for receiving, by processing circuitry, a plurality of maps of the geographic area, wherein each map of the plurality of maps is generated based on a respective plurality of overhead images captured during a respective portion of a time period, and each overhead image of the respective pluralities of overhead images comprises a respective plurality of pixels, and each pixel is designated as being of a particular mapping category of a plurality of mapping categories. The systems and methods may be configured to train, using the processing circuitry and the plurality of maps, the machine learning model to identify the expected distribution for the mapping categories of the geographic area at the given time.

### CROSS-REFERENCE TO RELATED APPLICATIONS

This application claims the benefit 35 U.S.C. § 119(e) of U.S. Provisional Application No. 63/458,870 filed Apr. 12, 2023, which is hereby incorporated by reference herein in its entirety.

### BACKGROUND

The present disclosure is directed towards an active learning artificial intelligence (AI) system to focus analyst attention on, and resolve salient changes in, Earth observations across time.

### SUMMARY

Over the last several decades, human-induced land use/land cover (LULC) change has affected ecosystems across the globe. LULC maps are foundational geospatial data products needed by analysts and decision makers across governments, civil society, industry, and finance to monitor global environmental change and measure risk to sustainable livelihoods and development. While there is an unprecedented amount of Earth observation imagery data available to track change, analyses must be automated in order to scale globally. In one approach, individual pixels of an image may be classified, e.g., based on a color of the pixel, and global maps having a resolution ranging from 30 meters per pixel to 500 meters per pixel are generated.

Decision makers in governments, defense, industry, finance, and civil society need to evaluate and understand how the world is changing to evaluate risk and anticipate threats to lives, assets, and livelihoods. Current Earth observation satellite constellations approaches attempt to satisfy this need by collecting many thousands of images per day, which then need to be analyzed and/or inspected for relevant change. When comparing images across time, the great majority of observed change is due to mundane variation in scene presentation due to at least three factors. The first factor includes mundane or expected variability of the surface due to seasonal factors including the growth stage of natural vegetation, the presence of temporary snow or surface water, and expected patterns of human activity in agriculture, forestry, or transportation. The second factor includes mundane variability from atmospheric conditions at the time of observation, including the presence of clouds, haze, or particulates. The third factor includes details of the geometry of each individual satellite observation including the relative angles of the Sun to the center of the observation on the surface, the topographic relief of the surface, and the orientation of the sensor on the satellite to the surface, causing some objects on the surface to appear brighter or darker than average, or other more complex effects specific to sensor modality, such as the “layover” distortion in synthetic aperture radar (SAR) imagery, or atmospheric absorption bands in hyperspectral images.

In one approach, technologically-advanced governments or companies employ large teams of human experts to manually task, inspect, and analyze the changes detected in satellite imagery for their specific areas of interest, such as an oil and gas plant, a timber plantation, or a defense installation. However, the number of human image analysts is too limited to keep up with the flood of Earth observation data as the areas of interest expand, up to and including monitoring of the whole world. The recent introduction of commercial Earth observation satellite constellations across a range of sensor modalities (optical, radar, lidar, thermal, and hyperspectral), at moderate or better spatial resolution (<10 m/pixel) and at weekly or better observational cadence has made the need for new ways of dramatically increasing analysis capacity essential.

To help overcome these problems, systems, methods, computer program products, and apparatuses (collectively referred to as “a mapping system”) are described herein for focusing analyst attention on (and/or automatically resolving) relevant changes across a time sequence of geospatial observations using a variety of techniques. In some embodiments, improved high-level, automated geospatial analysis solutions are provided for better converting the abundant pixel data into actionable insights for non-geospatial experts.

In some embodiments, the mapping system may be configured to train a machine learning model to identify an expected distribution of mapping categories for a geographic area at a given time, by receiving, by processing circuitry, a plurality of maps of the geographic area, wherein: each map of the plurality of maps is generated based on a respective plurality of overhead images captured during a respective portion of a time period; and each overhead image of the respective pluralities of overhead images comprises a respective plurality of pixels, and each pixel is designated as being of a particular mapping category of a plurality of mapping categories. The mapping system may be further configured to train, using the processing circuitry and the plurality of maps, the machine learning model to identify the expected distribution for the mapping categories of the geographic area at the given time.

In some embodiments, the mapping system may be configured to identify a distribution of mapping categories for a geographic area, based on at least one overhead image of the geographic area captured at a given time; input indications of the given time and the geographic area to a trained machine learning model; output, using the trained machine learning model, an expected distribution of the mapping categories of the geographic area at the given time; compare the identified distribution of mapping categories for the geographic area to the expected distribution of the mapping categories of the geographic area at the given time to identify a difference between the identified distribution and the expected distribution; and determine whether the difference between the identified distribution and the expected distribution is an anomaly.

Such aspects provide for automated and/or semi-automated techniques for accelerating mapping and monitoring in near-real-time, to detect mapping category patterns to enable data-driven decision-making with a clear and up-to-date understanding of any place on Earth and insights into the current state and dynamics of the Earth's surface. The techniques described herein may focus analyst attention on relevant changes across a time sequence of geospatial observations by training machine learning model(s), and using the trained machine learning model(s) (e.g., deep learning models), to determine (e.g., using historical map data for a geographic area) an expected mapping category distribution for such geographic area at a given time. Such expected mapping category distribution may be compared to, e.g., actual mapping categories for the geographic area at such given time, to determine whether a difference (e.g., the presence of a new mapping category, or a relatively large increase or decrease of a mapping category) in the expected and actual mapping categories rises to the level of an anomaly. In some embodiments, based on whether an anomaly is present, the mapping system may employ automated and/or semi-automated techniques for performing follow-up observations at the geographic area, providing a database for processing queries related to mapping category candidate changes, and/or using feedback from users to fine tune the machine learning model(s). In some embodiments, performing change analysis on a series of LULC maps over time can help to quantify and better understand the impacts of earth processes and human activity on the environment, which ma inform policy and land management decisions, helping to support a sustainable future.

In some embodiments, the mapping system may be configured to receive, by the processing circuitry and for each geographic area of a plurality of geographic areas, a respective plurality of maps, wherein: for each geographic area of the plurality of geographic areas, the respective plurality of maps is generated based on a respective plurality of overhead images captured during a respective portion of a time period; and each pixel of each respective plurality of overhead images is designated as being of a particular mapping category of a plurality of mapping categories. The mapping system may train the machine learning model further based on using the respective pluralities of maps for the plurality of geographic areas, to identify an expected distribution for mapping categories of a particular geographic area of the plurality of geographic areas at a particular time.

In some embodiments, training the machine learning model causes the machine learning model to learn a temporal distribution of mapping categories and confidences observed for the geographic area over the time period, and the method further comprises generating a vector, based on the temporal distribution of mapping categories and confidences observed for the geographic area over the time period, summarizing variability of mapping categories of the geographic area over the time period.

In some embodiments, the time period corresponds to: a particular year, and each respective portion of the time period corresponds to a month of the particular year; a plurality of seasons comprising winter, spring, summer, and autumn, and each respective portion of the time period corresponds to a respective season of the plurality of seasons; or a plurality of years, and each respective portion of the time period corresponds to a respective year of the plurality of years.

In some embodiments, the machine learning model is a statistical machine learning model, a Bayesian probabilistic model, a random forest model, a deep learning model, a transformer model using attention heads, or a combination thereof.

In some embodiments, training the machine learning model further comprises using auxiliary geospatial data as a parameter during training of the machine learning model, wherein the auxiliary geospatial data comprises at least one of weather data, topographic data, or signal emissions data for the geographic area.

In some embodiments, determining one or more trends for the mapping categories of the geographic area over the time period, wherein training the machine learning model is further based on the determined one or more trends.

In some embodiments, training the machine learning model further comprises determining a set of hyperparameters of the machine learning model based on identifying spatial segments and temporal segments summarizing the respective pluralities of overhead images. In some embodiments, the spatial segments enable identifying a spatially continuous object from groups of the plurality of pixels. In some embodiments, the temporal segments enable identifying patterns of nature, seasonal variation, or human activity over the time period.

In some embodiments, the machine learning model is a second machine learning model, the method further comprising training a first machine learning model to categorize each pixel of the respective pluralities of overhead images of the plurality of maps as being of a particular mapping category of the plurality of mapping categories.

In some embodiments, the first machine learning model comprises a plurality of machine learning models, and wherein each machine learning model of the plurality of machine learning models is trained to categorize pixels as being of a particular mapping category of the plurality of mapping categories for overhead images of a respective overhead image source of a plurality of overhead image sources.

In some embodiments, the respective pluralities of overhead image correspond to multi-spectral satellite imagery to which nearest-neighbor or bilinear interpolation is applied to resample spectral bands of the multi-spectral satellite imagery to a common spatial grid.

In some embodiments, the first machine learning model comprises a plurality of machine learning models, and wherein the method further comprising generating, by the processing circuitry, a composite map based on outputs from the plurality of machine learning models, wherein composite map is included in the plurality of maps.

In some embodiments, the trained machine learning model is trained using a plurality of maps of the geographic area, wherein: each map of the plurality of maps is generated based on a respective plurality of overhead images captured during a respective portion of a time period; and each overhead image of the respective pluralities of overhead images comprises a respective plurality of pixels, and each pixel is designated as being of a particular mapping category of a plurality of mapping categories.

In some embodiments, the comparing comprises identifying a plurality of candidate differences between the identified distribution and the expected distribution; and determining whether the difference between the identified distribution and the expected distribution is an anomaly comprises ranking the plurality of candidate differences based on a degree to which a respective candidate difference of the plurality of candidate differences differs from the expected distribution.

In some embodiments, the ranking further comprises categorizing each respective candidate difference of the plurality of candidate differences based on a likelihood that the respective candidate difference is an anomaly, each categorization including an indication of an observed feature related to whether the respective candidate difference is an anomaly.

In some embodiments, the mapping system may be configured to store the plurality of candidate differences, and each respective categorization, in an unstructured database.

In some embodiments, identifying the difference between the identified distribution and the expected distribution further comprises applying spatial clustering to segment spatially adjacent pixels of the at least one overhead image, likely to correspond to the difference between the identified distribution and the expected distribution, into an entity described by a vector.

In some embodiments, based on whether the difference is determined to be an anomaly, the mapping system may be configured to recommend performance of, or automatically performing, a follow-up observation of the geographic area.

In some embodiments, the recommending of the performance of, or the automatic performance of, the follow-up observation of the geographic area is based on receiving user feedback accepting the difference as an anomaly.

In some embodiments, a type of the difference comprises a first mapping category indicated in the identified distribution for a portion of the geographic area being different from a second mapping category indicated in the expected distribution for the portion of the geographic area; and the follow-up observation is identified based on the type of the difference.

In some embodiments, the follow-up observation is performed using at least one of an overhead image source that is different from an overhead image source used to capture the at least one overhead image or using a higher resolution overhead image than the at least one overhead image.

In some embodiments, the follow-up observation is identified based on at least one of a database of available sensor platforms, time to a next observation for one or more of the available sensor platforms, an expected monetary cost and expected time to fulfillment of the follow-up observation, or expected weather conditions at the geographic area.

In some embodiments, the follow-up observation is identified using an active learning machine learning model, and the method further comprises: identifying a result of the follow-up observation; receiving user feedback in relation to at least one of the anomaly or the follow-up observation; and further training the active learning machine learning model based on at least one of the identified result or the received user feedback.

In some embodiments, the mapping system may be further configured to store, in a database, for a plurality of geographic areas, data indicating: a plurality of candidate differences between identified distributions of mapping categories for respective geographic areas of the plurality of geographic areas and expected distributions of mapping categories for the respective geographic areas; and follow-up observations performed for at least a subset of the candidate differences. The mapping system may be configured to receive a natural language query related to a candidate difference, the natural language query comprising one or more parameters, and provide a response to the query based on the data indicated in the database.

In some embodiments, the one or more parameters comprise at least one of a geographic area, a time window, a size of region associated with the candidate difference, a type of candidate difference, likelihood of the candidate difference being an anomaly, one or more sensors used to capture overhead images and parameters of the capturing, recommendations for follow-up observations, results of the follow-up observations, user access logs, or indications of whether the follow-up observations or associated candidate differences were accepted, rejected, or modified.

In some embodiments, the query is received from a large language model (LLM), and the response to the query is provided based at least in part using the LLM.

In some embodiments, the determining whether the difference is an anomaly is further based on comparing the at least one overhead image of the geographic area captured at the given time to sensor data received from ground-based sensors at the geographic area or location at the given time.

### BRIEF DESCRIPTION OF THE DRAWINGS

The above and other objects and advantages of the present disclosure will be apparent upon consideration of the following detailed description, taken in conjunction with the accompanying drawings, in which like reference characters refer to like parts throughout, and in which:

FIG. 1 shows an illustrative block diagram of a system for training a machine learning model to categorize each pixel of an input overhead image, and generating a map by classifying to which mapping category of a plurality of mapping categories each pixel of a plurality of overhead images belongs, in accordance with some embodiments of this disclosure;

FIG. 2 shows an illustrative block diagram of a system for training a machine learning model to categorize each pixel of an input overhead image, and generating a map by classifying to which mapping category of a plurality of mapping categories each pixel of a plurality of overhead images belongs, in accordance with some embodiments of this disclosure;

FIG. 3 shows an illustrative block diagram of a system for training a machine learning model to categorize each pixel of an input overhead image, in accordance with some embodiments of this disclosure;

FIGS. 4A-4B show illustrative training images used to train a machine learning model, in accordance with some embodiments of this disclosure;

FIG. 5 shows an illustrative distribution of mapping categories of training images used to train a machine learning model, in accordance with some embodiments of this disclosure;

FIG. 6 shows an illustrative geographic locations and biomes associated with training images used to train a machine learning model, in accordance with some embodiments of this disclosure;

FIG. 7 shows an illustrative spatial distribution of a validation dataset used to tune a machine learning model, in accordance with some embodiments of this disclosure;

FIG. 8 shows an illustrative distribution of mapping categories of a validation set used to tune a machine learning model, in accordance with some embodiments of this disclosure;

FIG. 9 shows an illustrative confusion matrix used to present validation statistics for a machine learning model, in accordance with some embodiments of this disclosure;

FIG. 10 shows an illustrative block diagram of a system for using a trained machine learning model to categorize each pixel of an input overhead image, in accordance with some embodiments of this disclosure;

FIG. 11 shows illustrative captured overhead images, labeled versions of the captured images, and predictions of mapping categories of the captured images as output by a trained machine learning model to categorize each pixel of an input overhead image, in accordance with some embodiments of this disclosure;

FIG. 12 shows an illustrative captured overhead image and a prediction of mapping categories output by a trained machine learning model to categorize each pixel of an input overhead image, in accordance with some embodiments of this disclosure;

FIG. 13 depicts an illustrative straight mode technique employed on a series of images, in accordance with some embodiments of this disclosure;

FIG. 14 depicts an illustrative evaluation of the performance of a class weighted mode on a validation set, in accordance with some embodiments of this disclosure;

FIGS. 15A-15B show illustrative resulting images when a machine learning model is deployed along with a class weighted mode, in accordance with some embodiments of this disclosure;

FIG. 16 shows an illustrative map of a geographic area associated with a plurality of overhead images generated based on the plurality of overhead images and on categories determined by a machine learning model, in accordance with some embodiments of this disclosure;

FIG. 17 shows an illustrative map of a geographic area associated with a plurality of overhead images generated based on the plurality of overhead images and on categories determined by a machine learning model, in accordance with some embodiments of this disclosure;

FIG. 18 is a flowchart of a detailed illustrative process for training a machine learning model, in accordance with some embodiments of this disclosure;

FIG. 19 is a flowchart of a detailed illustrative process for generating a map of a geographic area, in accordance with some embodiments of this disclosure;

FIG. 20 is a flowchart of a detailed illustrative process for training a machine learning model, in accordance with some embodiments of this disclosure;

FIG. 21 is a flowchart of a detailed illustrative process for generating a map of a geographic area, in accordance with some embodiments of this disclosure; and

FIG. 22 is a flowchart of a detailed illustrative process for further training a machine learning model, in accordance with some embodiments of this disclosure.

FIG. 23A shows an illustrative system for identifying an expected distribution of mapping categories for a geographic area over a period of time, in accordance with some embodiments of the present disclosure.

FIG. 23B shows an illustrative flowchart for a system, in accordance with some embodiments of this disclosure.

FIG. 23C shows an illustrative flowchart for a system, in accordance with some embodiments of this disclosure.

FIGS. 24-25 shows illustrative composite maps, in accordance with some embodiments of this disclosure.

FIG. 26 shows an illustrative time sequence of maps generated by the mapping system for a particular area, in accordance with some embodiments of this disclosure.

FIG. 27 shows an illustrative time sequence of inferred labels at a location where each row corresponds to an individual pixel across time, in accordance with some embodiments of this disclosure.

FIG. 28 shows a time sequence of inferred labels at a location where each row corresponds to an individual pixel across time, and the model learns distributions over these pixel labels, in accordance with some embodiments of this disclosure.

FIG. 29 shows an example of a high-likelihood change for mapping categories of a geographic area, in accordance with some embodiments of this disclosure.

FIG. 30 shows an illustrative search interface, in accordance with some embodiments of this disclosure.

FIG. 31 shows illustrative text input, in accordance with some embodiments of this disclosure.

FIG. 32 shows illustrative text output, in accordance with some embodiments of this disclosure.

FIG. 33 shows an illustrative search interface, in accordance with some embodiments of this disclosure.

FIG. 34A shows an example of and interface providing geospatial metrics associated with a geospatial region, in accordance with some embodiments of this disclosure.

FIG. 34B shows an illustrative internal database structure of geospatial metrics, in accordance with some embodiments of this disclosure.

FIG. 35 shows an illustrative LULC map, in accordance with some embodiments of this disclosure.

FIG. 36 shows an illustrative implementation of the mapping system, in accordance with some embodiments of this disclosure.

FIG. 37 is a flowchart of a detailed illustrative process for training a machine learning model to identify an expected distribution of mapping categories for a geographic area at a given time, in accordance with some embodiments of this disclosure.

FIG. 38 is a flowchart of a detailed illustrative process for using a trained machine learning model to identify an anomaly in mapping categories for a geographic area, in accordance with some embodiments of this disclosure.

### DETAILED DESCRIPTION

The present disclosure discloses techniques for categorizing image pixels, and using machine learning models for categorizing image pixels such as images of land use or land cover. Systems and methods are provided herein for training a machine learning model to categorize each pixel of an input overhead image by receiving, by processing circuitry, a plurality of overhead images, each comprising a respective plurality of pixels, where each pixel of each overhead image of the plurality of overhead images is designated as being of a particular mapping category of a plurality of mapping categories. The processing circuitry may be configured to train a machine learning model to categorize each pixel of the input overhead image using the plurality of overhead images.

In addition, systems and methods are provided herein for generating a map by predicting to which mapping category of a plurality of mapping categories each pixel of a plurality of overhead images belongs. Such systems and method may include processing circuitry configured to input the plurality of overhead images to the trained machine learning model, and determine, using the trained machine learning model, for each pixel of the plurality of overhead images, to which mapping category of the plurality of mapping categories the pixel belongs. The processing circuitry may generate the map of a geographic area associated with the plurality of overhead images based on the plurality of overhead images and on the determined categories. In some embodiments, generating the map comprises generating the map at a resolution of 10 meters per pixel.

In the provided systems and methods for training the machine learning model, for each pixel of each respective overhead image, the designation of the particular mapping category may be appended to the respective overhead image and/or the designation of the particular mapping category may be stored at a database. In some embodiments, the training of the machine learning model comprises using boundary information that indicates where boundaries between regions of pixels of different categories are located, where the overhead image may be annotated to comprise an indication of the boundary information (e.g., a dense labeling of pixels and neighboring pixels). Such boundary information may enable the machine learning model to learn patterns and characteristics of boundaries between certain regions of pixels of different categories, and explore spatial and spectral features to more accurately and efficiently categorize pixels.

In some embodiments, training the machine learning model further comprises biasing each of the respective plurality of mapping categories based on, for example, a frequency of occurrence of the mapping category in the plurality of overhead images. In this way, certain under-represented mapping categories may be accounted for to correct any imbalances in the training dataset.

In some embodiments, each overhead image of the plurality of overhead images comprises a satellite image or other aerial image that is of a predefined dimensioned area of the planet. In some aspects of this disclosure, training the machine learning model may further comprise using three-dimensional terrain information to train the machine learning model. In some embodiments, the machine learning model may be trained using any suitable types of imagery, e.g., visible or infrared optical images, SAR images, medium wave or long wave thermal infrared images, hyperspectral images, or any other suitable images, or any combination thereof.

In the provided systems and methods for determining, using the trained machine learning model, to which mapping category of the plurality of mapping categories the pixel belongs, the plurality of overhead images may have been captured at a plurality of times during a time period, and the generated map may be of the geographic area over the time period. In some embodiments, the map may comprise a temporal axis.

In some embodiments, generating the map comprises generating a composite image based on the plurality of overhead images and on the determined categories. In some embodiments, the composite image may be generated for a particular time interval, e.g., a few days, a month, a year, a meteorological season, an agricultural season, or any other suitable time interval. The composite image may comprise a plurality of pixels each of which respectively corresponds to a pixel included in each of the plurality of overhead images. The processing circuitry may be configured to generate the composite image of the geographic area by identifying, for each pixel of the plurality of overhead images of the geographic area, a particular mapping category that is determined most frequently (or most confidently) by the trained machine learning model over the time period. In some embodiments, the processing circuitry may analyze composite images or maps from previous years matching the specific time of year requested for a new composite image or map to be generated. For example, if a requested time period for the composite image is spring of 2022, a particular mapping category that is determined most frequently (or most confidently) in spring of 2021 for the geographic area (and/or for spring of any other suitable year(s)) may be taken into account when generating the composite image. In some embodiments, For each respective pixel of the composite image, the processing circuitry may cause the pixel to be represented as being of the same particular mapping category that is identified for the pixel of the plurality of overhead images that corresponds to the pixel of the composite image.

In some aspects of this disclosure, generating the map comprises formulating a class weighted mode parameter based on a probability (or likelihood or confidence or similarity to a training pixel) associated with each mapping category; and a desired weight of a particular mapping category of the plurality of mapping categories with respect to the other mapping categories of the plurality of mapping categories. The plurality of mapping categories may comprise at least grass, flooded vegetation, crops, bare ground, snow/ice and clouds, and formulating the class weighted mode may comprise assigning higher weights to each of the grass and flooded vegetation categories as compared to the crops, bare ground, snow/ice, and clouds categories.

In some aspects of this disclosure, formulating the class weighted mode parameter based on a desired weight of a particular mapping category of the plurality of mapping categories with respect to the other mapping categories of the plurality of mapping categories comprises assigning a first set of weights for the plurality of mapping categories to a particular geographic region as compared to other geographic regions.

In some embodiments, the processing circuitry may be configured to generate a plurality of maps of a plurality of geographic areas associated with the plurality of overhead images based on the plurality of overhead images and on the determined categories, and composite the plurality of maps together to generate a composite map comprising each of the plurality of geographic areas. The composite map may comprise a global map.

In some embodiments, the processing circuitry may be configured to receive feedback information from the trained machine learning model, and determine, based on the feedback information, that an additional training overhead image is necessary. The processing circuitry may obtain one or more additional training overhead images, update the plurality of training overhead images with the one or more additional training overhead images, and update the trained machine learning model using the updated plurality of training overhead images. Such features may facilitate gathering additional training data such as, for example, for particular geographical locations and/or particular mapping categories associated with low confidence results.

In some embodiments, the processing circuitry may be configured to receive feedback information from the trained machine learning model, and determine, based on the feedback information, that one or more mapping category designations for respective pixels of at least one of the plurality of training overhead images need to be updated. The processing circuitry may be configured to update the one or more mapping category designations for the respective pixels of the at least one of the plurality of training overhead images, and update the trained machine learning model using the updated one or more mapping category designations.

In some embodiments, the trained machine learning model may implemented at particular equipment, where the particular equipment comprises the processing circuitry that is configured to receive the feedback information from the trained machine learning model. The particular equipment may comprise one or more sensors configured to capture the additional training overhead image, and the processing circuitry of the particular equipment is configured to perform the updating of the plurality of training overhead images with the additional training overhead image and the updating of the trained machine learning model using the updated plurality of training overhead images.

In some embodiments, the plurality of overhead images (e.g., input to the trained machine learning model) may be captured by one or more imagery sources corresponding to at least one of a visible or infrared optical imagery source, an SAR imagery source, or a medium wave or long wave thermal infrared imagery source. In some embodiments, generating the map comprises generating the map at a resolution based on upsampling or down sampling an intrinsic resolution of the one or more imagery sources.

In some embodiments, a non-transitory computer-readable medium may be provided having non-transitory computer-readable instructions encoded thereon that, when executed by a processor, cause the processor to receive a plurality of overhead images, each comprising a respective plurality of pixels, wherein each pixel of each overhead image of the plurality of overhead images is designated as being of a particular mapping category of a plurality of mapping categories, and train a machine learning model to categorize each pixel of the input overhead image using the plurality of overhead images.

In some embodiments, a non-transitory computer-readable medium may be provided having non-transitory computer-readable instructions encoded thereon that, when executed by a processor, cause the processor to input the plurality of overhead images to a trained machine learning model; determine, using the trained machine learning model, for each pixel of the plurality of overhead images, to which mapping category of the plurality of mapping categories the pixel belongs; and generate, using processing circuitry, the map of a geographic area associated with the plurality of overhead images based on the plurality of overhead images and on the determined categories. The machine learning model is trained by executing instructions to cause the processor to receive a plurality of training overhead images, each comprising a respective plurality of pixels, wherein each pixel of each training overhead image of the plurality of training overhead images is designated as being of a particular mapping category of a plurality of mapping categories, and train a machine learning model to categorize each pixel of an input overhead image using the plurality of training overhead images.

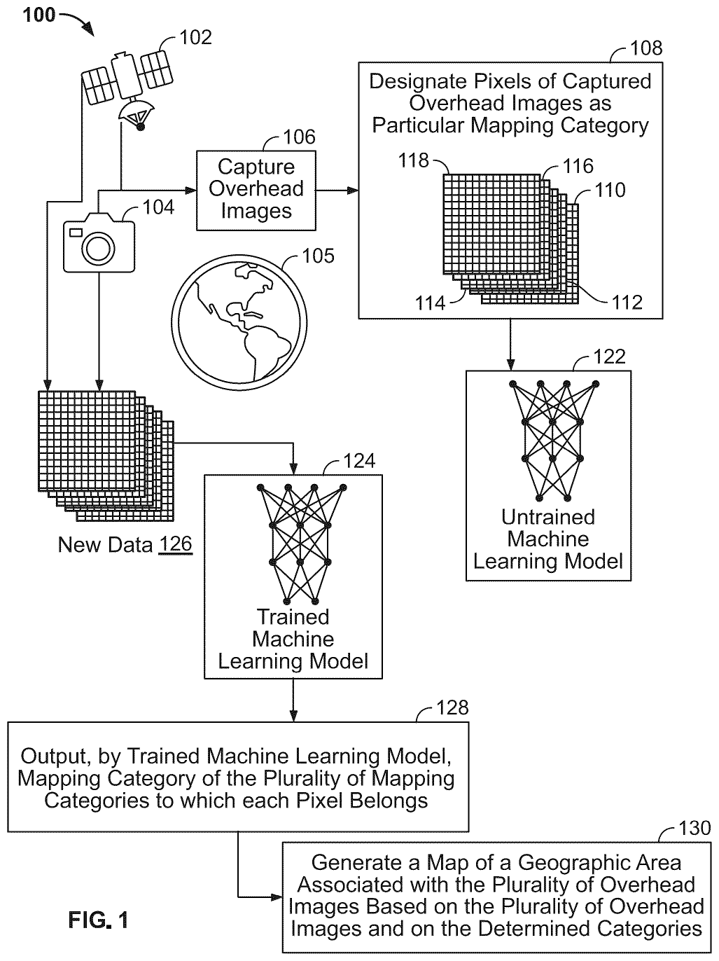

FIG. 1 shows an illustrative block diagram of a system 100 for training a machine learning model to categorize each pixel of an input overhead image, and generating a map based on classifying to which mapping category of a plurality of mapping categories each pixel of a plurality of overhead images belongs, in accordance with some embodiments of this disclosure. System 100 may include one or more satellites or other aircraft 102 having one or more imaging devices 104 (e.g., mounted in aircraft 102 or other aircraft, such as, for example, a satellite spacecraft, drone, balloon, helicopter, airplane, any other suitable aircraft, or any combination thereof) configured to capture overhead images 106 (e.g., satellite images and/or other aerial images and any other suitable images, or any combination thereof) of planet 105 (e.g., planet earth). Imaging device 104 may include an image sensor (e.g., directed towards the surface of planet 105) configured to receive light from its surrounding environment, and generate image data based on the received light. In some embodiments, a heterogeneous set of imaging sensors may be employed by imaging device 104. For example, visible or infrared optical images, SAR images, medium wave or long wave thermal infrared images, hyperspectral images, or any other suitable images, or any combination thereof, may be captured by such heterogeneous set of imaging sensors, and one or more mapping categories to which one or more of the pixels thereof correspond to may be identified. In some embodiments, any suitable sensor may be utilized to emit and/or receive energy for use in capturing and generating overhead images 106.

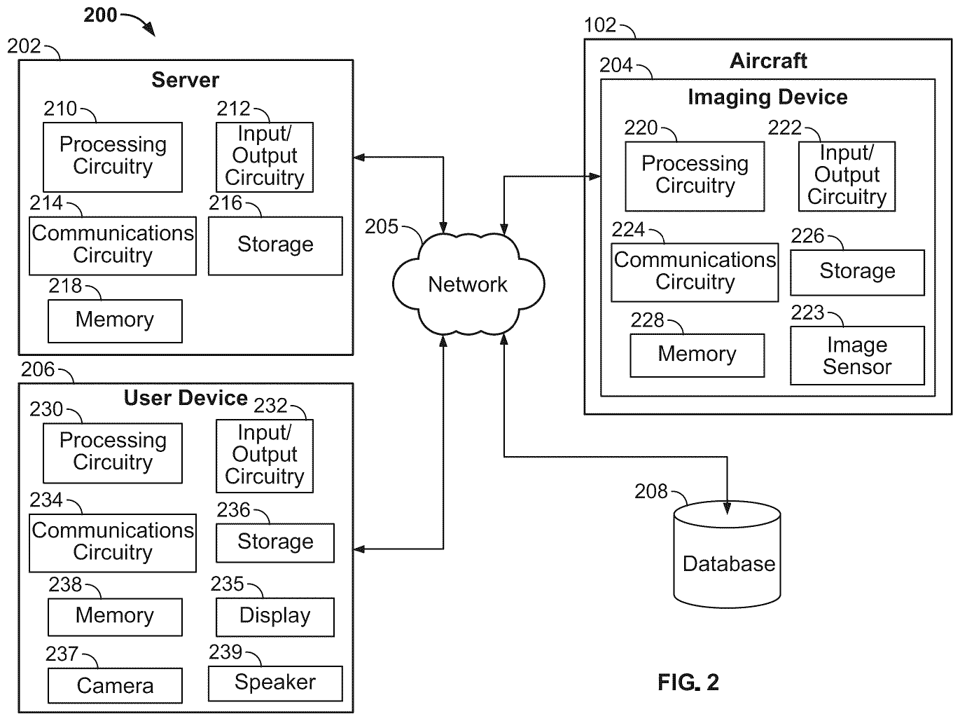

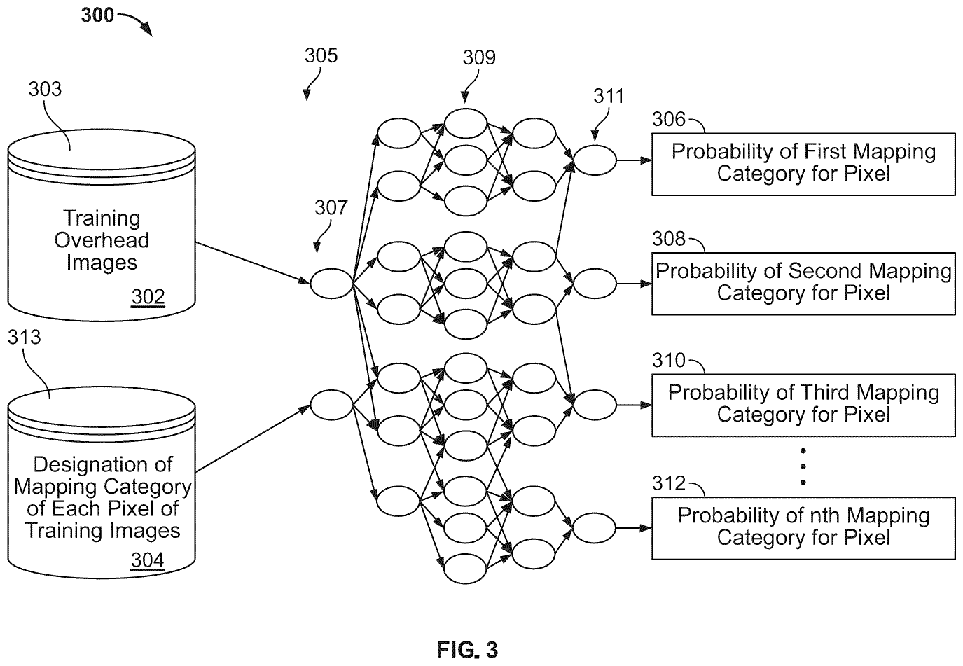

At 108, the overhead images captured at 106 may be received and/or captured by the mapping system (e.g., implemented at one or more of server 202, imaging device 204, user device 206, database 208 of FIG. 2, or at aircraft 102 or another suitable vehicle or device configured to capture images, or distributed across one or more of any other suitable device, or any combination thereof). In some embodiments, the mapping system may designate (e.g., based on annotations by a human editor) each pixel of the overhead images as belonging to a particular mapping category, for use in training untrained machine learning model 122 (e.g., corresponding to model 305 of FIG. 3). In some embodiments, less than 100% of a scene may be labeled, and annotators may label the scene for a set time period prior to moving on to a next scene to be labeled. In some embodiments, the particular mapping category may be selected from among discrete land use/land cover (LULC) categories or classes, e.g., clouds, snow/ice, grass, trees, cropland, built area, bare ground, flooded vegetation, water, scrub or scrubland/shrub or shrubland, forest, grassland, rangeland, and/or any other suitable mapping category, or any combination thereof. In some embodiments, the mapping system may employ a “no data” class for unlabeled pixels (e.g., when certain pixels are ambiguous or human editors are otherwise unable to determine a suitable mapping category for one or more of such pixels). In some embodiments, the training data used to train untrained machine learning model 122 may comprise training overhead images of a predefined dimensioned area of the planet (e.g., 24,000 5 km×5 km images or 100 km×100 km images collectively comprising over 5 billion human-labeled pixels, where each image may each be 510×510 pixel RGB natural-color images, or any other suitable number of images of any suitable numbers of pixels). The training data may correspond to captured images of various geographic areas spanning various time ranges (e.g., over a 6 month period of time, over a period of time of one year, or any other suitable time range). The mapping system may utilize artificial intelligence (AI) powered algorithms and on-demand data to bring sustainability and environmental risk analysis for governments, non-profit organizations, companies, and markets, or any other suitable entity, or any combination thereof.

The mapping system may retrieve (e.g., from one or more of one or more of server 202, user device 206, or database 208 of FIG. 2, or one or more of any other suitable device, or any combination thereof) the captured overhead images and associated designations of pixels of the captured images determined at 108, and use such images and corresponding pixel designations to train untrained machine learning model 122. The mapping system may cause training overhead images (e.g., images 110, 112, 114, 116, 118 captured at 106 of FIG. 1) to have an associated mapping category appended thereto for each pixel of the training overhead images, e.g., as part of an image file for input to train the machine learning model, and/or the designation of the particular mapping category may be stored at a database (e.g., database 208 of FIG. 2) and input to untrained machine learning model 122 in association with the overhead training image corresponding to the designation. Based on the training data, untrained machine learning model 122 may learn certain patterns and characteristics indicative of particular mapping categories for use in categorizing pixels of training images into particular mapping categories. In some embodiments, the training data may include images of scenes across the globe at individual points in time or snapshots in time, over a predefined period (e.g., one year or any other suitable time period). In some embodiments, the mapping system may exclude from training images having more than a predefined amount (e.g., 15%) of the “no data” class, and/or the mapping system may classify pixels as “no data” if the probability or confidence score of other classes is below a certain threshold. In some embodiments, the mapping system may utilize SAR techniques to generate imagery, which may be labeled and used to train untrained machine learning model 122, in addition to or alternative to the labeled overhead imagery. Training of the machine learning model is discussed in more detail in connection with FIG. 3.

Based on the aforementioned techniques, untrained machine learning model 122 may be trained to correspond to trained machine learning model 124. The mapping system may utilize trained machine learning model 124 by inputting new data 126 (e.g., overhead images captured by aircraft 102, imaging device 104, or captured or retrieved from any suitable device, or any combination thereof) to trained machine learning model 124. Trained machine learning model 124 model may be configured to output, at 128, a mapping category of a plurality of mapping categories to which each pixel of the images associated with new data 126 belongs. For example, trained machine learning model 124 may be configured to output respective probabilities that a particular pixel belongs to a particular class (e.g., from among clouds, snow/ice, grass, trees, cropland, built area, bare ground, flooded vegetation, water, and/or scrub/shrub, or any other suitable mapping class, or any combination thereof). Based on such probabilities, a particular class may be selected by the mapping system. New data 126 may comprise images captured at a plurality of geographic areas across planet 105 at a plurality of times throughout a predefined time period (e.g., one year). In some embodiments, trained machine learning model 124 may be configured to take as input one overhead image and output a map of the geographic area corresponding to the overhead image comprising indications of one or more mapping categories of pixels of the input overhead image. In some embodiments, additional mapping categories may be used to train the model and may be recognized by the trained model, e.g., in addition to categorizing one or more pixels as trees, the model may output a prediction that the one or more pixels are part of a particular type of forest (or any other suitable mapping class, or any combination thereof), such as, for example, a deciduous forest, or any other suitable forest, or any combination thereof. In some embodiments, the map generated by the mapping system may encompass a specific time range.

At 130, the mapping system may generate a map of a geographic area associated with the plurality of overhead images input to the trained machine learning model at 124, based on the plurality of overhead images and on the mapping categories determined at 128. In some embodiments, the mapping system may account for cloud cover variability and possible gaps in data coverage by utilizing multiple observations of a particular geographic area in generating a map of a plurality of geographic areas (e.g., a world map, or a map of a portion of interest in the world, or any other suitable planet, or any combination thereof) to create a seamless LULC map over a particular time interval (e.g., one year, or any other suitable time interval). The mapping system may employ scene selection logic, e.g., by selecting the least cloudy scenes for an overhead image tile, and more scenes in very cloudy areas may be incorporated for a partial region whereas less scenes may be incorporated in mostly cloud-free areas. In some embodiments, the mapping system may subdivide an image tile may into, e.g., 5 km×5 km image chips with 1 km overlap, or any other suitable image dimensions or any other suitable overlap amount. The mapping system may generate a final map using any suitable technique (e.g., by computing or formulating a class weighted mode across all the predictions of model, where the class weighted mode may incorporate the mapping category classification, the associated probability, and a custom class weight per pixel, as discussed in more detail below). In some embodiments, the mapping system may utilize a custom weight per class, which may be akin to a seasonal adjustment, and which may emphasize ephemeral classes that may only occur a few times per year (e.g. grass, or any other suitable class, or any combination thereof) and/or de-emphasize more common classes and/or de-emphasize transient classes (e.g., snow/ice, or any other suitable class, or any combination thereof).

In some embodiments, the mapping system may generate a global map by processing any suitable number of images (e.g., over 20,000 Sentinel-2 tiles across the entire Earth's land surface, which may be surface reflectance corrected imagery accessed from the Microsoft Planetary Computer, or any other suitable number of images associated with any other suitable aircraft and any suitable imagery platform, or any combination thereof). In some embodiments, the mapping system may generate the global map in near real time (e.g., approximately 7 days). For example, such processing may require approximately 1.2 million core hours of compute time, and the mapping system may leverage third party cloud computing resources such as, for example, Microsoft Azure Batch (e.g., over a million cores, and running up to 6400 cores simultaneously, or any other suitable processing parameters and any other suitable cloud computing resource, or any combination thereof) and/or Amazon Web Services resources. In some embodiments, the mapping system may generate a global map at 10 meter resolution (e.g., a single pixel may represent an area on the ground of 10 m×10 m), or any other suitable high resolution may be employed, and/or may incorporate imagery from across an entire year. In some embodiments, the mapping system may generate maps of any suitable number of geographic areas, and composite such maps together to create a map that includes all of the geographic areas desired to be represented in the global map. In some embodiments, the mapping system may generate maps that exceed the training set by a large amount (e.g., the global map may be 300× larger than the training set). In some embodiments, the plurality of overhead images may be captured by one or more imagery sources corresponding to at least one of a visible or infrared optical imagery source, an SAR imagery source, or a medium wave or long wave thermal infrared imagery source, and the mapping system may generate the map at a resolution based on upsampling or down sampling an intrinsic resolution of such one or more imagery sources.

FIG. 2 shows an illustrative block diagram of a system 200 for training a machine learning model to categorize each pixel of an input overhead image, and generating a map based on classifying to which mapping category of a plurality of mapping categories each pixel of a plurality of overhead images belongs, in accordance with some embodiments of this disclosure. System 200 may comprise one or more of server 202, one or more of imaging device 204, one or more of user device 206, and one or more of database 208, each of which may communicate with each other via network 205. Network 205 may comprise any suitable network (e.g., satellite network, cellular network, and/or the Internet, including a WAN and/or a LAN, or any combination thereof). In some embodiments, system 200 may be utilized to implement the mapping system. The mapping system may comprise hardware, software, or any combination thereof for providing the functionality described herein. The mapping system may be implemented in one location at one device or distributed across different locations across different devices (e.g., using processing circuitry 210, processing circuitry 220, processing circuitry 230, or any other suitable components, or any suitable combination thereof). The mapping system may enable automated LULC mapping from time series observations, by employing a systematic (e.g., algorithmic) technique to deploy the machine learning model over large arbitrary areas of interest while including relevant data across a particular time period (e.g., one year, or any other suitable time period).

Server 202 may comprise one of more servers having processing circuitry 210 which may comprise hardware, software or any combination thereof, such as, for example, one or more central processing units (CPUs) or processors configured to execute instructions stored in computer-readable media (e.g., memory 218 and/or storage 216) to implement operating system(s) and applications of system 200 and perform and/or control various operations on data and other computations. For example, processing circuitry 210 may be configured to train the machine learning model (e.g., at 122 of FIG. 1), input captured images (e.g., new data 126 of FIG. 1) to the machine learning model, and receive output of a mapping category for each pixel of the input images (e.g., at 128 of FIG. 1), and generate a map associated with the plurality of overhead images (e.g., at 130 of FIG. 1). Server 202 may further comprise input/output circuitry 212 and/or communications circuitry 214 configured to receive input and/or communications (e.g., based on input received at user device 206 in communication with server 202 over network 205). In some embodiments, input/output circuitry 212 and/or communications circuitry 214 may be configured to receive overhead images (e.g., from another server or a database and/or captured at imaging device 204) and designation of particular mapping categories of respective pixels of the received images (e.g., from database 208 and/or otherwise appended to the overhead images). In some embodiments, server 202 may comprise a plurality of servers (e.g., as part of cloud computing resources) that may be configured to run the trained machine learning model and/or generate a map based on the output of the trained machine learning model. Storage 216 and/or memory 218 of server 202 may comprise one or more of, for example, Random Access Memory (RAM), Read Only Memory (ROM), EEPROM, ASIC, optical storage, magnetic storage, flash memory, solid state memory, or any other suitable medium used to store data, or any combination thereof. Storage 216 and/or memory 218 may be configured to store one or more applications (e.g., in non-transitory medium) executable by processing circuitry 210 to implement the techniques discussed above and below. In some embodiments, at least a portion of training data, and/or associated metadata, and/or at least a portion of the machine learning model and associated parameters or hyperparameters may be stored at server 202. In some embodiments, server 202 may comprise a collection of servers, and processing circuitry of server 202 can be distributed across a number of servers.

Imaging device 204 may comprise processing circuitry 220, input/output circuitry 222, communications circuitry 224, storage 226, memory 238, which may be implemented in a similar manner as processing circuitry 210, input/output circuitry 212, communications circuitry 214, storage 216 and memory 218, respectively, of server 202. Imaging device 204 (e.g., mounted on aircraft 102 of FIG. 1 or other aircraft and directed towards planet 105 of FIG. 1, such as, for example, planet earth) may include image sensor 223 which may be configured to detect light, e.g., passed or transmitted through one or more filters. In some embodiments, image sensor 223 may be a charge-coupled device (CCD) or complementary metal oxide semiconductor (CMOS) sensors. Image sensor 223 may generate image data based on the detected light, e.g., by converting light comprising photons to electrical signals. Processing circuitry 220 may be configured to perform image processing on the image data generated by image sensor 223. For example, processing circuitry 220 may cause the image data generated by image sensor 223 to be stored in memory 228 and/or storage 226, and processing circuitry 220 may analyze or operate on a plurality of pixels of the image data. In some embodiments, input/output circuitry 222 and/or communications circuitry 224 may be configured to transmit images of various geographical areas over a predefined period of time (e.g., one year) to one or more of server 202 and/or user device 206 and/or database 208. In some embodiments, imaging device 204 may utilize one or more of a variety of techniques to generate image data (e.g., SAR, hyperspectral imaging, etc.). In some embodiments, imaging device 204 may be configured to capture and/or process, and provide to the machine learning model for training and/or processing, any suitable types of imagery, e.g., visible or infrared optical images, SAR images, medium wave or long wave thermal infrared images, hyperspectral images, or any other suitable images, or any combination thereof. In some embodiments, a classification of the type of imagery of image data may be appended to the image or otherwise stored at a database, e.g., database 208. Ins some embodiments, the machine learning model may be configured to extract the different complementary information in the different types of images from the different imagery sources, and may leverage such information for data fusion and improved performance of the machine learning model.

In some embodiments, the machine learning model may be implemented at least in part at aircraft 102 (e.g., satellite or a drone or any other suitable vehicle or device) which also has the capability of collecting image data, such as, for example, via imaging device 204 which may be mounted or positioned on aircraft 102. In some embodiments, at least a portion of training data, and/or associated metadata, and/or at least a portion of the machine learning model and associated parameters or hyperparameters may be stored at aircraft 102.

User device 206 may comprise processing circuitry 230, input/output circuitry 232, communications circuitry 234, storage 236, memory 728, which may be implemented in a similar manner as processing circuitry 210, input/output circuitry 212, communications circuitry 214, storage 216 and memory 218, respectively, of server 202. In some embodiments, input/output circuitry 232 and/or communications circuitry 234 may be configured to receive images of various geographical areas over a predefined period of time (e.g., one year), and may receive input (e.g., from human editors) labeling pixels of the received images as belonging to a particular mapping category. The captured images received at user device 206 may be presented to the human editors by way of display 235. In some embodiments, user device 206 may comprise camera 237 and speaker 239. Processing circuitry 230 may be configured to train the machine learning model based on the captured overhead training images and/or transmit the captured images and associated labels to server 202 for training. In some embodiments, user device 206 may be configured to generate a map of a particular geographic area (e.g., a global map) over a predefined period of time (e.g., one year) based on a plurality of outputs of the machine learning model. User device 206 may be configured to receive input to instruct the machine learning model to be executed and/or to receive input instructing execution of techniques to generate a map based on the output of the trained machine learning model. User device 206 may correspond to any suitable device (e.g., a desktop computer, a laptop computer, a television, a mobile device, a smartphone, a tablet, or any other suitable device, or any other combination thereof). In some embodiments, at least a portion of training data, and/or associated metadata, and/or at least a portion of the machine learning model and associated parameters or hyperparameters may be stored at user device 206.

Database 208 may be configured to be in communication (e.g., over network 205) of server 202, imaging device 204 and/or user device. In some embodiments, database 208 may store indications of a particular mapping category for each pixel of a plurality of pixels of overhead images (e.g., captured at 106, based on input received from human editors). In some embodiments, in training the machine learning model, one or more of server 202 and/or user device 206 may retrieve or otherwise request such mapping category information matching a current image being used to train the machine learning model. For example, database 208 may store an identifier for a particular image, and identifiers for individual pixels of the image, and provide the appropriate information upon request, where the receiving device may associate the received mapping categories with images of the pixels and input such information to the machine learning model. Database 208 may comprise any suitable formatted data structure. In some embodiments, database 208 may be relational database, a self-referential database, or a distributed database, or any combination thereof. Any suitable technique may be used to communicate with, and access database records stored at, database 208 (e.g., SQL). In some embodiments, database 208 may be configured to store images or references to network locations of images (e.g., overhead training images captured at 106 of FIG. 1 and/or overhead images captured at 126). In some embodiments, at least a portion of training data, and/or associated metadata, and/or at least a portion of the machine learning model and associated parameters or hyperparameters may be stored at database 208.

FIG. 3 shows an illustrative block diagram of a system 300 for training a machine learning model 305 to categorize each pixel of an input overhead image, in accordance with some embodiments of this disclosure. System 300 may correspond to the mapping system discussed herein. In some embodiments, machine learning model 305 may be a deep learning based segmentation model, e.g., a neural network machine learning model, or any other suitable model, or any combination thereof. The neural network may employ input layer 307 having one or more input nodes, an output layer 311 having one or more output nodes, and one or more hidden layers 309 (between the input layer and output layer) comprising a plurality of nodes and connections between the nodes, where the connections may represent parameters (e.g., weights and/or biases, or any other suitable techniques, or any combination thereof) learned during training (e.g., using backpropagation techniques, or any other suitable techniques, or any combination thereof) of model 305 with training data 302. In some embodiments, machine learning model 305 may be a convolutional neural network (CNN) machine learning model used to categorize input images into a particular mapping category. A CNN may leverage the fact that neighboring pixels tend to be similar to each other, e.g., tend to be of a similar or the same color or otherwise have similar characteristics. More specifically, the CNN model may be used to extract image features and automatically learn suitable weights during training by applying a filter (e.g., 3×3 pixels, or any other suitable dimensions) to input images, where the filter is slid around the image to be overlaid on different pixels of the input image and convolved with overlapping pixels. A bias value may be applied to a filter output, and the biased filter output may be added to a feature map, and pooling may be applied to the feature maps, e.g., to select a maximum value in each region to be used as inputs to the neural network.

In some embodiments, machine learning model 305 may employ a CNN having a U-Net architecture specifically tailored for image segmentation. The U-Net architecture is discussed in more detail in Ronneberger et al., “U-Net: Convolutional Networks for Biomedical Image Segmentation,” In: Navab N., Hornegger J., Wells W., Frangi A. (eds) Medical Image Computing and Computer-Assisted Intervention—MICCAI 2015, Lecture Notes in Computer Science, vol 9351, the disclosure of which is hereby incorporated by reference herein in its entirety. In some embodiments, machine learning model 305 may include one or more modifications to the U-Net architecture that is discussed in Ronneberger et al. For example, while the CNN of Ronneberger et al. utilizes two 3×3 unpadded convolutions, machine learning model 305 may employ the “same” padding (i.e., addition of pixels to the edge of an image) such that a suitable amount of pixels are utilized to ensure that an output of model 305 matches images input to model 305 (e.g., for each image, 510×510 pixels, 10 m per pixel).

Model 305 may be trained for any suitable number of epochs (e.g., 100, or any other suitable number) using the training overhead images, e.g., stored at database 303 (which may correspond to database 208 of FIG. 2 or any other suitable database, or any combination thereof) and/or otherwise received by the mapping system (e.g., at processing circuitry 210 of FIG. 2 of server 202 and/or processing circuitry 230 of user device 206 of FIG. 2) for use in training machine learning model 305. In some embodiments, surface reflectance (e.g., top of atmosphere reflectance) corrected imagery (e.g., full dynamic range, with pixel values scaled 0-255), e.g., captured by the 6-band (e.g., red, green, blue, nir, swir1, swir2, or any other suitable band, or any combination thereof) European Space Agency (ESA) Sentinel-2 Level 2A (L2A) satellite and provided by the Microsoft Planetary Computer, may be employed by the mapping system in training machine learning model 305. For example, such imagery may comprise visible blue, green, and red bands, near infrared and/or ultraviolet, and/or at least two shortwave infrared bands, e.g., Sentinel-2 bands 2, 3, 4, 8, 11, and 12, and may be rescaled from a fixed precision data format (e.g., UInt16 or any other suitable format) to a Float format (e.g., 0.0-1.0) for performed computations. In some embodiments, ten (or any other suitable number) of L2A bands may be used (e.g., three red edge bands and a narrow NIR band may be used in addition to the Sentinel-bands referenced above, or any suitable number or type of bands, or any combination thereof) and/or band ratios (NDVI computed using the red and NIR bands, NDWI, EVI, or any other band ratio, or any combination thereof). In some embodiments, a time series of band ratios (e.g., NDVI, NDWI, and EVI, or any other suitable band ratio, or any combination thereof) of captured overhead training images may be used to train the model, which may enhance the model's ability to detect phenologic patterns (e.g., cropping cycles, grass green-up, seasonally flooded vegetation, or any other suitable pattern, or any combination thereof). Model 305 may be trained for the identified number of epochs to convergence, with a stepped learning rate (e.g., starting at 1e⁻⁴ or any other suitable value) that may be caused by the mapping system to drop an order of magnitude (e.g., up to 1e⁻⁷ or any other suitable value) in response to determining that validation loss begins to plateau or otherwise stops improving.

Model 305 may be trained using the overhead images (e.g., images 110, 112, 114, 116, 118 captured at 106 of FIG. 1, or any other suitable images and any suitable number of images, or any combination thereof), where each pixel of the training overhead images may be designated by the mapping system at 108 (e.g., by a human editor) as belonging to a particular mapping category. In some embodiments, the mapping system may select the particular mapping category from among discrete land use/land cover (LULC) classes, e.g., clouds, snow/ice, grass, trees, cropland, built area, bare ground, flooded vegetation, water, scrub/shrub, or any other suitable mapping category, or any suitable combination thereof. In some embodiments, the mapping system may employ a “no data” class for unlabeled pixels, and images having more than a predefined amount (e.g., 15%, or any other suitable predefined amount) of the “no data” class may be excluded from training, and/or pixels may be predicted as “no data” if the probability of other classes is below a certain threshold. In some embodiments, the training data for use at 122 may comprise training overhead images of a predefined dimensioned area of the planet (e.g., 24,000 5 km×5 km images or 100 km×100 km images collectively comprising over 5 billion human-labeled pixels, or any other suitable dimensioned images and number of images, or any combination thereof). Th training dataset may be global and geographically-balanced. In some embodiments, the mapping system may process over 400,000 Earth observations, or any other suitable number of observations, to produce the map. The mapping system may cause the training overhead images to have an associated mapping category appended thereto for each pixel of the training overhead images, e.g., as part of an image file for input to model 305, and/or the designation 304 of the particular mapping category may be stored at database 313 and input to machine learning model 305 in association with the overhead training image corresponding to the designation.

In training machine learning model 305, the mapping system may attempt to minimize a loss function (e.g., categorical cross entropy loss function, or any other suitable loss function, or any combination thereof). The loss function may be weighted using inverse-log weighting based on the percent proportion of each class (e.g., by weighting or biasing one or more under-represented classes higher in the model), to account for class imbalance in the training dataset, or using any other suitable technique, or any combination thereof. In some embodiments, the mapping system may zero out a class weight for unlabeled pixels (i.e., no data), thereby forcing model 305 to ignore unlabeled regions in overhead training images during training. In some embodiments, the mapping system may perform data augmentation, e.g., to randomly flip images vertically and horizontally, which has the effect of introducing more geographic pattern realizations used for training, and/or to apply random color perturbations to change brightness and hue of images used for training. In some embodiments, the mapping system may flip sample weights when flipping images to augment the training dataset. In some embodiments, the mapping system may employ a dropout technique during training, e.g., randomly turning off 20% of the neurons in model 305 in each batch, or any other suitable number of neurons, which may serve a regularization effect so as to prevent overfitting and aid in generalization properties of the model. In some embodiments, the mapping system may cause a certain indication to be made (e.g., a brighter color, or other suitable characteristic) over a region of one or more pixels to indicate stronger weights (e.g., brighter colors, or other suitable characteristic, may be indicative of stronger weights or biases).

Once machine learning model 305 is trained (e.g., to correspond to trained machine learning model 124), such trained model may be configured to output a mapping category of the plurality of mapping categories to which each pixel belongs, e.g., semantically segment land cover types into multiple classes. For example, model 305 may be configured to output probabilities 306, 308, 310, 312, or any other suitable number of probabilities, or any combination thereof. In some embodiments, a softmax layer may be applied (e.g. to obtain a normalized probability distribution) to a last convolutional decoder block of model 305, and the softmax layer may map the output to a probability for each of the classes (e.g., ten classes or any other suitable number of classes), and/or an argmax function may be applied to the probabilities (e.g., to set each probability to zero or one) to yield a final segmentation map which shows a pixel-wise classification of the input image. In some embodiments, model 305 may be trained to recognize that certain mapping categories tend to have a certain amount of heterogeneity, e.g., in the Amazon region of planet earth, many or all pixels may correspond to a forest region, or in the Sahara region of planet earth, many or all pixels may correspond to a desert region, or any other suitable patterns may be employed by the mapping system, or any combination thereof. In some embodiments, a global map of height or topography and/or 3D terrain information may be input to the model, e.g., to enable the model to learn in terms of color and 3D structure (e.g., the model may learn that bare ground is less likely near a city, based on the combination of overhead imagery and the 3D terrain information, and/or the model may learn any suitable number or types of other predictive characteristics in relation to mapping classes).

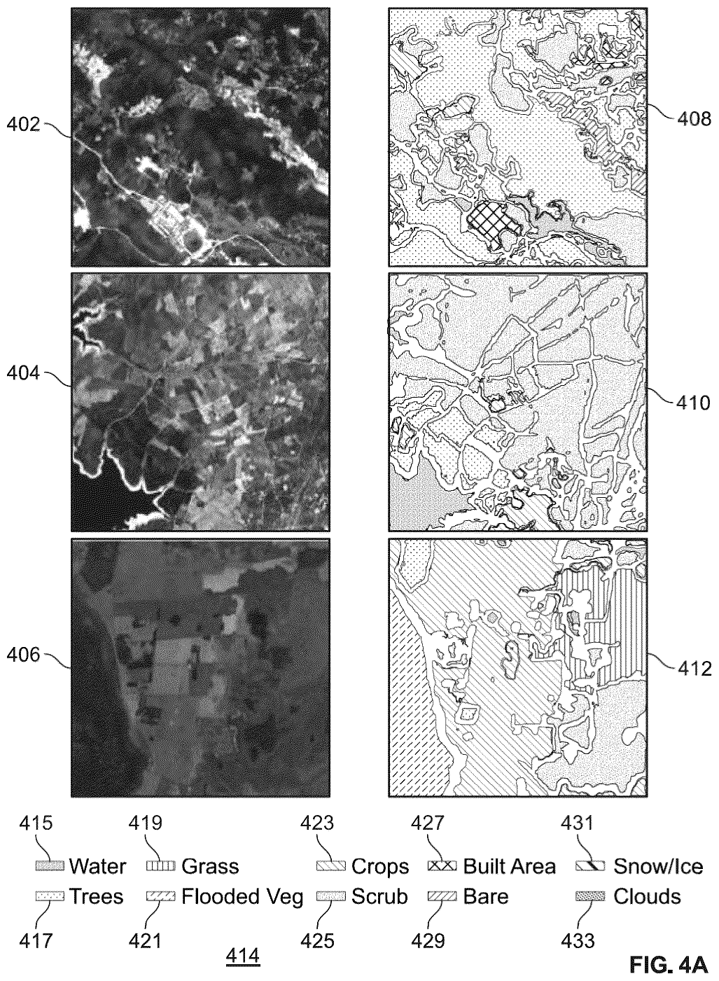

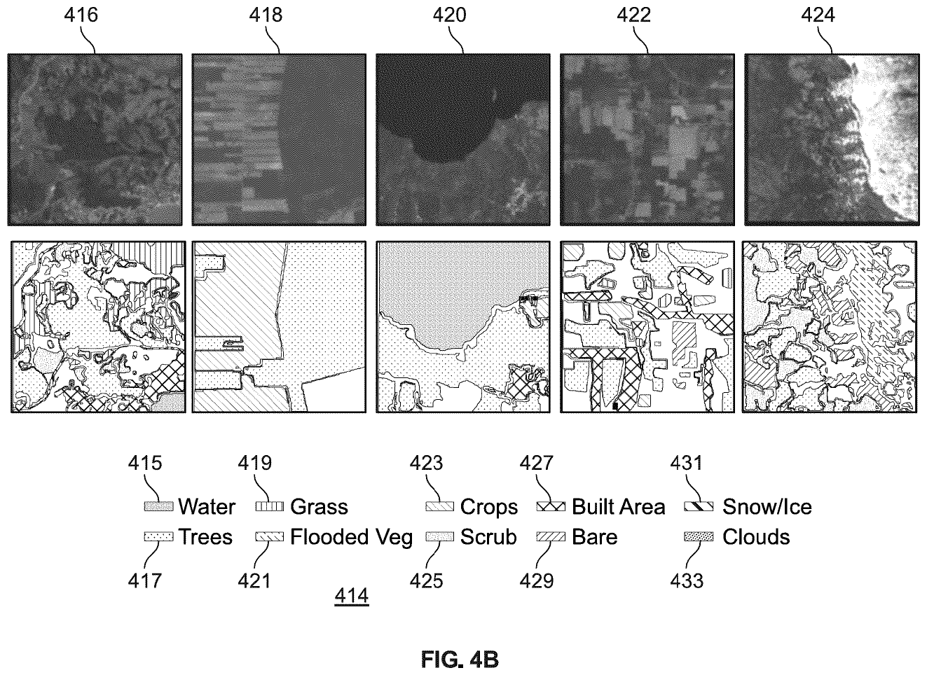

FIGS. 4A-4B show illustrative training images used to train a machine learning model, in accordance with some embodiments of this disclosure. In some embodiments, the mapping system may train machine learning model 305 using boundary information that indicates where boundaries between regions of pixels of different categories are located. For example, the mapping system may enable training overhead images to be annotated or labeled using a dense markup technique, which may comprise drawing or otherwise indicating vector boundaries around individual feature classes (e.g., particular mapping categories) in a particular scene. Such dense labeling may enable machine learning model 305 to learn to recognize patterns associated with spatial and spectral features of boundaries for categorizing images, and may permit a faster recovery of per-pixel labels compared to a single pixel annotation. For example, machine learning model 305 may recognize that a boundary between ocean and desert tends to have certain characteristics, and may be trained to recognize such characteristics in future situations. Any suitable platform (e.g., Labelbox) may be used to draw the vector boundaries around a feature class of an image. In some embodiments, certain mapping categories (e.g., water, trees, crops, built area, bare ground, snow/ice, and/or cloud, and any other suitable mapping category, or any combination thereof) may appear in homogenous agglomerations and lend themselves to being grouped in vector boundaries. In some embodiments, each pixel may be individually labeled as belonging to a particular mapping category without utilizing the dense markup technique, or single pixel labels may be used in combination with dense labeling techniques.

As shown in FIG. 4A, overhead images 402, 404, 406, captured by an imaging device (e.g., aircraft 102, such as, for example, the Sentinel-2 satellite capturing RGB images) may correspond to labeled images 408, 410, 412, respectively. As shown in legend 414 of FIG. 4B, each mapping category may be represented by a corresponding identifier or indicator (e.g., a color, a pattern, or any other suitable distinguishing feature, or any combination thereof) in labeled images 408, 410, 412. Legend 414 may comprise indicator 415 for the water mapping category; indicator 417 for the trees mapping category; indicator 419 for the grass mapping category; indicator 421 for the flooded vegetation mapping category; indicator 423 for the crops mapping category; indicator 425 for the scrubs mapping category; indicator 427 for the built area mapping category; indicator 429 for the bare ground mapping category; indicator 431 for the snow/ice mapping category; and/or indicator 433 for the clouds mapping category, or an indicator for any other suitable mapping category, or any combination thereof. In some embodiments, each labeled image used for training machine learning model 305 may comprise 510×510 pixels (10 m per pixel), or any other suitable number of pixels and/or distance per pixel, or any combination thereof.

FIG. 4B shows overhead images 416, 418, 420, 422, 424 which are labeled by human annotators as shown in labeled overhead training images 426, 428, 430, 432, 434, respectively. Legend 414 of FIG. 4A may be employed in FIG. 4B to identify mapping categories in labeled images 426, 428, 430, 432, 434. In some embodiments, during labeling, certain distinctions may be drawn between overlapping categories (e.g., the built areas mapping category, rather than grass mapping category, may be considered to include lawns and parks). In some embodiments, the mapping system may match a coordinate reference system (CRS) of an input image to the geometry information associated with the training data (e.g., appended as metadata to an image, or using any other suitable technique, or any combination thereof). The training data may comprise any suitable number of examples for each mapping category (e.g., a million examples of a forest region, or any other suitable number of examples for each mapping category) to capture global variability (e.g., a forest in Texas may have different characteristics than a forest in Borneo).

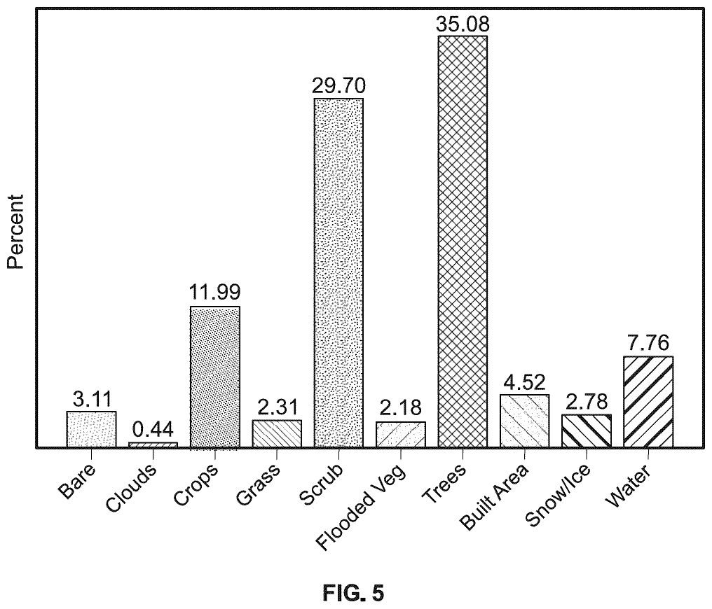

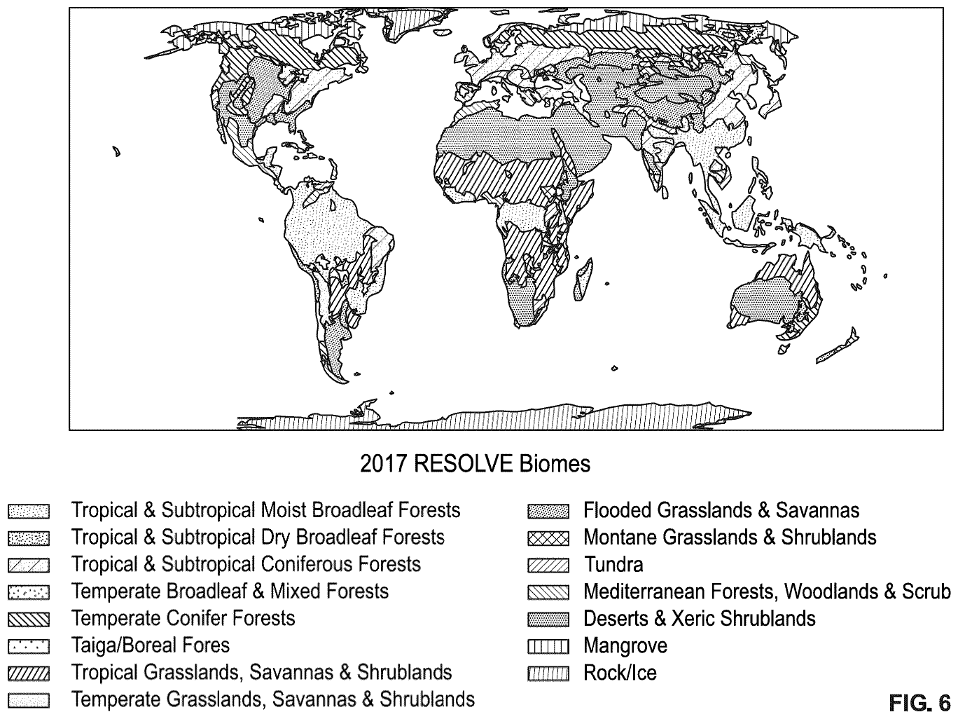

FIG. 5 shows an illustrative distribution of mapping categories of training images used to train a machine learning model, in accordance with some embodiments of this disclosure. Such training images may correspond to geographic areas all over the globe, and across any suitable number of biomes (e.g., 14 biomes, such as for example, as shown in FIG. 6, which shows illustrative geographic locations and biomes associated with training images used to train a machine learning model, in accordance with some embodiments of this disclosure). The images may be collected over the biomes using a random stratified sampling approach, or any other suitable technique, or any combination thereof. In some embodiments, certain categories (e.g., the rock/ice biome category, or any other suitable category, or any suitable combination thereof) may be omitted from the labeled images. The mapping system may weight or bias each class based on a pixel-wise distribution of training data, e.g., based on the computation of natural log(inv(class_pix/total_pix)). For example, each time the model sees an example of a class weight Y, the mapping system may cause such class to be weighted such that the model sees it X*Y times (e.g., if a weight for the bare ground mapping category is 3.5, the model may treat each bare ground pixel as though it has seen it 3.5 times). In some embodiments, the mapping system may de-weight certain mapping categories (e.g., the cloud and snow/ice categories, or any other suitable category, or any combination thereof) in a class weighted mode during model deployment. Such de-weighting may reflect the desire to avoid inferring more frequent mapping category classifications (e.g., clouds in a tropical region, unless clouds consistently appear in images of the region, or snow/ice unless the snow/ice persistently appears in images of a particular region, or any other suitable characteristics in other categories, or any combination thereof). On the other hand, it may be desirable to weight or bias certain mapping categories (e.g., crops or any other suitable category, or any combination thereof) such that a designation of the category should be presented if detected at any point during a desired time frame. Some classes may be under-represented by the model, e.g., grass, flooded vegetation, bare ground, or any other suitable combination, or any combination thereof, which may also change in appearance seasonally (e.g., grass may be green or brown depending on how much rain a region recently received), and thus it may be desirable to weight such classes higher when generating a map (e.g., even if grass isn't the most frequently observed class for a particular pixel, it may be desirable to classify such pixel as grass).

In some embodiments, the mapping system may employ radiometrically-corrected ground range detected (GRD) data, e.g., generated based on images captured by the Sentinel-1 satellite or any other suitable aircraft or image source, in training the model, which may be particularly useful in the model learning the distinction between certain mapping categories, e.g., flooded vegetation versus croplands, bare versus scrub/shrub, or any other suitable distinctions between categories, or any combination thereof. In some embodiments, the mapping system may take into account time-series features (e.g., measures of vegetation health over a year), which may be useful in differentiating between certain mapping categories, e.g., grasslands versus crops versus scrub/shrub, or any other suitable categories, or any combination thereof.

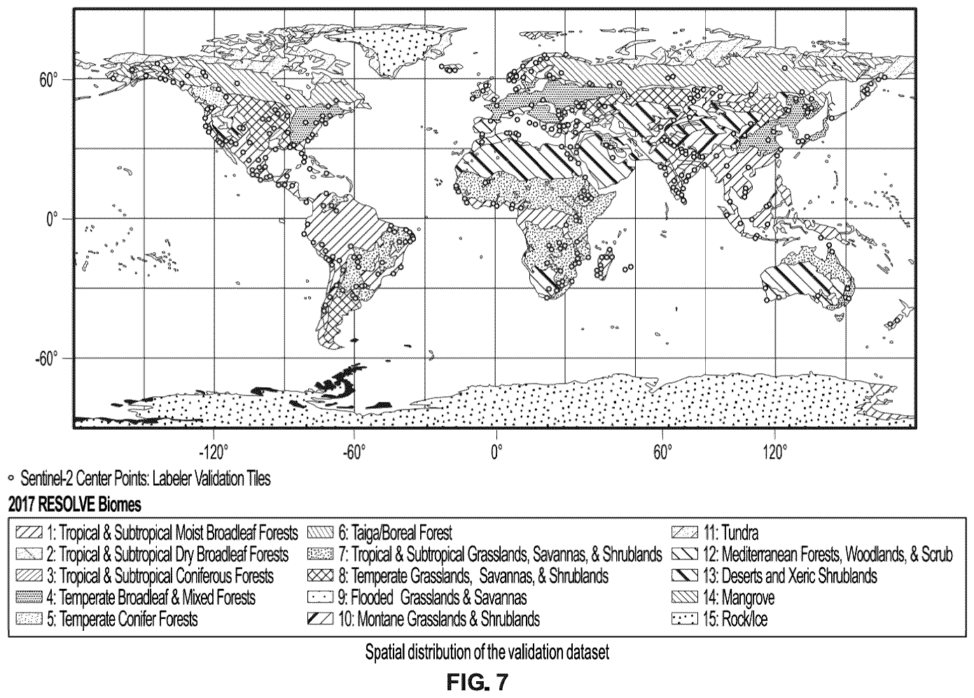

FIG. 7 shows an illustrative spatial distribution of a validation dataset used to tune a machine learning model, in accordance with some embodiments of this disclosure. The map system may employ a validation dataset to evaluate machine learning model 305 after model 305 is trained. In some embodiments, the validation data set may correspond to any suitable amount of training data that is entirely excluded from training (e.g., 15% at the end of each epoch, or any other suitable amount) to combat overfitting. In some embodiments, a “gold standard” set of images or tiles (e.g., labeled by multiple expert annotators, where each expert annotator, or a majority of expert annotators that expressed an opinion, or at least a threshold number of experts, agreed on the appropriate mapping category designation for a particular pixel or group of pixels, or any other suitable metric, or any combination thereof) may be utilized as the validation dataset. Images of any suitable number of sample areas (e.g., over 400, spanning the globe from each suitable biome, as shown in FIG. 7, or any other suitable number of areas and/or biomes, or any combination thereof) may be utilized as the validation dataset. In some embodiments, the mapping system may utilize the validation dataset used to tune hyperparameters of the model (e.g., number of hidden units in a layer, learning rate, choice of activation function, or any other suitable parameters, or any combination thereof). The mapping system may generate error matrices based on such validation dataset to report validation statistics compared to the holdout tiles. For example, an error matrix may include an indication of area proportions for each geographic region along with one or more accuracies. From the error matrix over each region, an area of each class may be computed, e.g., with 95% confidence error bounds. In some embodiments, certain biomes (e.g., rock/ice, or any other suitable biomes or any combination thereof) may be excluded from the validation dataset. In some embodiments, the machine learning model may be applied to validation tiles for each biome individually to ensure that no single biome is underperforming.

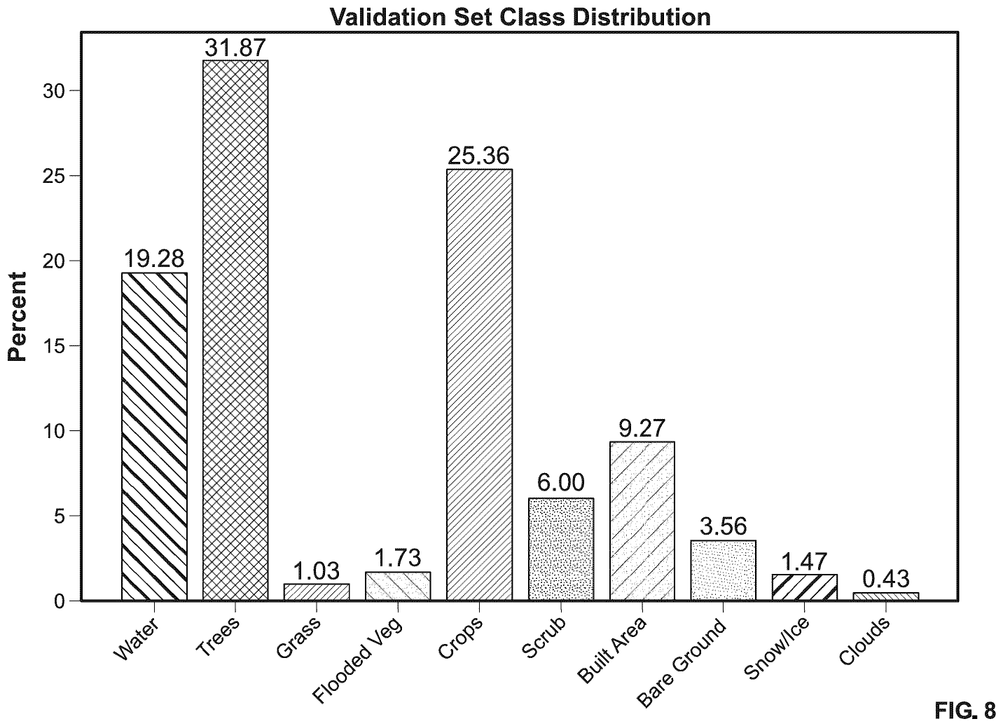

FIG. 8 shows an illustrative distribution of mapping categories of a validation set used to tune a machine learning model, in accordance with some embodiments of this disclosure. In some embodiments, the distribution of mapping categories of the validation dataset may not be evenly balanced, which also may be the case with the training dataset. The distribution of FIG. 8 may correspond to “three expert strict” validation data, e.g., where each of three expert labelers expressed an option on a mapping category of a pixel and agreed on the mapping category classification. Any suitable number of experts may be used in such validation set.

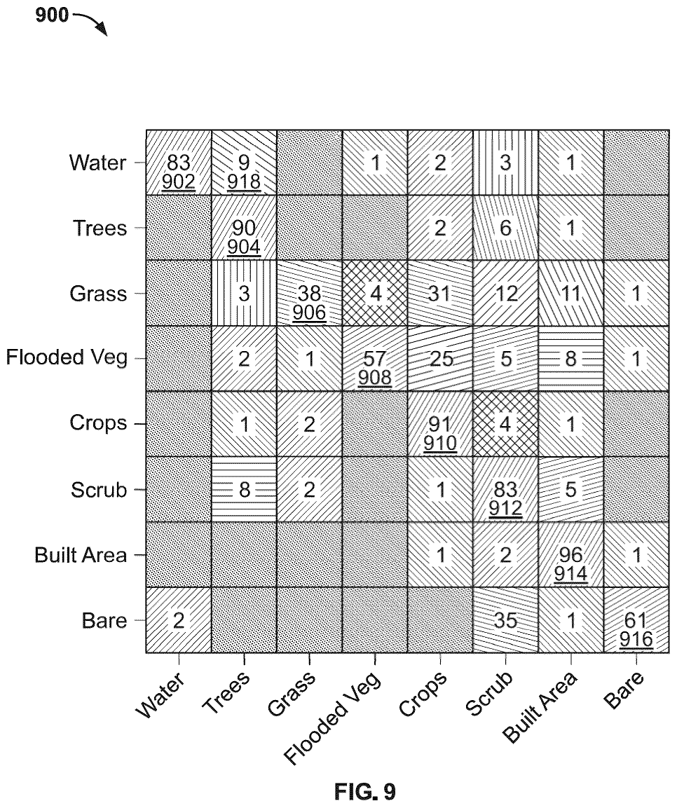

FIG. 9 shows an illustrative confusion matrix used to present validation statistics for a machine learning model, in accordance with some embodiments of this disclosure. Confusion matrix 900 may be generated by the mapping system and may indicate correctly predicted mapping categories in boxes 902, 904, 906, 908, 910, 912, 914, 916 of confusion matrix 900 forming a diagonal through the center of confusion matrix 900. Confusion matrix 900 may indicate, in certain portions of rows or columns thereof, incorrect predictions made on the validation dataset fed into model 305, e.g., box 918 included in the row of the mapping category “water” may indicate the number of pixels incorrectly classified as the mapping category “trees” that were in fact pixels corresponding to the mapping category “water.” In the example of FIG. 9, the confusion matrix indicates that a particular machine learning model (e.g., model 305 of FIG. 3) performed at an accuracy of greater than 85%, varying by mapping category, on a validation dataset. In some embodiments, accuracy of predicted mapping categories may tend to be linked to how often a class is seen in a training dataset.

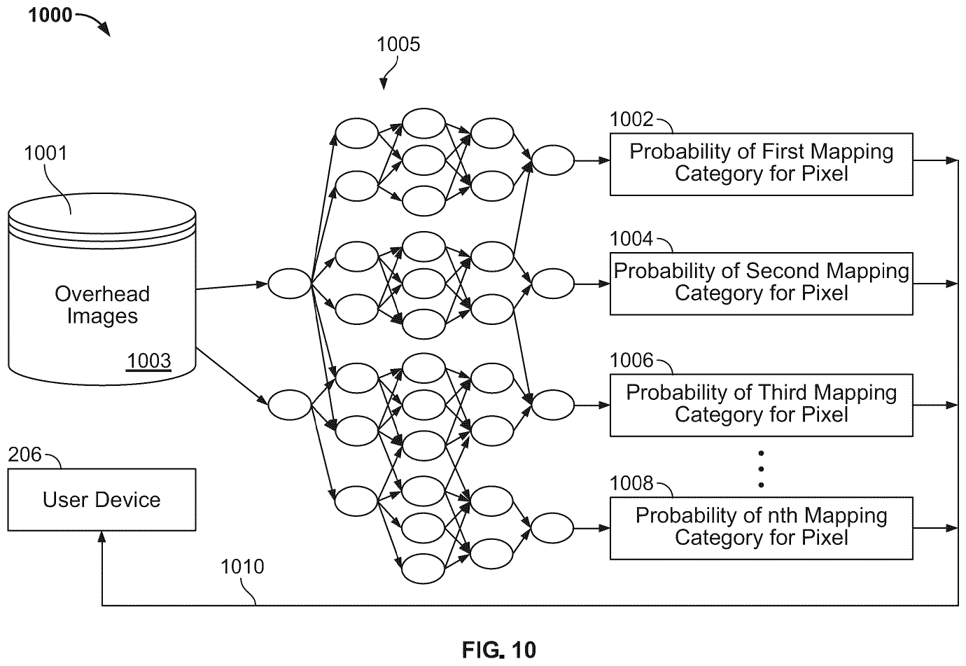

FIG. 10 shows an illustrative block diagram of a system 1000 for using a trained machine learning model 1005 to categorize each pixel of an input overhead image, in accordance with some embodiments of this disclosure. In some embodiments, the mapping system may input a test dataset (e.g., stored at database or data structure 1001) to trained machine learning model 1005 (e.g., model 305 of FIG. 3 having had weights and/or biases thereof optimized during training, and/or having hyperparameters thereof tuned using the validation dataset) to test the accuracy of model 1005. In some embodiments, the mapping system may compare a test set accuracy to the validation set accuracy (e.g., to determine whether the model is overfit). Trained machine learning model 1005 may run on-demand for any region and/or timeframe (e.g., a few days, one or more months, one or more years, a meteorological season, an agricultural season, or any other suitable timeframe) and may be configured to receive an input image from among overhead images 1003 (e.g., stored at database or data structure 1001) and output for each pixel of the image a probability that the pixel belongs to a particular mapping category. Trained machine learning model 1005 may be configured to output probabilities 1002, 1004, 1006, 1008 concerning a mapping category for a pixel of an image input to model 1005.

In some embodiments, trained machine learning model 1005 may provide, based on outputs 1002, 1004, 1006 and 1008, feedback information 1010. Feedback information 1010 may comprise confidence information, such as, for example, a numerical confidence score or a flag indicating a level (e.g., high or low) of confidence for a particular output of trained machine learning model 1005. The mapping system may be configured to determine, based on the confidence information indicated in feedback information 1010, that an additional training overhead image is necessary, and, in particular, the type of training overhead image image(s) to obtain based on the images having been determined to have a low enough confidence, e.g., compared to a threshold confidence level. For example, each of outputs 1002, 1004, 1006 and 1008 may be associated with respective confidence scores assigned by trained machine learning model 1005 that may represent the likelihood that a designation of a particular mapping category for a pixel of input overhead images is correct. In some embodiments, the type of image(s) to obtain may correspond to a particular geographic area or portions thereof, and/or one or more particular mapping categories. In some embodiments, the threshold confidence level can be predetermined (e.g., 0.5, or any other suitable value, such as on a scale of zero to one) or dynamic (e.g., variable based on a particular application for the training overhead image, image quality of the training overhead image, equipment used to capture the training overhead image, or based on any other suitable attribute or characteristic associated with the training overhead image, or based on any combination thereof). In some embodiments, the mapping system may be configured to determine, based on the confidence information indicated in feedback information 1010, whether to confirm, add or update mapping category labels for existing training overhead images, e.g., for a particular geographic area or portion thereof. In some embodiments, such as if one or more pixels of the input overhead images input to trained machine learning model 1005 were not labeled, feedback information 1010 may suggest that one or more of such pixels be provided with a label.

In some embodiments, training overhead images 302 may be updated based on the obtained one or more additional training overhead images, and/or based on one or more mapping category designations for the respective pixels of the at least one of the plurality of training overhead images 302. Trained machine learning model 1005 may be updated using the updated plurality of training overhead images. For example, trained machine learning model 1005 may be further trained using the updated plurality of training overhead images comprising the obtained one or more additional training overhead images.

In some embodiments, feedback information 1010 may be provided by trained machine learning model 1005 to user device 206 (and/or or server 202 or any other suitable component of the mapping system) and/or to particular equipment, e.g., aircraft 102, or any other suitable device or vehicle or equipment, or any combination thereof, which may be equipped with a computing system adjacent to or collocated with image sensor 223 and/or any other suitable sensor(s) or imagery source(s). Such computing system of the particular equipment, e.g., processing circuitry, I/O circuitry 222, communications circuitry 224, storage 226, memory 228 and/or any other suitable component or any combination thereof, may be configured to implement trained machine learning model 1005 with image sensor 223 and/or any other suitable sensor(s) or imagery source(s). Processing circuitry 220 of the particular equipment may be configured to receive feedback information 1010 and cause image sensor 223 and/or other suitable sensors to collector updated training data based on feedback information 1010, as well as update the plurality of training overhead images 302 and update machine learning model 1005 using the updated plurality of training overhead images. For example, the particular equipment, e.g., aircraft 102, may be a drone or satellite that uses feedback information 1010 to instruct itself regarding a particular geographic location at which additional images should be captured. In some embodiments, the particular equipment, e.g., aircraft 102, may be in communication with one or more of the components of system 200 which may implement a cloud-based system. Alternatively, the particular equipment, e.g., aircraft 102, may be configured to implement the receiving of feedback information 1010, the determination of whether an additional overhead training image or updated overhead training image in necessary, the updating of the plurality of training overhead images 302 with one or more additional overhead training images and/or one or more updated overhead training images, and the updating of machine learning model 1005 and deployment of the updated machine learning model 1005 in isolation in a closed system.

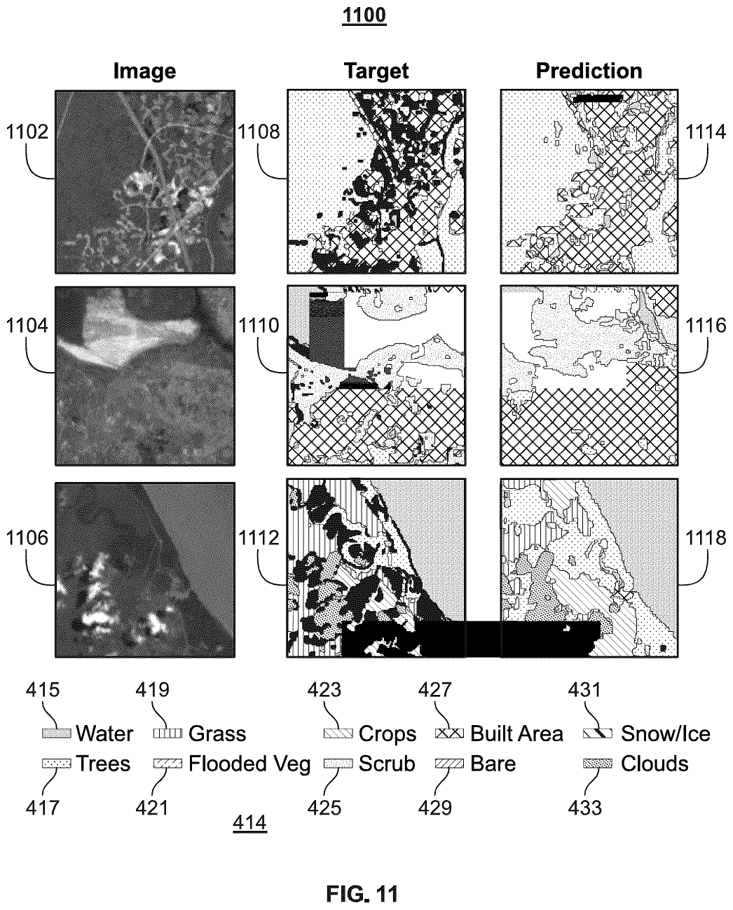

FIG. 11 shows illustrative captured overhead images, labeled versions of the captured images, and predictions of mapping categories of the captured images as output by a trained machine learning model to categorize each pixel of an input overhead image, in accordance with some embodiments of this disclosure. For example, overhead images 1102, 1104, 1106 (e.g., captured by aircraft 102), may correspond to labeled images 1108, 1110, 1112, respectively, where each particular mapping category indicated in labeled images 1108, 1110, 1112 may be represented by one of the particular colors (or other suitable indicators) indicated in legend 1120 (or other distinguishing characteristic, or any combination thereof). Images 1114, 1116, 1118 represent predictions by trained model 1005 of respective mapping categories for pixels of images 1102, 1104 and 1106. For example, FIG. 11 shows a side-by-side comparison of images 1114, 1116, 1118 output by model 1005 and images 1102, 1104, 1106 as labeled by human editors (e.g., images 1108, 1110, 1112 may not be input to the model and may be utilized in the example for comparison purposes to the predicted mapping categories of pixels of images 1114, 1116, 1118). In some embodiments, unlabeled pixels (e.g., pixels 1122) may be predicted and filled in by trained model 1005, e.g., to provide a fuller representation than is provided in certain training data.

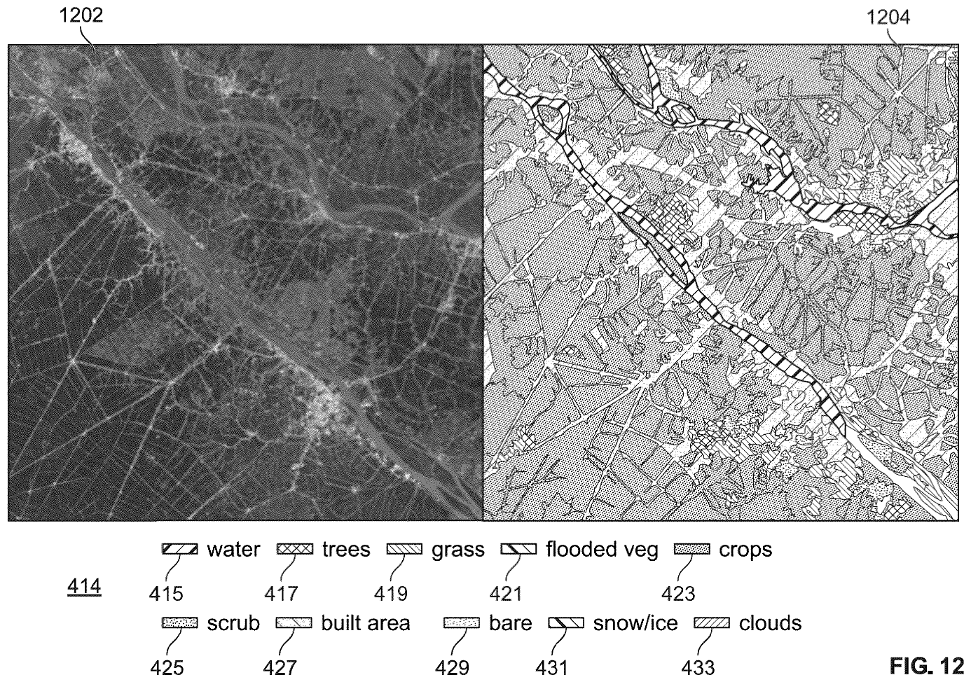

FIG. 12 shows an illustrative captured overhead image and a prediction of mapping categories output by a trained machine learning model to categorize each pixel of an input overhead image, in accordance with some embodiments of this disclosure. As shown in FIG. 12, image 1204, e.g., output by trained machine learning model 1005, may comprise a plurality of colors or other indications of which mapping category of a plurality of mapping category to which pixels of image 1204 belong (e.g., as indicated at legend 414). Model 1005 is able to capture small villages (e.g., the “built area” mapping category depicted in red) and canals in an otherwise largely agricultural landscape (e.g., indicated by an orange color, or another suitable indicator, for the “crops” mapping category).

The mapping system may employ various techniques to leverage trained machine learning model 1005 over geographic areas of interest, e.g., desired regions of the earth, over a predefined period of time (e.g., incorporating relevant data across an entire year or other desired period of time). For example, the mapping system may deploy the model on a composite image, e.g., to generate a composite image comprising image data captured over the entire predefined period of time, and such generated composite image may be input into model 1005, to yield classifications which may be representative of the time frame. As another example, the mapping system may generate a composite of classifications. For example, the mapping system may individually input to the machine learning model images captured over the predefined period of time, e.g., so that the model is being provided image data matching the type of data it may be trained on. For example, the model may be run on multiple individual scenes from multiple points in time, and the mapping system may composite the results of the classification.

In some embodiments, the mapping system may analyze composite images or maps from previous years matching the specific time of year requested for a new composite image or map to be generated. For example, if a requested time period for the composite image is spring of 2022, the mapping system may take into account a particular mapping category that is determined most frequently (or most confidently) in spring of 2021 for the geographic area (and/or for spring of any other suitable year(s)) when generating the composite image. In some embodiments, For each respective pixel of the composite image, the processing circuitry may cause the pixel to be represented as being of the same particular mapping category that is identified for the pixel of the plurality of overhead images that corresponds to the pixel of the composite image.

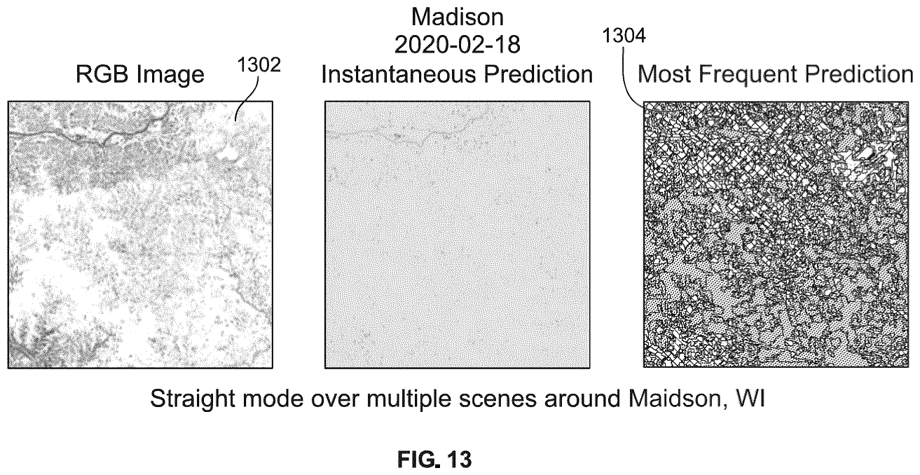

As shown in FIG. 13, in some embodiments, the mapping system may employ a straight mode technique in which the mapping category determined most frequently by trained machine learning model 1005 may be identified, e.g., by way of a pixel-wise mode operation over a plurality of overhead images of the same geographic area. FIG. 13 depicts an illustrative image 1302 resulting from the straight mode technique being utilized over multiple images (e.g., including image 1302) captured in a geographic vicinity of Madison, Wisconsin. The mapping system may generate a composite image based on the straight mode technique by identifying, for each pixel of the plurality of overhead images of the particular geographic area, a particular mapping category that is determined most frequently by the trained machine learning model over the time period. Additionally or alternatively, the mapping system may generate a composite image based at least in part on identifying, for each pixel of the plurality of overhead images of the particular geographic area, a particular mapping category associated with the highest confidence score, as output by the trained machine learning model, over such time period. For each respective pixel of the composite image, the mapping system may cause the pixel to be represented as being of the same particular mapping category that is identified for the pixel of the plurality of overhead images that corresponds to the pixel of the composite image.

In some embodiments, the mapping system may employ a class weighted mode technique, which may comprise an algorithmic formulation for generating a composite of classifications, suitable for large-scale deployment. The mapping system may employ the class weighted mode technique, which may leverage the observation that some mapping categories may be under-represented by the model, e.g., grass, flooded vegetation, bare ground, forest, built area, scrubland, grassland, and/or rangeland, which may also change in appearance seasonally (e.g., grass may be green or brown depending on how much rain a region recently received), and thus it may be desirable to weight such classes higher when generating a map (e.g., even if grass isn't the most frequently observed class for a particular pixel, it may be desirable to classify such pixel as grass). As discussed herein, the mapping system may cause weights to be set during training (e.g., sample weights) such that each mapping category (or one or more of the mapping categories) may be set to a different weight (e.g., determined based on the distribution of pixels across mapping categories in the original training dataset, or any other suitable technique, or any combination thereof), and a similar technique may be utilized in formulating the class weighted mode. For example, in the class weighted mode, the mapping system may combine (e.g., multiply or otherwise combine) respective probabilities associated with each mapping category with the desired weights for particular mapping categories (as compared to other mapping categories), in a pixel-wise manner, to weight the mode computation. For example, the mapping system may cause certain classes (e.g., grass and flooded vegetation, and/or forest, built area, scrubland, grassland, and/or rangeland) to be heavily weighted whereas other classes (e.g., crops and bare grounds) may be assigned relatively lower weights, while other classes (e.g., snow/ice and clouds) may be weighted even lower (e.g., to minimize predictions for such mapping categories unless such categories are persistently identified over time). In some embodiments, the mapping system may cause the class weighted mode to utilize raw probability data (e.g., prior to a softmax or argmax computation) in performing weighting of mode classifications. In some embodiments, mode weighted by specific weights per class may formulate a custom class weight, multiply probabilities by class weights, and compute the weighted mode. In some embodiments, alternative or in addition to taking into account the respective probabilities associated with each mapping category, the class weighted mode may take into account a likelihood with respect to a particular mapping category, and/or confidence score with respect to a particular mapping category, and/or a degree of similarity to one or more pixels of one or more of the training overhead images.

In some embodiments, the mapping system may specify, during a temporal compositing of the model outputs, a weight per class, which may take into account a seasonal adjustment. For example, the mapping system may weight a mapping category for grass higher because it is highly seasonal and may only show up a few times per year. Based on gained knowledge and observations of how certain classes appear throughout the course of the year, as well as less-represented classes in the training dataset, the mapping system may assign weights to each class for use in the class weighted mode computation. In some embodiments, particular geographic regions or ecoregions may be assigned separate weights or tuned differently. For example, the mapping system may assign separate weights to the continent of Africa (or any other suitable cot intent or region, or any combination thereof) compared to the rest of the world, in particular to increase sensitivity to the types of smallholder agriculture unique to the region, and/or ecologically homogenous spatial regions may be similarly weighted or biased (e.g., in one or more of the machine learning model and/or temporal compositing of images).

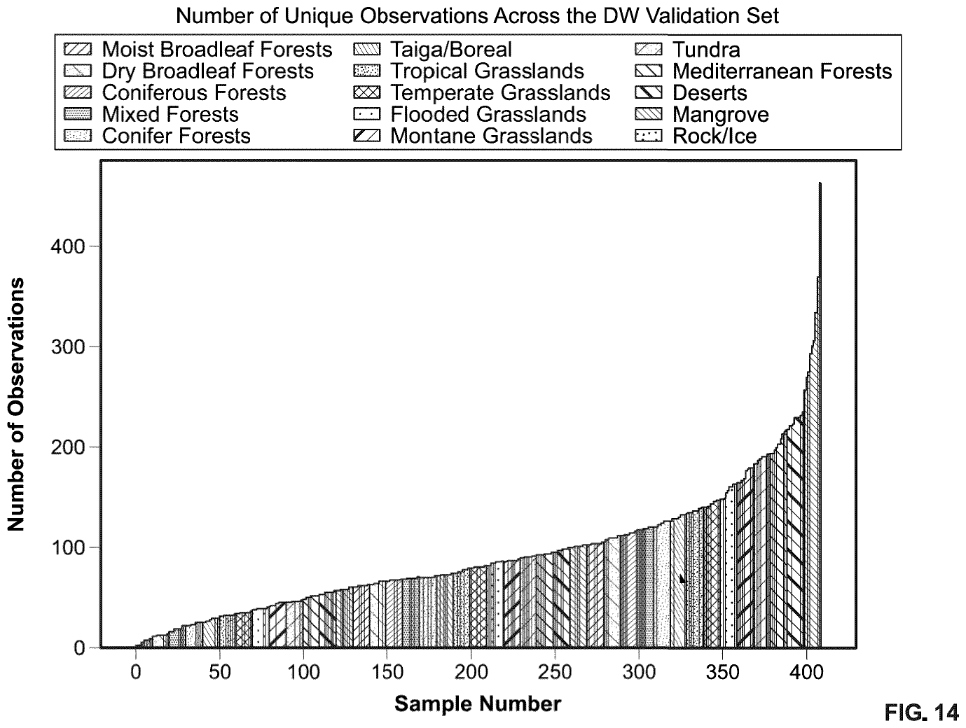

FIG. 14 depicts an illustrative evaluation of the performance of a class weighted mode on a validation dataset, in accordance with some embodiments of this disclosure. For each validation tile, the mapping system may utilize cloud-filtered data (or any other suitable type of data, or any combination thereof) within a predefined range of a timestamp of each image (e.g., six months prior to, and subsequent to, the time stamp to obtain a year's worth of image data for each validation tile). In some embodiments, the number of images retrieved by way of the mapping system via the cloud-filtered data may depend on how cloudy a particular region is (e.g., many hundreds of images may be captured and input to the model over a predefined period of time if a particular region is determined to be cloudy, whereas significantly less images may be utilized in a less cloddy region). For example, for the 12 months of data which may correspond to each validation tile, the model may output predictions of mapping categories for each respective pixel, and the mapping system may compute the class weighted mode across each of such predictions. In some embodiments, confusion matrices may be generated to measure the performance of the model when the class weighted mode is utilized, and certain mapping categories (e.g., snow/ice and clouds, or any other suitable mapping category, or any combination thereof) having been dis-incentivized based on weights assigned to such categories may not be included within the accuracy computations. FIG. 14 depicts a graph representing a number of unique observations per tile across the validation set, which may vary depending on biome and geography (e.g., based on how cloudy and/or tropical a particular region is).

Each validation tile may represent an image (and corresponding mapping category) at a single instance in time. The model may be deployed over a series of images captured across a year and then combined together, and the same approach may be used in validation so that the results are representative of the global map. For each validation timestamp, overhead imagery from the entire year, which may be processed by the mapping system (e.g., filtered by cloud cover to remove images depicting a clouds in at least a predetermined threshold amount of pixels) may be input to the model over the resulting imagery for each validation tile, and the mapping system may compute a class weighted mode across the model results. In some embodiments, the mapping system may utilize scene selection logic and a class weighted mode matching the logic used in deploying the global model.

In some embodiments, such temporal composite of model outputs allows emphasis of certain classes over others, and also provides the model with robustness to cloud cover and seasonal snowfall. However, this may make accuracy comparison for these classes challenging within the validation formulation. For example, if there were clouds during a validation scene, the mapping system may cause the temporal composite to remove the cloud cover by aggregating data from other scenes in the years, and for seasonal snowfall, the model may only report persistent snow cover (e.g. glaciers, permanent snowpack). In some embodiments, snow and clouds (or any other suitable classes, or any combination thereof) in the global map may be excluded from the accuracy calculation. From the output of the class weighted mode per validation tile, the mapping system may compute an overall accuracy percentage by counting the number of correct pixel classifications across all classes and dividing by the total number of available pixels. Similarly, the mapping system may compute a confusion matrix, which may show the accuracy and confusers per class, as discussed in connection with FIG. 9.

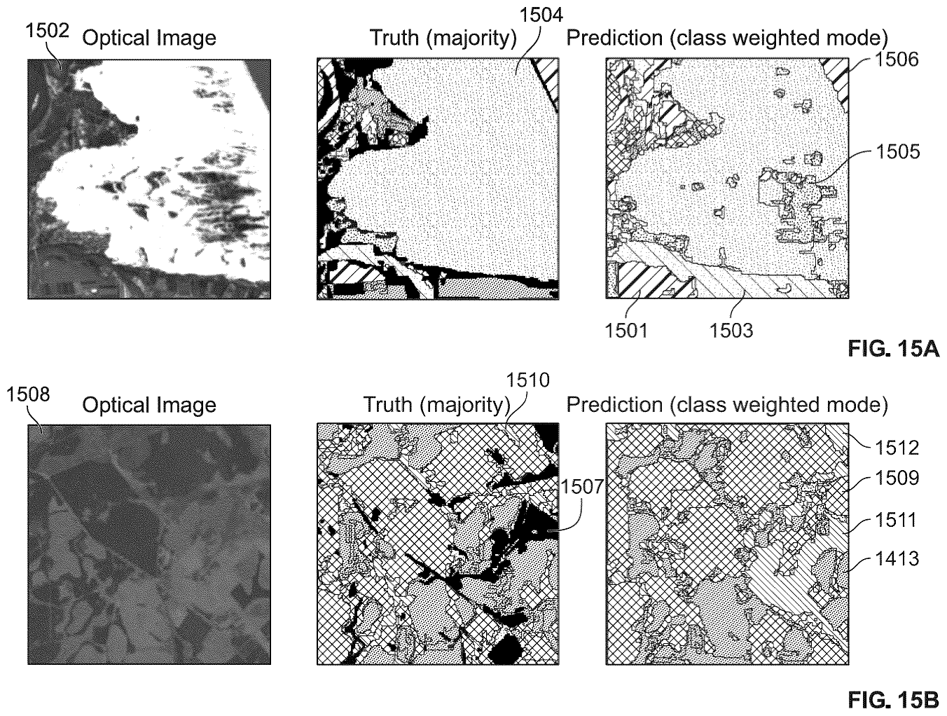

FIGS. 15A-15B show illustrative resulting images when a machine learning model is deployed along with a class weighted mode, in accordance with some embodiments of this disclosure. The mapping system may cause image 1502 of FIG. 15A to be input to machine learning model 1005. Image 1504 may reflect human editor markup of various mapping categories. Image 1506, output from model 1005 and to which the class weighted mode is applied, may indicate more nuanced mapping category identifications than image 1504 (e.g., mapping category 1505, corresponding to scrub, or any other suitable category or any combination thereof, of image 1506). In some embodiments, such nuanced mapping category may differentiate between mapping category regions (e.g., teasing out different vegetation types, distinguishing between water and flooded vegetation, distinguishing between urban areas and bare ground, or any other suitable differentiations, or any combination thereof).

FIG. 15B shows captured optical image 1508 which may be input to machine learning model 1005. Image 1510 may reflect human editor markup of various mapping categories. Image 1512, output from model 1005 and to which the class weighted mode is applied, may predict or infer portions 1507 that are unlabeled in image 1510, and may clearly differentiate between mapping category regions (e.g., trees 1509, grass 1511, crops 1513).

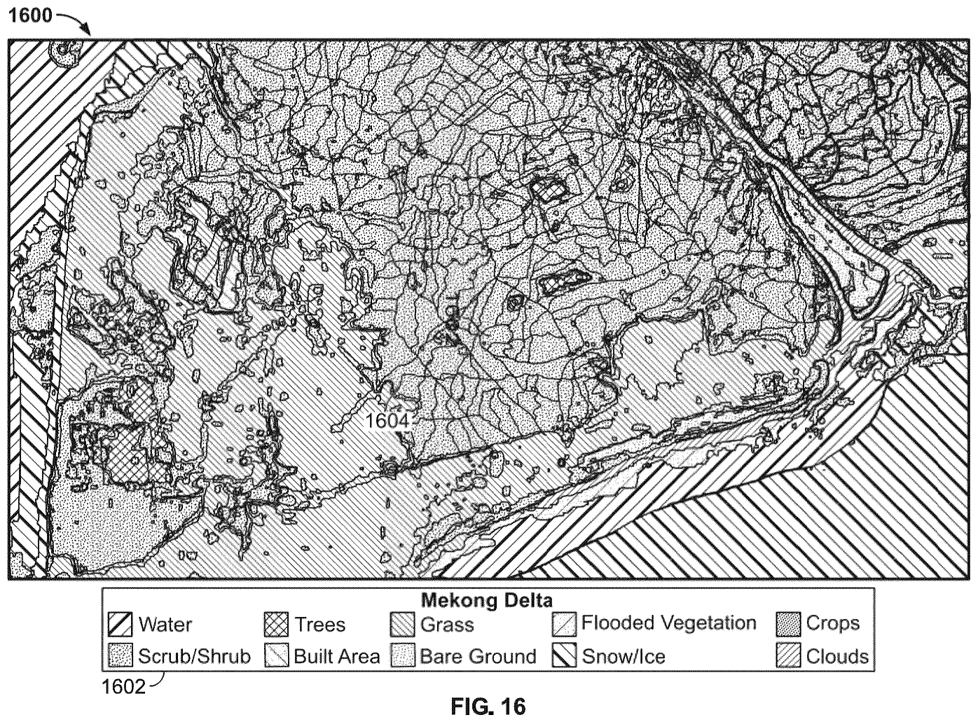

FIG. 16 shows an illustrative map 1600 of a geographic area associated with a plurality of overhead images generated based on the plurality of overhead images and on categories determined by a machine learning model, in accordance with some embodiments of this disclosure. Map 1600 depicts the Mekong River Delta in Southern Vietnam at a resolution of 10 meters per pixel. The mapping system may generate map 1600 based on mapping category predictions or classifications or inferences output by machine learning model 1005 for each pixel of a plurality of overhead training images input to model 1005, and using one or more of the aforementioned techniques (e.g., the class weighted mode or any other suitable technique or any combination thereof) to composite together images of the particular region captured over a predefined period of time (e.g., one year). Legend 1602 indicates the correspondence between certain colors (or other indicators) depicted in map 1600 and mapping categories (e.g., an orange color, or another suitable indicator, represents the mapping category crops, a red color, or another suitable indicator, represents the mapping category built area, etc.). Map 1600 may comprise dense lines of indicative of the mapping category “built area,” such as depicted at 1604, e.g., villages built along roads and irrigation canals. Central and northern areas are dominated by rice paddies, while the water further south represents aquaculture ponds. In some embodiments, a display (e.g., display 235 of FIG. 2) presenting map 1600 may include a temporal axis (e.g., a slider option selectable to toggle between various times of the year during which the plurality of images of the area of interest (e.g., arbitrarily large) were captured, to cause the display to depict mapping categories corresponding to the selected time period). In some embodiments, the output map generated by the mapping system may highlight features previously unseen in global land cover maps, e.g., meandering streams, rural villages, and pockets of permanent snowfields.

In some embodiments, the model may be trained to recognize biome-specific characteristics, which may differ in particular geographic areas (e.g., grass may look brown in New Mexico, but brighter in Ireland, or any other suitable characteristics, or any combination thereof). In some embodiments, the mapping system may train biome-specific models to recognize such characteristics in particular geographic areas. Additionally or alternatively, data from multiple time points may be used to generate a change detection algorithms (e.g., to determine a time point within multiple overhead images when a significant change occurred regarding mapping categories predicted in a particular region). In some embodiments, the mapping system may input captured overhead images (e.g., Sentinel-2 imagery or any other suitable imagery or any combination thereof) to trained machine learning model 124 annually (or at any other suitable time interval), to provide up-to-date global mapping information.

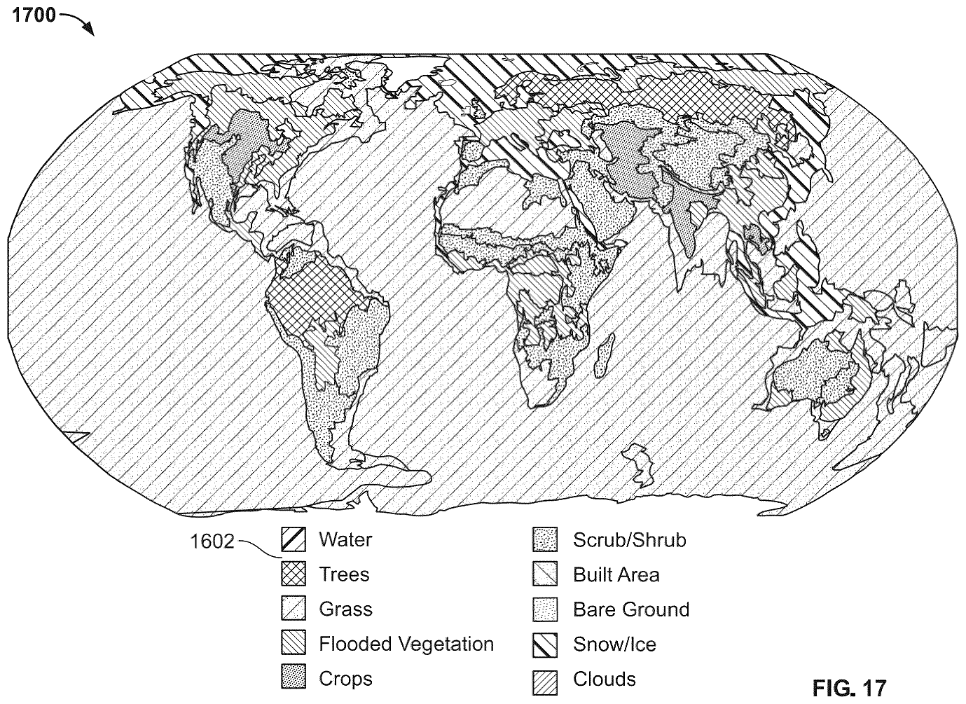

FIG. 17 shows an illustrative map 1700 of a geographic area associated with a plurality of overhead images generated based on the plurality of overhead images and on categories determined by a machine learning model, in accordance with some embodiments of this disclosure. Map 1700 is a global map depicting planet earth. Map 1700 may be generated by the mapping system based on mapping category predictions or classifications output by machine learning model 1005 for each pixel of a plurality of overhead training images input to model 1005, and using one or more of the aforementioned techniques (e.g., the class weighted mode or any other suitable technique of any combination thereof) to composite together images of each region of earth captured over a predefined period of time (e.g., one year). Legend 1702 indicates the correspondence between certain colors (or other suitable indicators) depicted in map 1600 and mapping categories (e.g., an orange color, or another suitable indicator, represents the mapping category crops, a red color, or another suitable indicator, represents the mapping category built area).

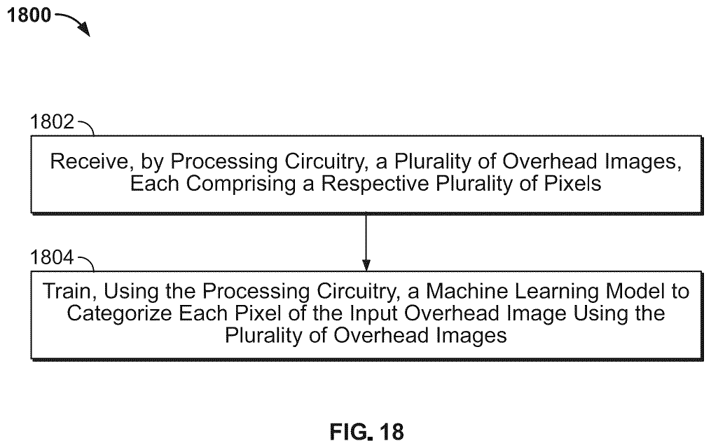

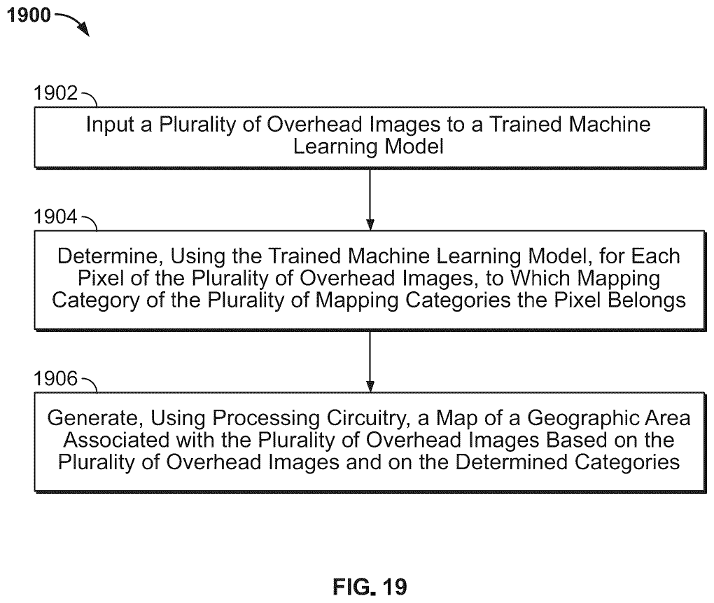

FIG. 18 is a flowchart of a detailed illustrative process 1800 for training a machine learning model, in accordance with some embodiments of this disclosure. In various embodiments, the individual steps of process 1800 may be implemented by one or more components of the devices, methods, and systems discussed in FIGS. 1-17. Although the present disclosure may describe certain steps of process 1800 (and of other processes described herein) as being implemented by certain components of the devices and systems of FIGS. 1-17, this is for purposes of illustration only, and it should be understood that other components of the devices and systems of FIGS. 1-17 may implement those steps instead. In addition, one or more steps of process 1800 may be incorporated into or combined with one or more steps of any other process or embodiment (e.g., FIG. 19 or FIG. 20 or FIG. 21 or FIG. 22, or any other embodiment disclosed herein, or any combination thereof).

At 1802, the mapping system receives a plurality of overhead images (e.g., images 110, 112, 114, 116, 118 captured at 106 of FIG. 1). Each received image may comprise a respective plurality of pixels. In some embodiments, each pixel of each image may be designated (e.g., at 108 of FIG. 1) as being of a particular mapping category of a plurality of mapping categories (e.g., clouds, snow/ice, grass, trees, cropland, built area, bare ground, flooded vegetation, water, or scrub/shrub). In some embodiments, the designation may be based on using boundary information to indicate where boundaries between regions of pixels of different categories are located, e.g., the overhead image may be annotated to comprise an indication of the boundary information (e.g., a dense labeling of pixels and neighboring pixels).

At 1804, the mapping system may train a machine learning model (e.g., model 305 of FIG. 3) to categorize each pixel of an input overhead image using the plurality of overhead images received at 1802. In some embodiments, model 305 may comprise a convolutional neural network, which may comprise one or more of input layer 307, hidden layer 309 and output layer 311. The machine learning model may categorize each pixel by outputting respective probabilities for each particular mapping category, and the mapping category having the highest probability may correspond to the categorization. It should be appreciated that any suitable number of training images may be utilized to train the machine learning model. For example, the training data for use comprise training overhead images of a predefined dimensioned area of the planet (e.g., 24,000 5 km×5 km images or 100 km×100 km images collectively comprising over 5 billion human-labeled pixels, where each image may each be 510×510 pixel RGB natural-color images).

FIG. 19 is a flowchart of a detailed illustrative process 1900 for generating a map of a geographic area, in accordance with some embodiments of this disclosure. In various embodiments, the individual steps of process 1900 may be implemented by one or more components of the devices, methods, and systems discussed in FIGS. 1-16. Although the present disclosure may describe certain steps of process 1900 (and of other processes described herein) as being implemented by certain components of the devices and systems of FIGS. 1-16, this is for purposes of illustration only, and it should be understood that other components of the devices and systems of FIGS. 1-17 may implement those steps instead. In addition, one or more steps of process 1900 may be incorporated into or combined with one or more steps of any other process or embodiment (e.g., FIG. 18 or FIG. 20 or FIG. 21 or FIG. 22, or any other embodiment disclosed herein, or any combination thereof).

At 1902, the mapping system may input a plurality of overhead images (e.g., images 110, 112, 114, 116, 118 captured at 106 of FIG. 1) to a trained machine learning model (e.g., model 1005 of FIG. 11). In some embodiments, the machine learning model may be trained by receiving a plurality of training overhead images, each comprising a respective plurality of pixels, each pixel of each training overhead image of the plurality of training overhead images designated as being of a particular mapping category of a plurality of mapping categories, and training the machine learning model to categorize each pixel of an input overhead image using the plurality of training overhead images, in a similar manner as discussed in connection with FIG. 18.

At 1904, the mapping system may determine, using the trained machine learning model (e.g., model 1005 of FIG. 11) for each pixel of the plurality of overhead images (e.g., images 1102, 1104, 1106 of FIG. 11), to which mapping category of the plurality of mapping categories the pixel belongs (e.g., as depicted by the colors, or other suitable indicators, in images 1114, 1116, 1118 which represent respective mapping categories).

At 1906, the mapping system may generate a map of a geographic area (e.g., a global map as shown in FIG. 17, or a portion thereof, such as the Mekong River Delta in Southern Vietnam as shown in FIG. 16) based on the plurality of overhead images and on the determined categories. In some embodiments, for each overhead image input to the machine learning model, the machine learning model may output a map (e.g., image 1204 of FIG. 12) comprising indications of a mapping category for each pixel for a particular geographic region.

For each geographic region (e.g., spanning the globe), a plurality of images from various times over the course of, e.g., one year or any other suitable time period, may be respectively input to the machine learning model, and for each geographic region, one or more of a variety of techniques (e.g., a straight mode and/or a class weighted mode, as discussed above) may be utilized to composite together a plurality of maps output for each geographic region (e.g., to obtain a single map for each region reflecting the mapping categories that best classify each pixel representing portions of the region). The resulting map for each region may then be composited or stitched together to form a global map (e.g., map 1700 of FIG. 17).

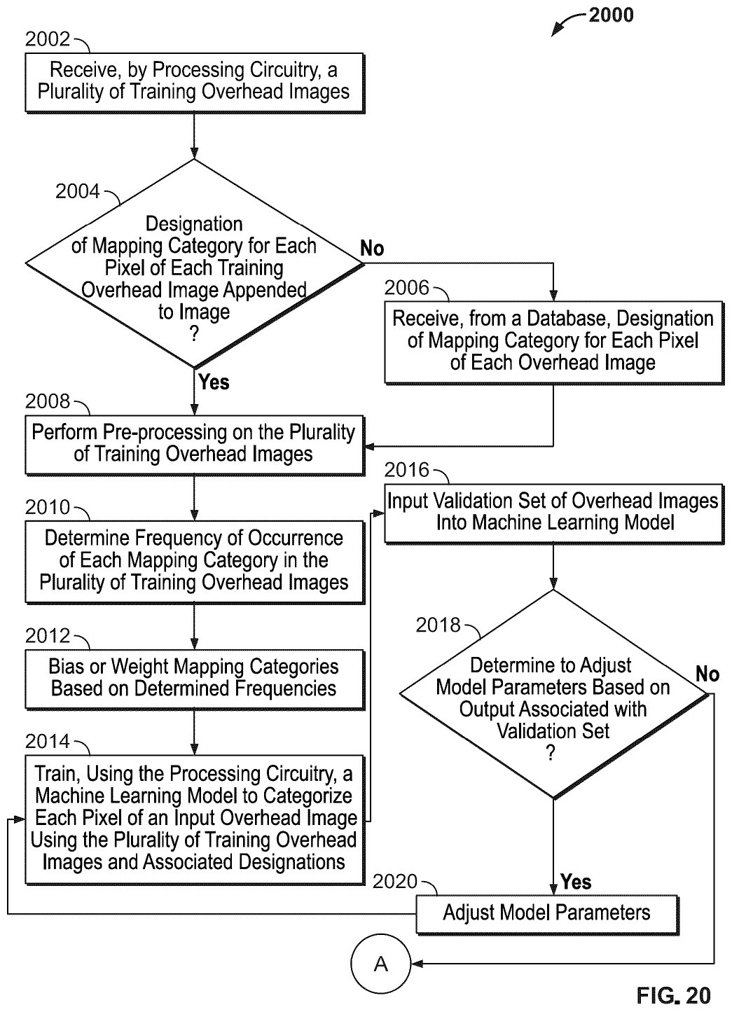

FIG. 20 is a flowchart of a detailed illustrative process 2000 for generating a map of a geographic area, in accordance with some embodiments of this disclosure. In various embodiments, the individual steps of process 2000 may be implemented by one or more components of the devices, methods, and systems discussed in FIGS. 1-16. Although the present disclosure may describe certain steps of process 2000 (and of other processes described herein) as being implemented by certain components of the devices and systems of FIGS. 1-16, this is for purposes of illustration only, and it should be understood that other components of the devices and systems of FIGS. 1-17 may implement those steps instead. In addition, one or more steps of process 2000 may be incorporated into or combined with one or more steps of any other process or embodiment (e.g., FIG. 18 or FIG. 19 or FIG. 21 or FIG. 22, or any other embodiment disclosed herein, or any combination thereof).

At 2002, the mapping system may capture or otherwise receive a plurality of training overhead images. 2002 may be performed in a similar manner as 1802.

At 2004, the mapping system may determine, e.g., by analyzing an image file associated with each training overhead image, whether a designation of a mapping category for each pixel of each training overhead image is appended to the received training overhead image. If each pixel is associated with a designation, processing may proceed to 2008. If at least one pixel is not associated with a designation, processing may proceed to 2006.

At 2004, the mapping system may access information associated with the one or more images (and associated pixels thereof) to which respective mapping categories are not appended. Upon receiving the requested mapping category designations, processing may proceed to 2008.

At 2008, the mapping system may optionally perform one or more pre-processing techniques on the plurality of training overhead images. For example, a class weight for unlabeled pixels (i.e., no data) may be zeroed out, thereby forcing model 305 to ignore unlabeled regions in overhead training images during training.

At 2008, the mapping system may determine a frequency of occurrence of each mapping category in the plurality of overhead images. In some embodiments, based on the determined frequencies, the mapping system may, at 2012, perform weighting or biasing of certain mapping categories. For example, certain mapping categories (e.g., under-represented in the training set) may be assigned relatively higher weights or biases, whereas other mapping categories (e.g., having a high frequency in the training set) may be assigned relatively lower weights or biases.

At 2014, the mapping system may train a machine learning model (e.g., model 305 of FIG. 3) to categorize each pixel of an input overhead image using the plurality of training overhead images and associated designations. 2014 may be performed in a similar manner as 1804.

At 2016, once the model is trained and/or during the training process, the mapping system may input a validation set (e.g., corresponding to the validation set having the characteristics shown in FIGS. 7-8) into the machine learning model (e.g., model 1005 of FIG. 10).

At 2018, the mapping system may analyze the results (e.g., by generating a confusion matrix, such as shown in FIG. 9) of the validation set. For example, the mapping system may compare the accuracy of the validation set to the accuracy of a test set or the training set, to determine, at 2018, whether it is desirable to further tune parameters the model (e.g., hyperparameters of the model).

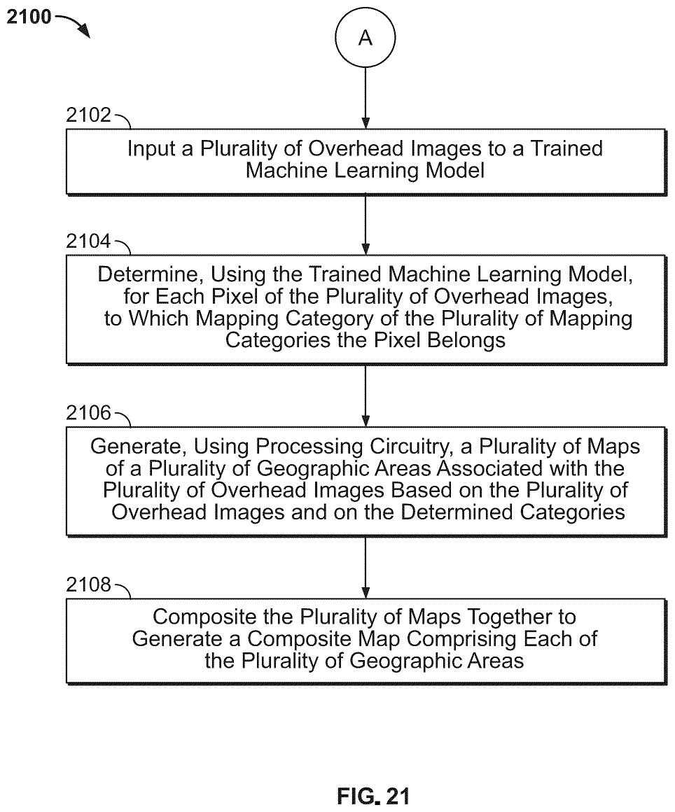

Processing may proceed to 2020 in response to a determination at 2018 by the mapping system that it may be desirable to adjust model parameters (e.g., weights and/or biases or hyperparameters of the model), and any suitable modifications may be performed to the model. In some embodiments, processing may proceed to A (FIG. 21) if the mapping system determines that the model is determined to performing well and no further tuning is needed.

FIG. 21 is a flowchart of a detailed illustrative process 2100 for generating a map of a geographic area, in accordance with some embodiments of this disclosure. In various embodiments, the individual steps of process 2100 may be implemented by one or more components of the devices, methods, and systems discussed in FIGS. 1-16. Although the present disclosure may describe certain steps of process 2100 (and of other processes described herein) as being implemented by certain components of the devices and systems of FIGS. 1-16, this is for purposes of illustration only, and it should be understood that other components of the devices and systems of FIGS. 1-17 may implement those steps instead. In addition, one or more steps of process 2100 may be incorporated into or combined with one or more steps of any other process or embodiment (e.g., FIG. 18 or FIG. 19 or FIG. 20 or FIG. 22, or any other embodiment disclosed herein, or any combination thereof).

At 2102, the mapping system may input a plurality of overhead images to a trained machine learning model (e.g., model 1005 of FIG. 10). 2102 may be performed in a similar manner as 1902 of FIG. 19.

At 2104, the mapping system may determine, using the trained machine learning model, for each pixel of the plurality of overhead images, to which mapping category of the plurality of mapping categories the pixel belongs. 2104 may be performed in a similar manner as 1904 of FIG. 19.

At 2106, the mapping system may generate a plurality of maps (e.g., multiple maps for a particular geographic area, such as the Mekong River Delta in Southern Vietnam, shown in FIG. 16) of a plurality of geographic areas (e.g., spanning the world) associated with the plurality of overhead images (e.g., input at 126 of FIG. 1) based on the plurality of overhead images and on the determined mapping categories.

At 2108, the mapping system may composite the plurality of maps together to generate a composite map (e.g., a global map) comprising each of the plurality of geographic areas. For example, one or more of a variety of techniques (e.g., a straight mode and/or a class weighted mode, as discussed above) may be utilized to composite together a plurality of maps output for each geographic region (e.g., to obtain a single map for each region reflecting the mapping categories that best classify each pixel representing portions of the region). The resulting maps for each region may then be composited or stitched together to form a global map (e.g., map 1700 of FIG. 17).

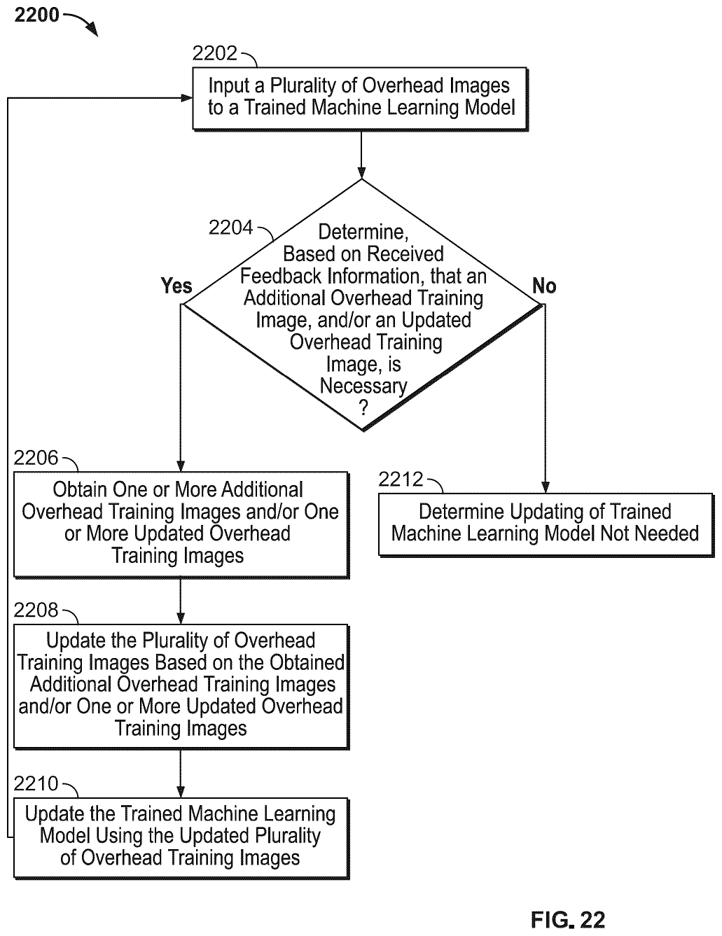

FIG. 22 is a flowchart of a detailed illustrative process 2200 for further training a machine learning model, in accordance with some embodiments of this disclosure. In various embodiments, the individual steps of process 2200 may be implemented by one or more components of the devices, methods, and systems discussed in FIGS. 1-16. Although the present disclosure may describe certain steps of process 2200 (and of other processes described herein) as being implemented by certain components of the devices and systems of FIGS. 1-16, this is for purposes of illustration only, and it should be understood that other components of the devices and systems of FIGS. 1-17 may implement those steps instead. In addition, one or more steps of process 2200 may be incorporated into or combined with one or more steps of any other process or embodiment (e.g., FIG. 18 or FIG. 19 or FIG. 20 or FIG. 21, or any other embodiment disclosed herein, or any combination thereof).

At 2202, the mapping system may input a plurality of overhead images to a trained machine learning model (e.g., model 1005 of FIG. 10). 2202 may be performed in a similar manner as 1902 of FIG. 19.

At 2204, the mapping system may determine, based on received feedback information, whether an additional overhead training image, and/or an updated overhead training image, is necessary. For example, each of outputs 1002, 1004, 1006 and 1008 of trained machine learning model 1005 may be respectively associated with a numerical confidence score or a flag indicating a level (e.g., high or low) of confidence for a probability of a mapping category predicted for a particular pixel and indicated by the output. If the confidence information indicates a confidence score that is above a threshold (e.g., predetermined or dynamically set) processing may proceed to 2212. At 2212, the mapping system may determine that the trained machine learning model 1005 need not be updated at this time, based on the confidence score exceeding the threshold. If the confidence information indicates a confidence score that is below the threshold, the mapping system may determine that an additional overhead training image, and/or an updated overhead training image, is necessary, and processing may proceed to 2206.

At 2206, the mapping system may, based on the received feedback information 1010, obtain additional training data (e.g., via aircraft 102) and/or consider editing existing data, e.g., the mapping system may prompt an operator to confirm or update or add mapping category designations to one or more pixels of training overhead images 302 or other data previously input to machine learning model 1005. In some embodiments, the mapping system determine the type of training overhead image image(s) to obtain or update based on the images having been determined to have a low enough confidence. For example, the additional training overhead images or updated training overhead images may correspond to a particular geographical area that machine learning model 1005 may be struggling to categorize pixels of overhead image data of, e.g., based on low confidence scores being output for such overhead image data. In some embodiments, particular equipment, e.g., aircraft 102, may be configured to both implement at least a portion of trained machine learning model 1005 and capture one or more additional overhead training images.

At 2208, the mapping system may be configured to update the plurality of overhead training images 302 based on the obtained additional overhead training images and/or one or more updated overhead training images, obtained at 2206. For example, one or more additional overhead training images may be added to database 303 or database 1001, and/or one or more of the overhead training images stored at database 303 or database 1001 may be updated based on processing performed at 2206. In some embodiments, particular equipment, e.g., aircraft 102, may be configured to perform the processing of 2208.

At 2210, the mapping system may be configured to update trained machine learning model 1005. using the updated plurality of overhead training images. For example, the mapping system may be configured to further train machine learning model 1005 based on the updated plurality of overhead training images comprising the one or more additional overhead training images and/or the updated overhead training images, e.g., the updated plurality of overhead training images, or any suitable portions thereof, may be input to the machine learning model. In some embodiments, particular equipment, e.g., aircraft 102, may be configured to perform the processing of 2210, as part of a closed system, or a cloud-based system, such as comprising the components of system 200 of FIG. 2, may be employed.

The maps generated based on the above-described systems and methods result in many practical benefits. For example, the generated maps over a predefined period (e.g., one year) enables observations of seasonality (e.g., to analyze drought, low water levels, permanent ice and snow, any presence of ice and snow, change in ice and snow over time, rate of ice or snow fall, etc.). For example, a user interface may be provided to an observer, e.g., comprising a temporal axis, which enables the observer to select certain periods of time to analyze or a summary of the entire period of time. As another example, trends regarding specific land uses in different regions may be observed (e.g., deforestation in a particular region, habitat encroachment in a region, road development through time, expansion of agriculture which may be a driver of climate change, analysis of human impact on environment, determining forests cut down in favor of pasture and farming, grasslands being stripped and turned into bare ground such as due to over grazing or dug up to be turned into a mine, estimating health of national parks and state parks, analyzing areas with the least human activity, etc.). In addition, certain organizations (e.g., government entities or private companies) to monitor certain characteristics (e.g., ensuring the presence of required water in a region, maintaining healthy waterways, biodiversity, disaster management, water resource management, carbon accounting, and conservation planning).

In some embodiments, the map may be updated annually to support change detection and highlight planetary land changes, e.g., related to the effects of human activity. A consistent map of land cover for the entire world based on the most current satellite information, may be combined with other data layers for green infrastructure, sustainability projects, and other conservation efforts that benefit from a holistic picture of both the human and natural footprint on the planet. In some embodiments, the land cover model may be available to support on-demand land cover classification, to create maps for project areas frequently (e.g., every week), supporting land managers who monitor change in a specific area of interest, looking at annual change and seasonal differences in land cover. In some embodiments, users may be able to manipulate the map in association with other geographic information system (GIS) layers such as terrain, hydrology, or any other suitable layer, or any combination thereof. Through the visualizations, planners worldwide may better understand the geography around them to make more informed decisions, enabling them to gain insight into locations with distinctive land cover, as well as human activity affecting them. High-resolution, open, accurate, comparable, and timely land cover maps may be critical for decision-makers in many industry sectors and developing nations. These maps improve understanding of important topics such as food security, land use planning, hydrology modeling, supply chains, urban development, and resource management planning. In addition, national government resource agencies use land cover as a basis for understanding trends in natural capital, which helps define land planning priorities and is the basis of budget allocations. Such aspects provide leaders in governments, NGOs, and across industries with a novel, timely view of the planet, and a new AI-powered capability for actionable, science-based insights on demand into the world's landscapes, which may contribute towards the global conservation effort, resource management, and climate change mitigation efforts.

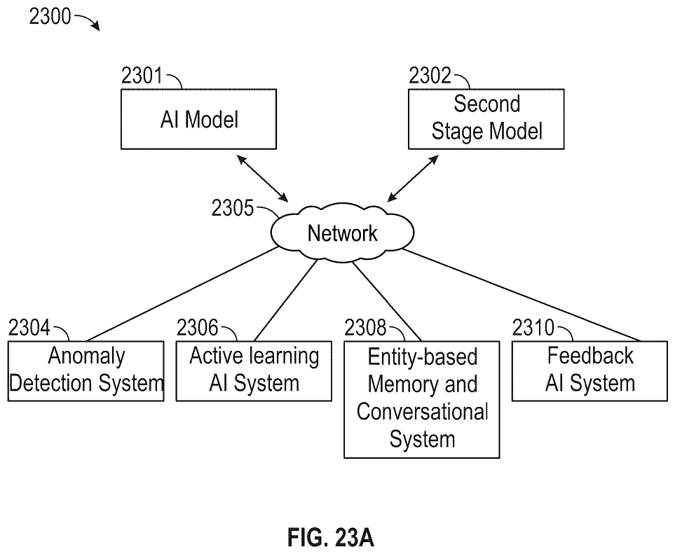

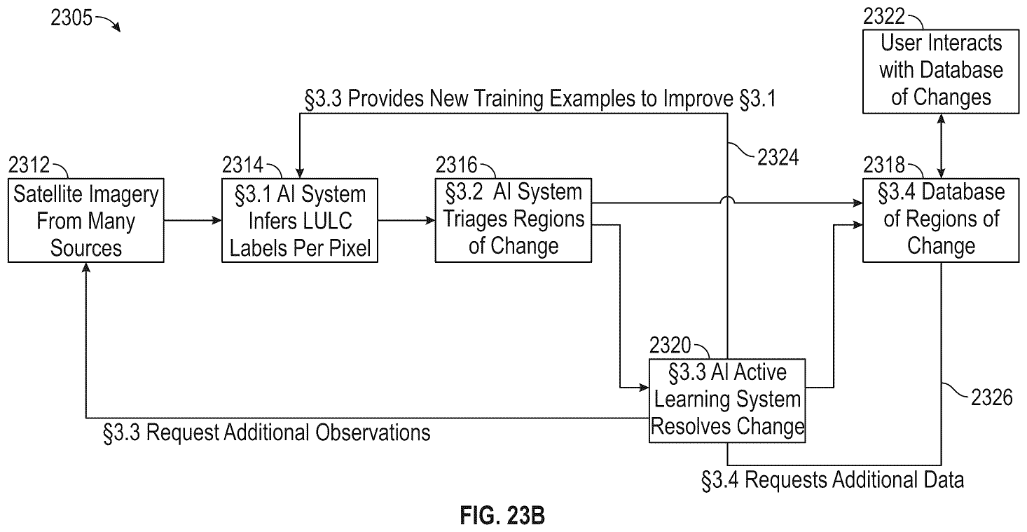

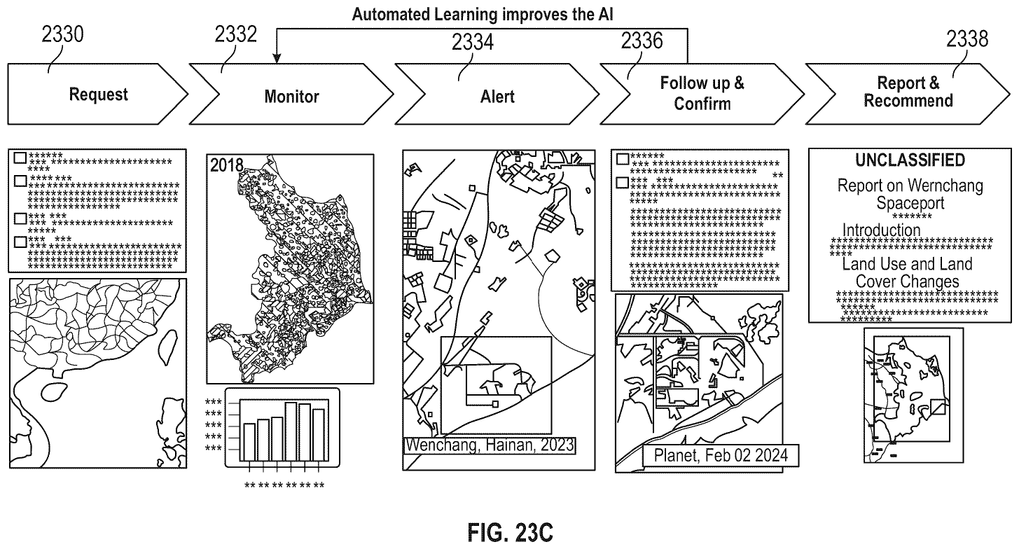

FIG. 23A shows an illustrative system 2300 for identifying an expected distribution of mapping categories for a geographic area over a period of time, in accordance with some embodiments of the present disclosure. System 2300 comprises AI model 2301, second stage model 2302, anomaly detection system 2304, active learning AI system 2306, entity-based memory and conversational system 2308, and feedback AI system 2310. System 2300 may correspond to or be included in the mapping system, and/or may be executed at a same computing device or at a group of computing devices (e.g., one or more servers 202 of FIG. 2), one or more databases (e.g., database 208 of FIG. 2) and/or may be in communication via any suitable network (e.g., network 2305). Network 2305 may comprise any suitable network (e.g., satellite network, cellular network, and/or the Internet, including a WAN and/or a LAN, or any combination thereof).

In some embodiments, one or more second stage artificial intelligence (AI) models 2302 are provided and are trained on expected variation of the natural background and normal human activity. In some embodiments, AI model 2302 may comprise a set of AI models trained to identify LULC categories based on a time series of complementary geospatial observations from multiple Earth observation satellite constellations and multiple sensors modalities.

In some embodiments, second stage model 2302 (and/or AI model 2301 and/or other components of system 2300) may be trained to identify expected seasonal variation of the natural background and expected patterns of normal human activity capturing variability at multiple temporal and spatial scales based on a time series of complementary geospatial observations from multiple Earth observation satellite constellations and multiple sensors modalities. In some embodiments, second stage model 2302 may be utilized in conjunction with AI model 2301. In some embodiments, one or more machine learning models 2301 and/or model 2302 may be used to identify LULC categories based on a time series of complementary geospatial observations from multiple Earth observation satellite constellations and multiple sensors modalities. In some embodiments, AI model 2301 may correspond to (or otherwise be implemented in a similar manner as) machine learning model 124 of FIG. 1.

In some embodiments, anomaly detection system 2304 may be configured to filter observed changes by their anomalousness. Such anomaly detection system 2304 may be an automated system to detect, segment, rank, and filter observed changes by their likelihood and their anomalousness versus expected seasonal variation of the natural background and expected patterns of normal human activity capturing variability at multiple temporal and spatial scales. In some embodiments, active learning AI system 2306 may recommend and cue follow-up observations to resolve and identify interesting changes.

In some embodiments, entity-based memory and conversational system 2308 may be configured to interrogate changes and task new observations via natural language queries. Entity-based memory and conversational system 2308 may be configured to monitor, retrieve, and interrogate geospatial changes across time, and/or explore and approve follow-up observations, using image-derived regional metrics and via natural language queries. In some embodiments, entity-based memory and conversational system 2308 may recommend and approve follow-up observations, using image-derived and signal-derived metrics and natural language queries. In some embodiments, such metrics and/or natural language queries may be derived from images or other data obtained by satellites and/or sensors, from data contained in public training datasets, from data contained in user-provided information, and/or any other suitable information from any other suitable source.

In some embodiments, feedback AI system 2310 uses feedback from the active learning observations of active learning AI system 2306 to build and improve AI model 2301, second AI model 2302 and/or anomaly detection system 2304 automatically and continuously. In some embodiments, feedback AI system 2310 corresponds to or is included as part of active learning AI system 2306.

FIG. 23B shows flowchart of an illustrative process 2305 which may be performed by system 2300, in accordance with some embodiments of this disclosure. At 2314, the mapping system may be configured to train (and/or use an already trained) AI model 2301, such as a machine learning model, a random forest model, or a deep learning model (or any other suitable model, or any combination thereof) to categorize satellite images (and/or other overhead imagery of earth or portions thereof) 2312 at the pixel level, taking a satellite image or sequence of satellite images and producing a map of land use land cover (LULC), as described in more detail in U.S. Patent Application Publication No. 2022/0415022 A1 filed in the name of Impact Observatory, Inc., and International Publication No. WO 2022/271942 A1 filed in the name of Impact Observatory, Inc., each of which is hereby incorporated by reference herein in its entirety.

In some embodiments of the present disclosure, AI model 2301 may correspond to a UNet deep learning model, as described in more detail in Karra et al., “Global land use/land cover with Sentinel-2 and deep learning, 2021 IEEE International Geoscience and Remote Sensing Symposium IGARSS, Jul. 11-16, 2021. DOI: 10.1109/IGARSS47720.2021.9553499, the contents of which are hereby incorporated by reference herein in their entirety.

In some embodiments of the present disclosure, implementation of the UNet deep learning model may be modified to use multi-spectral satellite imagery, such as, for example, by modifying the UNet and training it on 6-band Sentinel-2 satellite imagery using the visible blue, green, red, near infrared, and both short wave infrared bands (Sentinel-2 refers to these bands as Bands 2, 3, 4, 8, 11, 12). In some embodiments of the present disclosure, the spectral bands are resampled to a common 10 m spatial grid using bilinear interpolation. In some embodiments, nearest-neighbor sampling may help best preserve spectral information in the original image.

In some embodiments of the present disclosure, the Level-2A surface reflectance version of the spectral bands can be utilized, as released by the National Aeronautics and Space Administration (NASA) and the European Space Agency (ESA), e.g., Copernicus.

In some embodiments of the present disclosure, AI model 2301 is trained using a large proprietary dataset produced by Impact Observatory, Inc., comprising tens of thousands of satellite image and label image pairs (e.g., each image pair representing an area of 1 to 10 km by 1 to 10 km), using a dense markup scheme described in Karra et al. referenced above. As further described in Karra et al., the mapping system can run at scale in commercial cloud, and can also run at the edge on sufficiently fast hardware-accelerated compute systems.

In some embodiments of the present disclosure, AI model 2301 is probabilistic, meaning that each pixel output estimates the distribution of likelihood associated with each possible output label, e.g., at pixel 300 across and 474 down, the output label is 10% likely to be grass, 20% likely to be bareground, 50% likely to be artificial construction/build area, 0% likely to be water/wetland, 5% likely to be trees, and 15% likely to be cloud. In some embodiments of the present disclosure, the output may be simplified by only storing the most likely label and its confidence, or by only storing some subset of the most likely labels and their corresponding likelihoods. In some embodiments, the map is a raster dataset that may be stored in any suitable format or any suitable geospatial format. In some embodiments, the mapping system may train different respective AI models 2301 for each type of satellite image source. For example, each satellite source may be used to train a UNet image segmentation deep learning model as described in the aforementioned U.S. Patent Application Publication No. 2022/0415022 A1 and International Publication No. WO 2022/271942 A1.

In some embodiments, the mapping system may generate or obtain pre-processed satellite images 2303, to provide at-surface-reflectance (e.g., used for public and commercial space imagery). In some embodiments, for all sources of satellite imagery, satellite image calibration may be assessed using a standard linear calibration model trained from sample images from a specific source of imagery versus corresponding images from Sentinel-2 of the same spatial region at as close to the same time as possible, or if cloudy, at the same time of year.

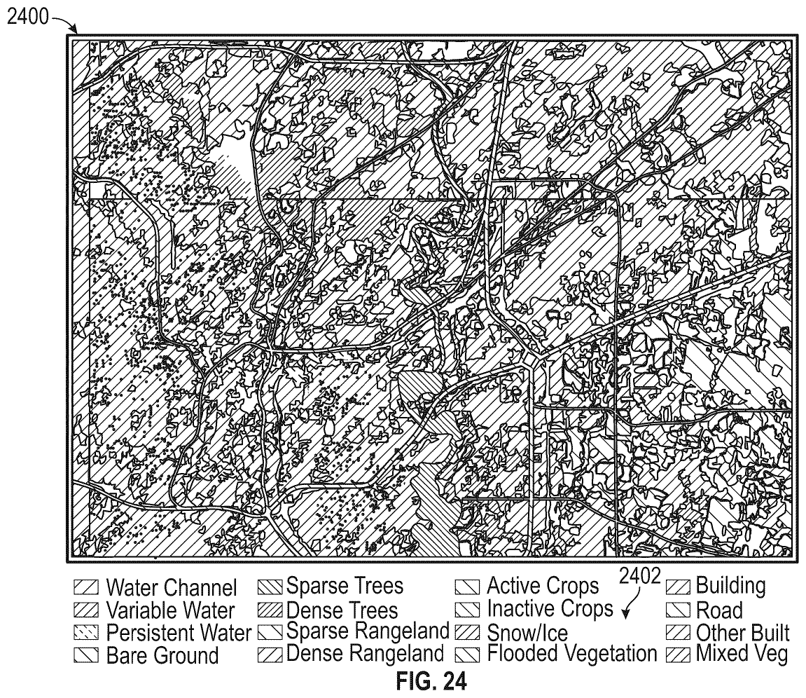

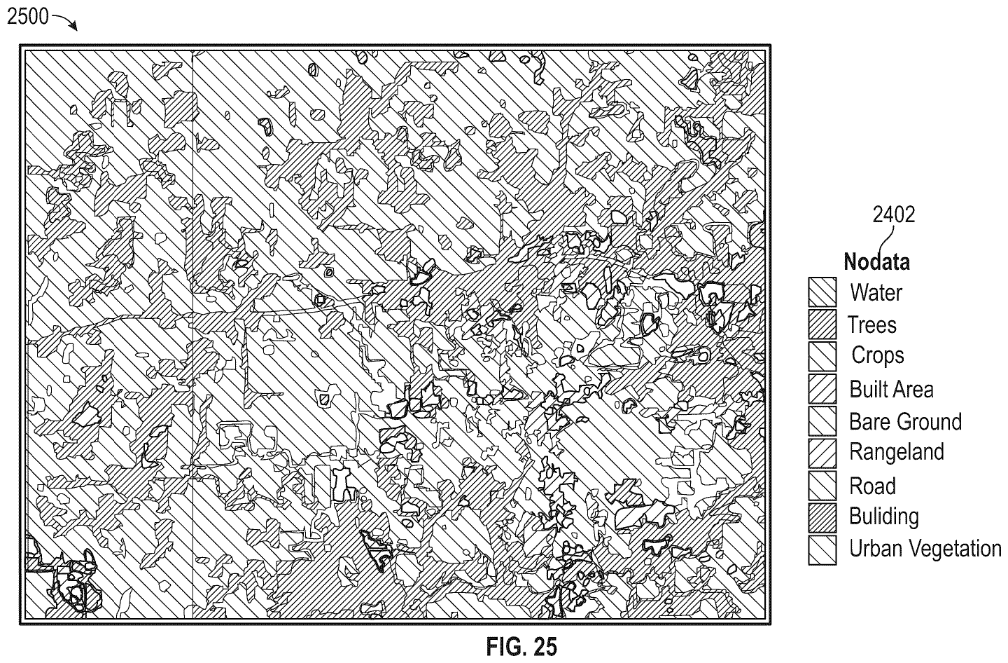

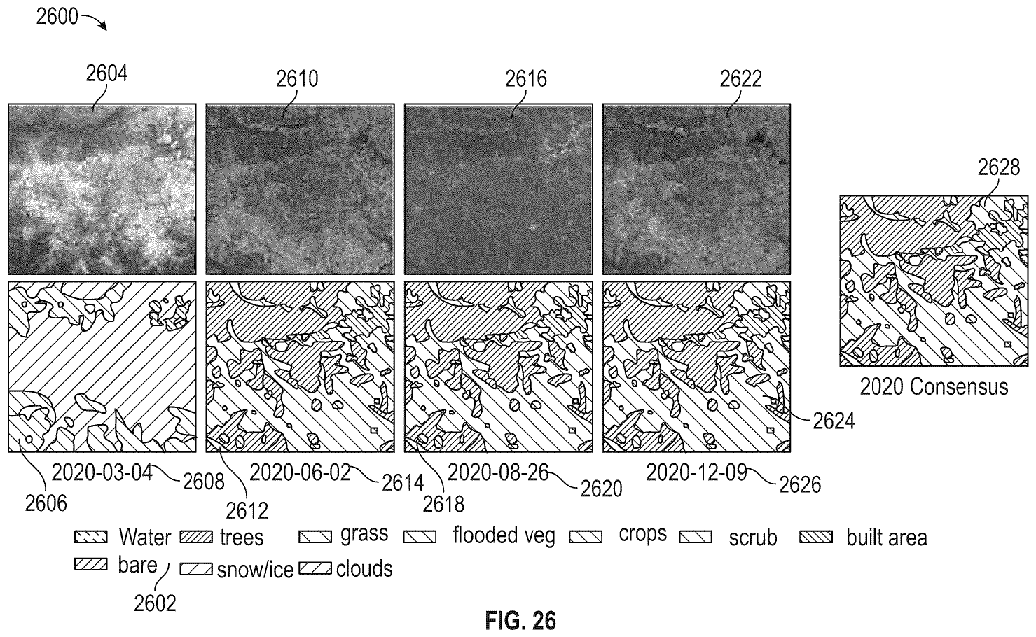

In some embodiments, each UNet model may be trained using any suitable number of (e.g., thousands or any other suitable number of) of satellite image and label image pairs, using a dense markup scheme described in Karra et al., referenced above, where the labeling is matched to the spatial resolution as the satellite imagery, e.g., using commercial satellite imagery at 1 m or 3 m resolution requires labels at the same scale. As shown in FIG. 26, each AI model 2301 may produce labels using a common taxonomy. In some embodiments, not all categories may be detectable from a single source, e.g., detecting one type of tree may require an SAR image, or labels detected using SAR may be the only labels available for parts of the year due to clouds and haze. In some embodiments, results from each AI model 2301 applied can be combined using hierarchical masking to produce a composite map (e.g., composite LULC map 2400 of FIG. 24 or composite LULC map 2400 of FIG. 25) for a specific time. For example, the mapping system may use output of the original Sentinel-2 model to learn the generic category of “trees”, and then use output from other sensors (e.g., such as, for example, Landsat and Sentinel-1 C-band SAR or JAXA ALOS-2 L-band SAR) to categorize types of trees. For example, a random forest spectral may be used for classifier for the Landsat imagery, and a linear discriminant classifier may be used on a NDVI-like transformation of the Sentinel-1 C-band SAR. In some embodiments, composite LULC map 2400 may be produced by combining output from an AI model using Sentinel-2 imagery and/or an AI model using Planet imagery, and/or using any other suitable imagery.

As shown at taxonomy/color legend 2402, composite map 2400 depicts mapping categories of one or more of water channel, variable water, persistent water, bare ground, sparse trees, dense trees, sparse rangeland, dense rangeland, active crops, inactive crops, snow/ice, flooded vegetation, building, road, other built and mixed vegetable. As shown at 2502, composite map 2500 depicts mapping categories of one or more of no data, water, trees, crops, built area, bare ground, rangeland, road, building, and urban vegetation.

In some embodiments, the mapping system may train a second stage AI model 2302 from a time sequence of LULC maps to enable model 2302 to learn the temporal distribution of labels and confidences observed for a given geospatial location. FIG. 26 shows an illustrative time sequence 2600 of maps generated by the mapping system for a particular area, using the techniques described herein. For example, time sequence 2600 comprises maps 2604 and 2606 associated with a particular location(s) at a particular date 2608 (e.g., Mar. 4, 2020); maps 2610 and 2612 associated with the particular location(s) at a particular date 2614 (e.g., Jun. 2, 2020); maps 2616 and 2618 associated with the particular location(s) at a particular date 2620 (e.g., Aug. 26, 2020) maps 2622 and 2624 associated with the particular location(s) at a particular date 2620 (e.g., Dec. 9, 2020). Such maps of time sequence 2600 may be used in combination to obtain a consensus LULC map 2628 for a particular time period (e.g., a year, in this case, 2020). Such maps of time sequence 2600 may, as indicated at 2602, comprise indications of mapping categories water, trees, grass, flooded vegetation, crops, scrub, built area, bare, snow/ice, and clouds.

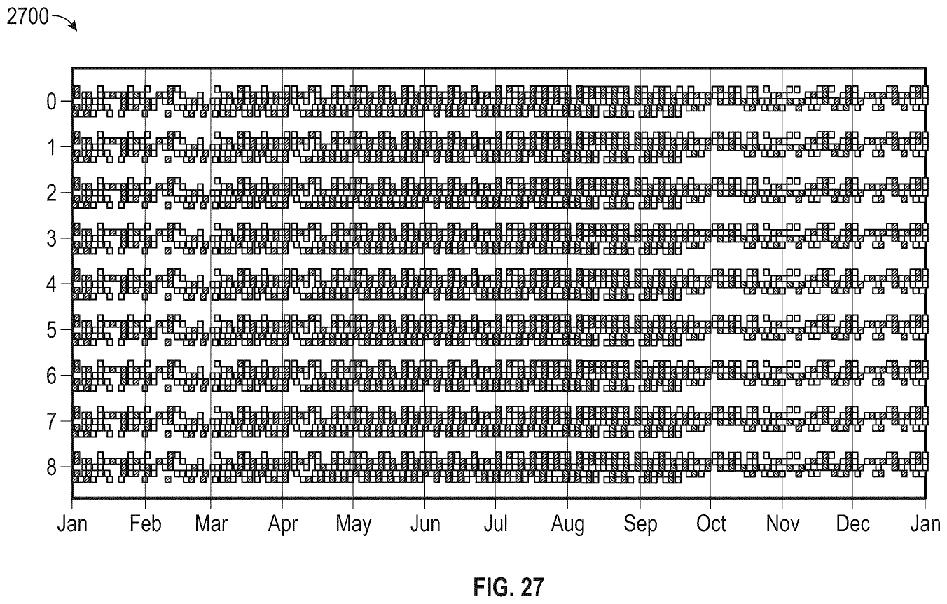

At 2316, second stage model 2302 and/or anomaly detection system 2304 may triage regions of change, based on the data output at 2314. Second stage AI model 2302 may be trained by the mapping system to learn temporal distribution of labels and confidences for any suitable number of geographic locations of any suitable size. In some embodiments, the second stage model 2302 may be a statistical machine learning model, a Bayesian probabilistic model, a random forest model, a deep learning model, a transformer model using attention heads, an ensemble of such models, or any other suitable model, or any combination thereof. In some embodiments, second stage model 2302 may be a Bayesian probabilistic model where the expected distribution is learned from the observed sequence of labels from previous observations, as shown in FIG. 27. FIG. 27 shows an illustrative time sequence 2700 (e.g., an Impact Observatory LabelScope time sequence) of inferred labels at a location where each row corresponds to an individual pixel across time. In some embodiments, individual pixel labels at a specific time may be based on observations by different sensors (e.g., visible/infrared, or SAR). In some embodiments, the Bayesian model may divide the year into time blocks (e.g., months or any other suitable time block), which may enable the mapping system to smooth out variability due to cloud obscuration and enable summarization of important periods of natural variability such as, for example, leaf-on/leaf-off for forests, or planting/growth/harvest/fallow for agricultural land. In some embodiments, the mapping system may utilize a standard Naïve Bayes Classifier implementation.

In some embodiments, second stage model 2302 may be configured to forecast or predict what future LULC categories will be present in particular location at a particular future time. While second stage model 2302 is described herein as a machine learning model, the present disclosure contemplates that other techniques could be used (in addition or in the alternative to) machine learning to perform the functionalities of model 2302, e.g., any suitable data analysis tool to analyze trends, such as, for example, a heuristic-based data analysis tool.

In some embodiments, the mapping system may explicitly take into account the time dynamics of observations. This may enable the mapping system to resolve LULC for categories that are inherently dependent on time, such as, for example, of annual plant crops that may appear as bare soil for parts of each year, or deciduous trees that lose their foliage for part of the year, and not just the mode of inferred labels for a location.

In some embodiments, one set of hyperparameters for model 2302 is the division of space and time into spatial and temporal segments that summarize the scene. In some embodiments, the spatial segments enable the mapping system to translate from pixels to spatially contiguous objects, e.g., agricultural fields, timber stands, and city blocks. In some embodiments, the temporal segments enable the mapping system to efficiently characterize patterns of life, e.g., planting, growing, and harvesting seasons for agriculture, leaf on/leaf off seasons for forests, work day, weekend, and “market day” activity for towns. In some embodiments, spatial and temporal summarization enables a significant reduction in the amount of data required to model a landscape, while preserving sufficient information to enable detection of interesting anomalies, such as abandoned towns, neglected fields, flooded fields, burned forests, and/or any other suitable anomaly.

In some embodiments, the sequence of labels distributions enables the mapping system to learn the seasonal distribution of likelihoods for different LULC categories for anywhere in the world, e.g., dry broadleaf forests are more likely to appear as “scrub” during the driest months of each year.

In some embodiments, the mapping system's models can use auxiliary geospatial data including but not limited to weather data (e.g., precipitation, daytime and nighttime temperature, water vapor pressure), topographic information (e.g., altitude, slope, aspect), or active emissions (e.g., nighttime light emissions, communications radiofrequency emissions, cell phone activity, global positioning location information for mobile devices on the ground, and/or vehicle emissions including AIS broadcasts from ships and aircraft). For example, such auxiliary variables may be additional parameters in the Bayesian probabilistic model.

In some embodiments, the mapping system's models can estimate trends across time to enable estimation of expected rates of change within an area of interest, e.g., harvesting of timber within a plantation, or rate of expansion of a displaced persons camp, or multi-year drift of the start of the growing season or the length of the growing season in response to natural climate variability and long term climate change.

In some embodiments, the mapping system may utilize the probabilistic information output from AI model 2301 to build models across time. As a non-limiting example, such information may be used to train second stage model 2302 to learn that trees are changing because the current time corresponds to Autumn, e.g., learning from months or years of observations to learn the dynamic distribution of mapping category labels across various time periods and/or geographic areas.

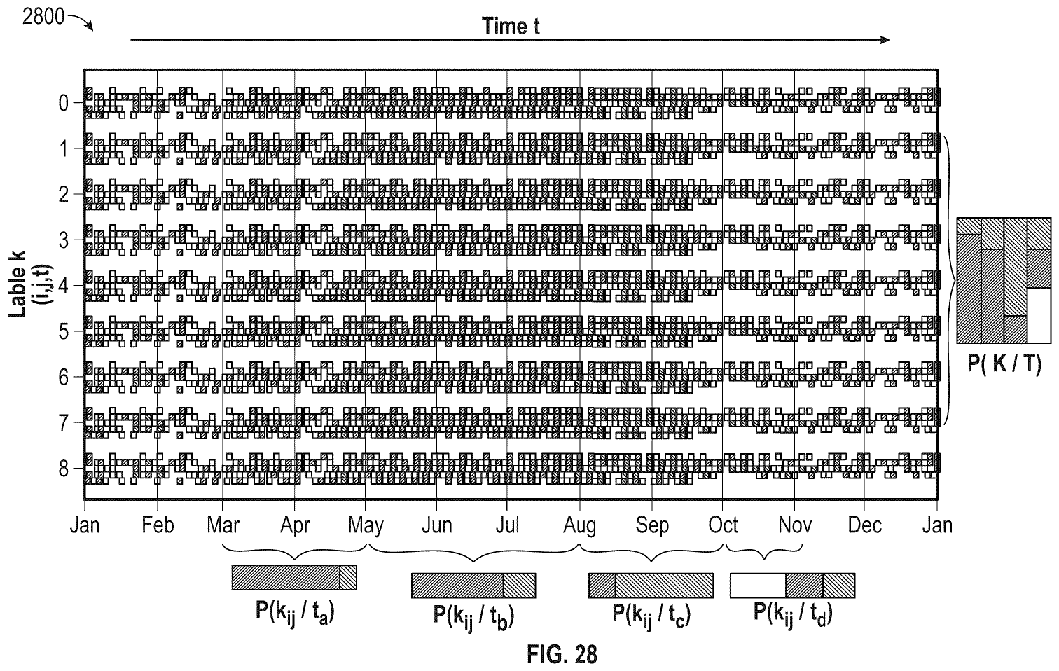

In some embodiments, at 2316 of FIG. 23, anomaly detection system 2304 may detect, segment, rank, filter, and triage observed changes by their anomalousness. Anomaly detection system 2304 of the mapping system may use as a starting point a series of maps with point estimates for the distribution of labels for regions of change—P(k|t), as shown in FIG. 28. FIG. 28 shows time sequence 2800 (e.g., an Impact Observatory LabelScope time sequence) of inferred labels at a location (e.g., a particular geographic area or location) where each row corresponds to an individual pixel across time, and the model learns distributions over these pixel labels. The distributions are grouped in in time intervals and then concatenated across a spatial segment to produce a distribution vector P(k|t) that summarizes the natural variability of the segment across time and enables monitoring of long-term trends and short term anomalous change.

The mapping system may learn, for each location from among any suitable number of locations, the expected distribution of labels across an average year, and the trend of the distribution across years, e.g., trend for forestry regions with expected rate of tree harvest and tree planting per year. Anomaly detection system 2304 may, for a new observation at a given date, estimate the expected distribution of labels per location, and may detect locations where the distribution of labels differs from an expected value (which may be referred to as candidate areas of change).

In some embodiments, anomaly detection system 2304 may apply spatial clustering to segment or group sets of spatially adjacent pixels likely to be of a similar type of change (e.g., nearby pixels transitioning from trees to bare ground) into an entity described by a vector shape, e.g., a centroid, radius, bounding box, or bounding polygon. In some embodiments, such segmenting of sets of similar pixels delivers an important efficiency gain, resulting in significant (e.g., at least 10×) reductions in storage and compute compared to having to track every pixel. Also, tracking at the geospatial object level is efficient for comparing detections and tracking changes across sensors with different spatial scales, e.g., comparing detections with 10 m/pixel Sentinel-2 imagery and 3 m/pixel PlanetScope imagery.

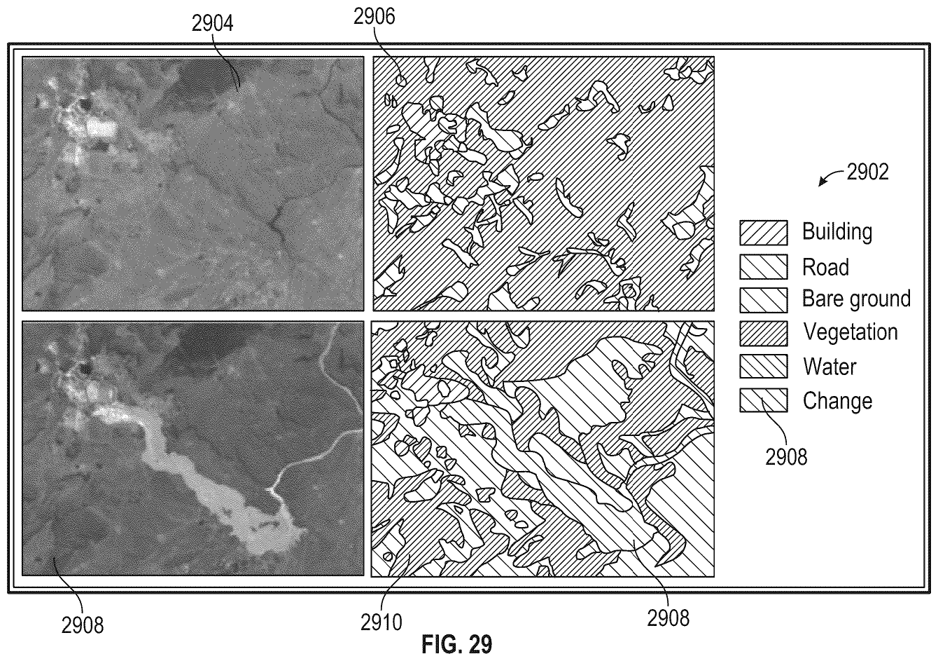

The mapping system may apply additional analysis of the underlying imagery to characterize changes, e.g., apply additional tests for cloud/haze or shadows, test for other sensor artifacts, and/or any other suitable tests. Anomaly detection system 2304 may filter these candidate changes based on the degree to which they differ from expectations and may triage candidate changes into a set of categories based on their observed features, e.g., “unlikely—missing data”, “unlikely—observational artifact”, “unlikely—natural variability”, “unlikely—normal human activity”, “likely—unusual natural change”, or “likely—unusual man made change”, or “likely—unknown change,” or any other suitable categories, or any combination thereof. In some embodiments, the triage adds a quantitative importance metric to each candidate change, allowing the mapping system and/or user thereof to prioritize inspection of candidate changes. Based on such filtering, a determination can be made (automatically by the mapping system or by an observing user, who may provide input regarding the determination to the mapping system) as to whether a change is likely to be an anomaly. FIG. 29 shows an example 2900 of a high-likelihood change, e.g., a high-likelihood that the candidate change for the given area corresponds to an anomaly. Maps 2904 and 2906 represent mapping categories at a first time, and maps 2908 and 2910 represent mapping categories for the location at a second time later than the first time. comprise indication of mapping categories for their pixels, e.g., building, road, bare ground, vegetation, water. As shown in FIG. 29, anomaly detection system 2304 may identify and cause display of a change 2908 in map 2910 based on such change 2908 being determined to be a high likelihood of an anomalous change. In some embodiments, a machine learning model may be trained to perform the anomaly detection, to identify changes that are most likely to be anomalous.

In some embodiments, anomaly detection system 2304 may employ one or more of the techniques for anomalous change detection discussed in Theiler et al., International application publication no. WO 2008/156634 A1, the contents of which are hereby incorporated by reference herein in their entirety. In some embodiments, such techniques of Theiler may be modified to be used with deep learning features in addition to the contemplated pixel values. The mapping system may return a list of ranked candidate changes to the user, including the location, size, estimated characteristics of the candidate change, and preview images and graphs. In some embodiments, the list of ranked candidate changes is a text and hypertext dataset that may be stored in any suitable standard geospatial format or any other suitable format.

In some embodiments, overhead images are analyzed and coregistered to each other, an analyst tasked with monitoring change can use a number of statistical learning methods to identify and model candidate areas of change, including thresholds on simple pixel differences, Kalman filtering of noisy estimated labels across space and time, and methods based on the theoretical information content of the image pair, including Bayesian surprise and other biologically- and cognitively-inspired models designed to mimic human attention in visual cortex, and mathematical models of anomalousness derived from the statistical distributions of the features across the sequence of images.

In some embodiments, the mapping system may employ techniques including spectral indices, spectral matched filters, unsupervised clustering, and spatial pattern analysis including spatial templates for known objects (e.g., planes, ships, and tanks), and multi-scale wavelet dictionaries for performing earth observations. These analysis methods may convert images composed of pixels into datasets of derived features that can be used as input to statistical machine learning systems including linear discriminators, Bayesian models, support vector machines, random forest models, and artificial neural networks. Meta-learning approaches may be used to explore the architectures of these statistical machine learning systems, including evolutionary algorithms and ensemble methods. The result may be a geospatial raster dataset where the pixels contains object labels and object characteristics, e.g., pixel 500 across and 725 down is a vehicle, and further the vehicle is estimated to be a transport plane, or pixel 850 across and 500 down is an agricultural field, and further the field is growing corn, the corn is currently healthy, the crop is 2 months from harvest, and the yield is forecast to be X metric tons per hectare.

In some embodiments, the mapping system may use an unstructured database (e.g., the database at 2318 of FIG. 23B and/or database 208 of FIG. 2) to store this text and hypertext dataset. One implementation may use a cloud-native, unstructured database approach (e.g., using MongoDB or a custom implementation thereof or any other suitable technique). Another implementation may use a Pinecone vector database (or a custom implementation thereof or any other suitable technique) to facilitate interactions with the change interrogation and tasking system (e.g., 2306 and/or 2308) using high-level natural language. In some embodiments, such use of an unstructured database enables extensibility of the system and is well matched to the heterogeneous nature of the LULC categories that might otherwise require use of very extensive schemas in a relational database which would then only be very sparsely populated.

At 2320, the mapping system may employ active learning AI system 2306 to recommend and cue follow-up observations to resolve changes. Given the list of ranked candidate changes produced by anomaly detection system 2304 at 2320, the mapping system may enable users to use their preferred geospatial information system to review the candidate changes in the suggested rank order, and/or may enable a user to sort the candidate changes in however manner a particular user prefers. For example, a user may inspect the ranked candidate changes in Esri ArcGIS Pro or QGIS desktop applications, or in Esri ArcGIS Online or MapBox web applications, or via code in a Jupyter or Google Colab notebook, or via any suitable custom implementation thereof, and/or using any other suitable technique. In some embodiments, the mapping system may enable users to provide feedback to the mapping system by rejecting some candidate changes as incorrect. Such human feedback, which may include human-provided notes on why a candidate change is rejected, may be stored for later use. In some embodiments, the mapping system may enable users to provide feedback to the mapping system rejecting some candidate changes as unclear and requiring more observation by the system (e.g., using AI model 2301 and/or second stage model 2302). Such human feedback may be stored for later use. In some embodiments, the mapping system may enable users to provide feedback to the mapping system of accepting a candidate change as real and an instruction to proceed to further analysis. Such human feedback may be stored for later use.

For candidate changes that the user believes may be real, the mapping system may employ active learning AI model 2306 to recommend (e.g., for user confirmation), or automatically proceed to task, a follow-up observation, e.g., to resolve one or more anomalies. Based on the type of detected change, e.g., forest to bare, or cropland to new building construction, the mapping system may use active learning AI system 2306 to recommend performance of (or perform automated tasking to perform) a follow-up observation from the same sensors and constellations used as input to AI model 2301 and/or second stage model 2302, or use additional sensors and constellations that may provide additional information about the observation in order to further rank the type of the detected change. For candidate changes that the user believes may be real, the mapping system may enable a user to reject the system's recommended follow-up observation and instead request an alternative follow-up observation. Such human feedback may be stored for later use.

In some embodiments, the recommendation system (e.g., implemented by active learning AI system 2306) may use a mutable rule table combined with a database of available sensor platforms, time to the next observation for that sensor platform, estimate of the expected monetary cost and expected time to fulfillment of that observation, and expected weather conditions over the location of the candidate change (e.g., cloudy conditions at the location of the candidate change will require waiting longer or choosing a SAR observation), to recommend a follow-up observation, e.g., whether the follow-up observation should be performed.

In some embodiments, the mapping system may fine-tune an instruction large language model (LLM) that matches observed patterns of change (e.g., forest to crops, or built area to water) to follow-up observational strategies and the specific needs of the user, such as, for example, a time window in which a decision must be made. In some embodiments, the mapping system may employ follow-up observational strategies that take into account estimated cost and complexity of follow-up observations, e.g., an observed change may suggest a higher resolution follow-up which is available from several possible commercial space vendors with a range of data costs and time to delivery factors. In some embodiments, the mapping system may enable users to pre-specify existing image archives, preferred satellite vendors, cost constraints for new observations, and/or any other suitable data.

For example, for a candidate change of any natural land cover category (e.g., trees, scrubland, rangeland, wetland, snow/ice) to a man-made structure presenting as a detection of built-up area, the mapping system may recommend a follow-up observation by either a high resolution (e.g., <1 m/pixel) visible/infrared observation optical system or a SAR observation or a hyperspectral observation. For a candidate change of any natural land cover category to agriculture or plantation forest, the mapping system may recommend a follow-up observation by either a time series of higher spatial resolution red-edge and infrared optical images or a hyperspectral image observations over a period of time.

In some embodiments, for cases where the mapping system receives an indication that a user accepts the mapping system's recommendation, the mapping system may automatically proceed to task the suggested follow-up observation, e.g., using vendor APIs to task the observations and track delivery of the follow up observational data.

In some embodiments, the follow-up observations may extend beyond satellite images, to include datasets such as aerial imaging, drone/unmanned aircraft systems (UAS) imaging, non-imaging signal collection, in-situ sensor collection from internet-of-things sensors, or tasking apps that rely on humans, or any other suitable images, or any combination thereof. Such follow-up observations may become input to AI model 2301 and/or second stage model 2302, enabling an updated estimate of whether a candidate change has occurred. That is, the follow-up optical, infrared, hyperspectral, SAR, radiofrequency signal, or other observation may be automatically analyzed by a machine learning model trained for that specific type of imagery.

In some embodiments, AI system 2306 may correspond to a UNet deep learning algorithm trained to analyze <3 m/pixel optical/infrared time series imagery, or a UNet deep learning algorithm trained to analyze <3 m/pixel SAR imagery, or a random forest spectral time series classifier to analyze time series 10 m/pixel SAR imagery or >10 m/pixel multispectral optical (visible/infrared) imagery, or a matched filter classifier to analyze hyperspectral visible/infrared imagery, or any other suitable model trained to analyze any other suitable m/pixel values, or any combination thereof.

In some embodiments, active learning AI system 2306 may recommend (e.g., where several commercial sensors and/or other types of sensors are available) a follow-up observation informed by the monetary cost of the observation and expected time to fulfillment accounting for expected weather based on accessing public global weather data from National Oceanic and Atmospheric Administration (NOAA) and/or another suitable source. The mapping system may receive feedback from the analysis of the follow-up observations. For example, Satellogic, Planet, BlackSky, Maxar, and Airbus produce similar optical visible/infrared observations with spatial resolution around 1 m/pixel, and Umbra, Capella, and ICEye produce SAR radar imagery.

In some embodiments, active learning AI system 2306 may optimize the active learning recommendations over time based on user adjudications and outcomes of follow-up observations. In some embodiments, the mapping system may use the outcomes of follow-up observations and tracking of observational costs and times to fulfillment to weight the recommendations towards observations with the greatest likelihood of success, including weighting choices between satellite providers.

In some embodiments, in addition to (or prior to) providing for the recommended and/or automated tasking of follow observations, the mapping system may take into account the financial cost (and/or cost in terms of computing resources) of that follow-up observation and the possible reward or potential gain associated with information to be gleaned from such follow-up observation. Such cost-benefit analysis may enable expending additional resources for capturing additional imagery only when such follow-up task is likely to yield sufficiently useful information.

In some embodiments, the mapping system may detect whether (and/or a degree to which) a candidate change (e.g., a current day's image) is anomalous for a particular geographic area based on historical observations for the particular geographic area and future projections for the particular geographic area (e.g., based on a trend of recent observations for such geographic area). For example, the mapping system may project what the land cover for the particular geographic area is expected to look like in the future and use that to inform whether and/or how to perform a follow-up observation, e.g., if the current observation suggests that a future forecast or trend has changed, it may be desirable to perform more observations to confirm whether the future trend is likely to be correct. As another example, the mapping system may determine that, taken alone, an observation of a current day for the geographic area on its own may not rise to the level of an anomaly, but nonetheless when considering the current observation in the larger context of a tracked prior (or projected future) trend, it may be useful to recommend performance of (or automatically perform) one or more follow-up observations for the geographic area.

In some embodiments, a trend may correspond to one or more statistics for a particular geographic area of any suitable period of time. For example, for a given county or other geographic area of interest, if the mapping system is tracking deforestation (e.g., a number of trees) tracked across time and is determined to be accelerating or decelerating, the mapping system may recommend or automatically perform a higher resolution image capture to confirm whether such trend is real. Acceleration and deceleration trend lines can be tracked for any suitable mapping category. Any suitable number of (and type of) statistics can constitute a trend for any suitable size or type of geographic area, for one or more of any suitable type of mapping categories.

In some embodiments, for n mapping categories, the mapping system may measure n² changes. Such statistics may measure how much area of each of the n categories is in a current area of interest and how those areas are changing, which can be represented in any suitable numerical form, e.g., a matrix of how one or more of those mapping categories are changing into another category over time. In some embodiments, a commonly applied trend statistic can be applied across all desired geographic areas for any suitable number of mapping categories. In some embodiments, the mapping system may define any suitable statistic or metric based on an observed set of trend lines.

In some embodiments, entity-based memory and conversational system 2308 may be configured to retrieve, monitor, and interrogate geospatial changes via regional metrics and natural language queries. In some embodiments, as shown at 2322, the structure of entity-based memory and conversational system 2308 enables a conversational interface with the database of places and changes indicated at 2318, where such database can store and remember the user's goals and past actions. In some embodiments, as candidate changes and human adjudications accumulate over time, the mapping system may store the candidate changes in a scalable, entity-based database, e.g., entity-based memory and conversational system 2308 which may include the database indicated at 2318. The database may comprise entity-based descriptions of data sources and available analysis tools, enabling recommendations and tasking of follow-up observations. The database of entities and changes may enable structured queries for retrieving types of change for areas and entities of interest based on a number of parameters that include locations, time windows, size of change region (measured in units of area or volume), types of change (e.g. trees to bare ground, or rangeland to built), likelihoods of change, sensors used in the detections, recommendations for follow-up observations, results of follow-up observations, user access logs, and any user actions such as accepting recommendations, modifying recommendations, or rejecting candidate changes, or any other suitable parameters, or any combination thereof. In some embodiments, the database is specifically structured to enable querying by large language models (LLMs), enabling more natural and powerful search across the database, e.g., using retrieval augmented generation (RAG), which may include use of a standard LLM to generate vector embeddings of text and metrics.

Entity-based memory and conversational system 2308 may be structured to include land cover taxonomy information to help convert user requests for synonym classes to land cover classes available in products that may be ordered. In some embodiments, entity-based memory and conversational system 2308 may be structured to include open source spectral index information including index equations and methodology descriptions (and/or any other suitable data from any other suitable source) to enable the LLM system to identify and task computation of useful spectral indices for a given taxonomic land cover class with required spectral bands per sensor.

In some embodiments, entity-based memory and conversational system 2308 includes information of satellite sensors and other satellite observational characteristics such as orbital parameters (e.g., time interval between observations, image swath width, sensor orientation relative to nadir, and/or any other suitable parameters) that enable recommendation of follow-up observations, e.g., which satellite sensors enable calculation of a given spectral index.

In some embodiments, entity-based memory and conversational system 2308 may be structured to include the data needed for the LLM to correctly identify where information is insufficient and thus may require follow-up observations, including confidence or likelihood measures and/or measures of image quality used in the observations. In some embodiments, the LLM may assist the user to search for training datasets matching the taxonomy. Entity-based memory and conversational system 2308 system may include a knowledge schema that is specific to the user's industry or governmental agency, e.g., a user in farming, logistics, or farm insurance may require a schema that tracks a number of agricultural production characteristics that may be specific to individual crops or jurisdictions, or a user in real estate may require a schema that tracks a number of property characteristics that may be specific to types of buildings or localized zoning regulations.

In some embodiments, the structure of entity-based memory and conversational system 2308 enables a conversational interface with the database that can remember the user's goals and actions. The conversational system enables active learning by the mapping system by recommending similarity matches of candidate changes across the database to the user for feedback, e.g., by determining that a particular change in forest in Costa Rica in the year 2023 is similar to this change in forest in Nicaragua in the year 2018 based on a transparent set of metrics. In some embodiments, the structure of the memory system enables an LLM to assist with summarizing changes and trends, and the outcomes of follow-up observations. In some embodiments, the memory system enables automated alerts to users based on longer duration or larger area patterns of change and trends.

In some embodiments, the conversational interface uses natural language to interrogate the contents of the database indicated at 2318 and retrieve relevant information. In some embodiments, the database enables the LLM to connect and compare satellite image observations to other geospatial sources of data such as, for example, geolocated ground sensors and data-logging systems (e.g., rain or stream gauges, “smart” farm machinery, “smart” transportation vehicles, or deployed cameras or microphones). An LLM API may be utilized to process natural language text to queries compatible with the database. In some embodiments, such LLM may be fine-tuned using a proprietary library of geo-spatial prompts and instruction pairs.

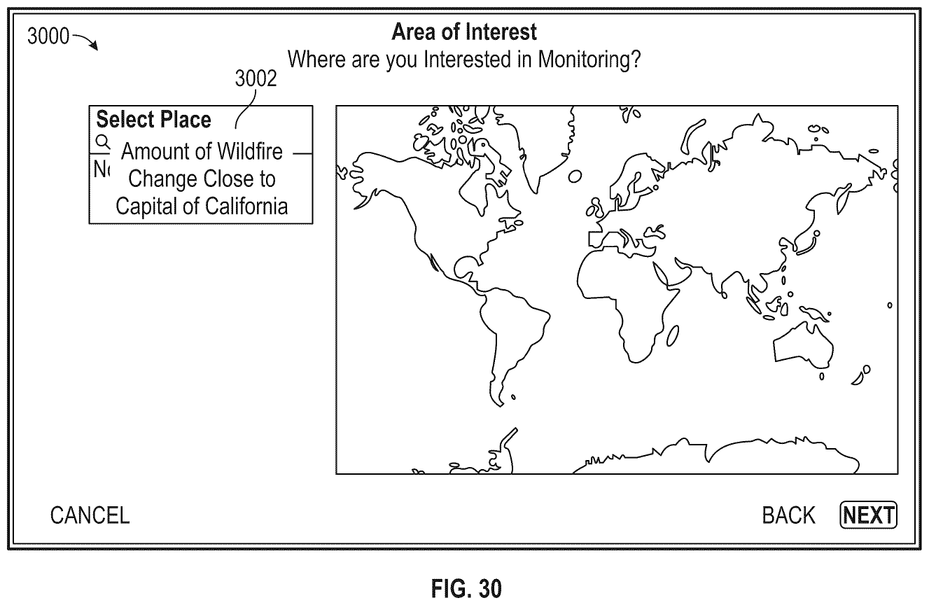

In some embodiments, the similarity search or similarity match is based on distance between metric values for geospatial objects extracted from satellite observations by the AI systems in 2300, 2302, 2304 and/or 2306. For example, a change in a number of km² of trees for all counties in a U.S. State can be used by a resource manager or other user from that State Government (and/or the mapping system may automatically utilize such information) to find the most similar counties to any particular county experiencing tree loss. In some embodiments, the mapping system may provide a search interface for natural language text entry. In some embodiments, chain-of-thought (CoT) prompting may be used to augment the user provided text with context on the specific database scheme to produce a prompt that helps guide the LLM to produce a customized geospatial language query that previously would have required expert formulation, e.g., the user may use search interface 3000 to request “amount of wildfire change close to the capital of California” as shown at 3000 in FIG. 30.

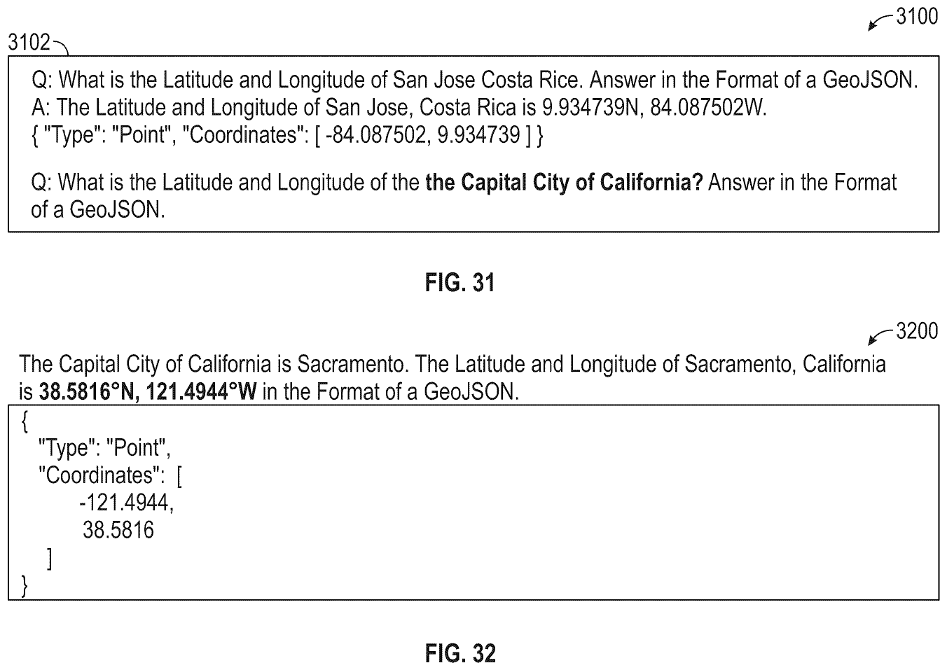

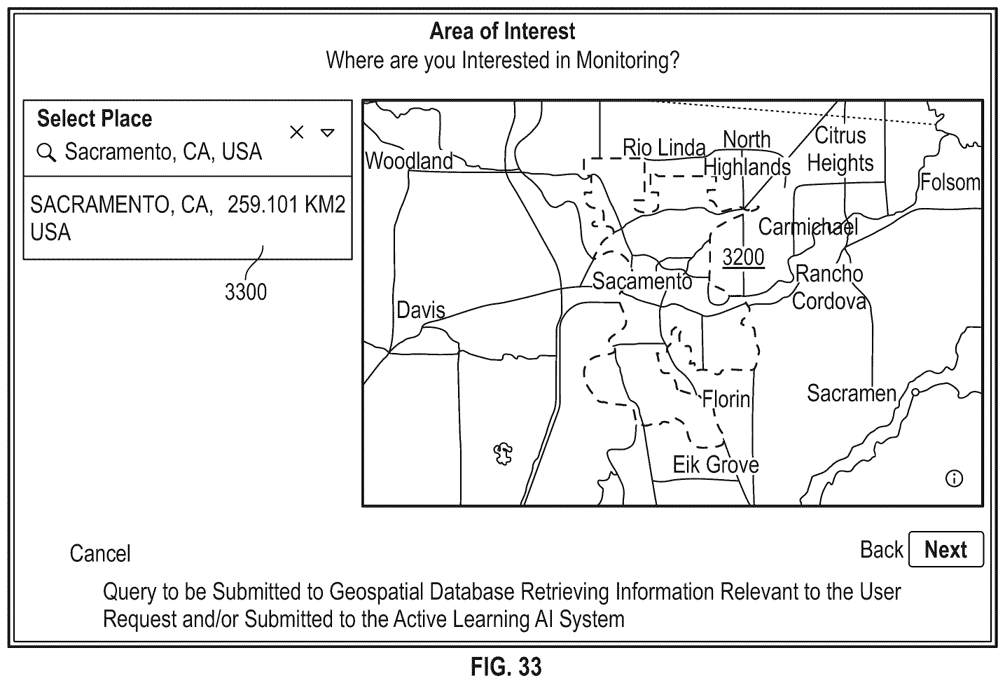

In some embodiments, the mapping system may prepend contextual information on categories of land cover and land cover change supported by the database as a text string and may append output format information required by the database and additional textual commands to guide the LLM through the geospatial reasoning steps used to formulate an accurate answer. In some embodiments, the augmented prompt 3100 and/or 3102 may be submitted to a language model via the LLM API, as shown in FIG. 31. In some embodiments, the response from the LLM is parsed based on the requested output format and either submitted to the database to access existing data, or if the requested data is not available in the database, then the active learning AI system 2306 can recommend new follow-up observations to the user, and can task those follow-up observations with the user's permission. FIG. 31 shows an illustrative user text augmented to produce a prompt 3100, 3102 adapted to the LLM tuned to a geospatial database (e.g., the database indicated at 2318). FIG. 32 shows an illustrative formatted output 3200 returned by the LLM, appropriate for querying the geospatial database (e.g., the database indicated at 2318). FIG. 33 shows a query 3300 to be submitted to the geospatial database, and such database retrieving information (e.g., map 3302) relevant to the user request and/or submitted to active learning AI system 2306. In some embodiments, as shown at 2326 of FIG. 23B, the database indicated at 2318 may request additional data based on resolved changes from active learning AI system 2306.

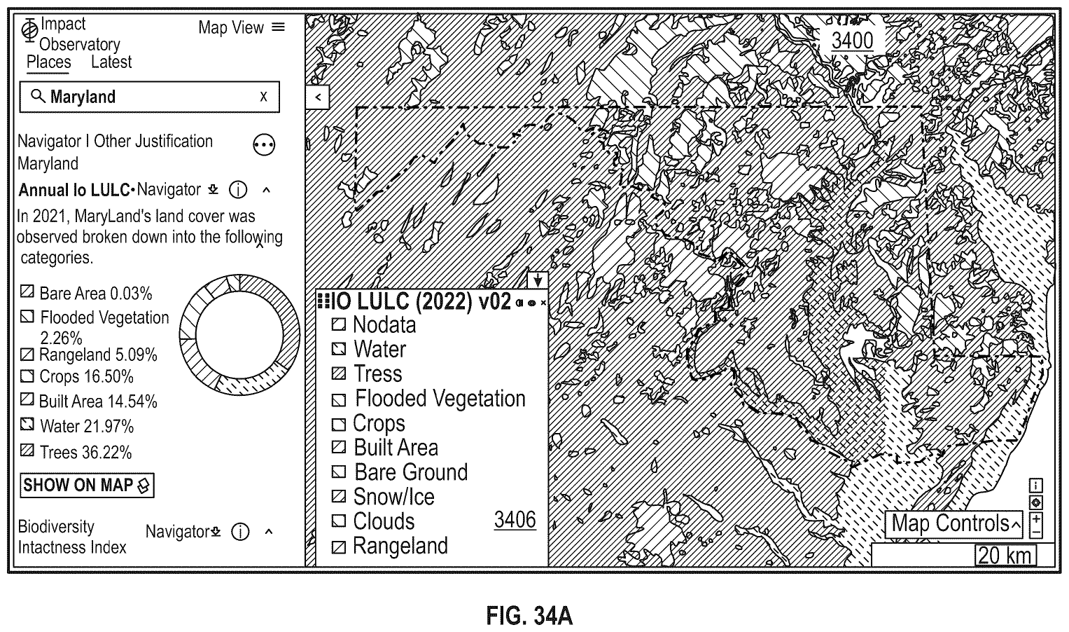

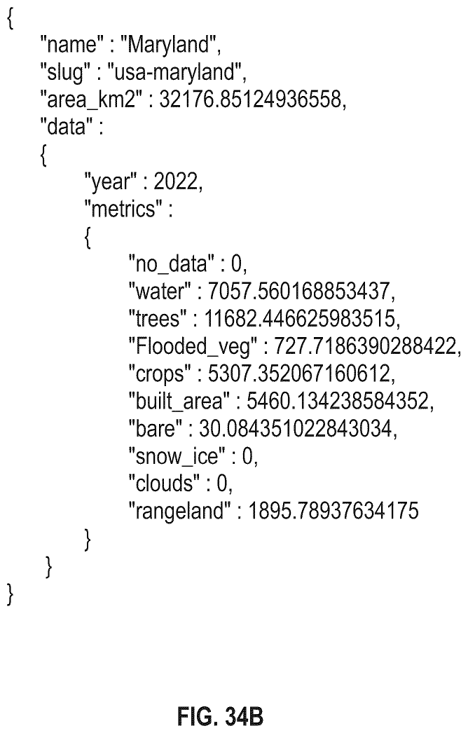

FIG. 34A shows an example of an interface 3400 providing geospatial metrics 3004 associated with a geospatial region 3002 (e.g., the State of Maryland in the U.S.). For example, the metrics may include a graphical representation of percentages of mapping categories determined to be present in Maryland in 2021, e.g., bare area, flooded vegetation, rangeland, crops, built area, water, and trees. The database may store this data in a form that enables structured and natural language querying of the database and quantitative comparisons of regions based on changes of the metrics across time (e.g., mapping categories for 2022 in Maryland are shown at 3006). In some embodiments, interface 3400 may be provided by entity-based memory and conversational system 2308. FIG. 34B shows an illustrative internal database structure of geospatial metrics, e.g., for geospatial region 3002 of FIG. 34A.

In some embodiments, at 2322 of FIG. 23B, the mapping system may receive a user interaction, such as, for example, via plain language, with a dynamic database 2314 of places, metrics, observations, and remote sensing science background information on satellites, sensors, and/or properties of the atmosphere and surface materials, and/or any other suitable data. For example, the mapping system may receive input from a user specifying their places of interest, and the system may initiate automated monitoring, and automated follow-up observations, to resolve changes (e.g., at active learning AI system 2306). In some embodiments, interesting observations and changes can be used as additional training to improve the monitoring and change detection systems (e.g., entity-based memory and conversational system 2308 of FIG. 23A).

As shown at 2324 of FIG. 23B, in some embodiments, user adjudications and outcomes of follow-up observations enables feedback AI system 2310 to generate automated preparation of new training examples for AI model 2301 and/or second stage model 2302, to provide for continual improvement of change filtering based on feedback from active learning. The mapping system may optimize the active learning recommendations over time based on user adjudications and outcomes of follow-up observations. As new sensors and new constellations become available, the system may be extensible to leverage these new sources of imagery and data. In some embodiments, entity-based memory and conversational system 2308 enables periodic review of actions recommended and the outcomes of actions taken, which enables periodic comprehensive retraining of the monitoring system (e.g., entity-based memory and conversational system 2308). In some embodiments, entity-based memory and conversational system 2308 can enable better use of additional datasets comprising features useful for further system learning and enhanced model outputs, including external sources of training data. In some embodiments, the mapping system may add training data for improving global models, as well as fine-tuning of models for regional applications, e.g., training data forests specific to tropical biomes.

The techniques described herein may enable LULC maps to be generated in a faster and more efficient manner, e.g., daily or otherwise as frequently as image data is received. In some embodiments, the techniques described herein may be used for military applications, such as, for example, measuring of natural resources of national security importance, e.g., extracted minerals, oil and gas fields, rubber plantations or any other suitable resources or any combination thereof; monitoring illicit crops (e.g., heroin, cocaine, marijuana or any other illicit crop or any combination thereof); human infrastructure changes in transportation hubs; monitoring changes in airports, roads, ports, road bridge construction; detecting negative changes in infrastructure (e.g., removal of a bridge or destruction of a building). The techniques described herein may utilize high spatial resolution and detect changes in mobile vehicle location (e.g., ships, transportation planes, trucks, technical aircraft, personal vehicles, or any other suitable vehicle, or any combination thereof).

In some embodiments, the techniques described herein may be used by private or public companies or organizations and/or other persons to estimate property values (e.g., based on geospatial data), optionally in conjunction with other data (e.g., census data of an area and/or average income or ratings of schools in an area). For example, the techniques described herein may track and notify a user that over time, map data generated by the mapping system indicates that a neighborhood has been experiencing positive upgrades (e.g., roadwork, more trees plated, more water features such as swimming pools, stable building density, and/or any other suitable factors) and thus property values are likely to be higher than another neighborhood experiencing negative developments (e.g., no road construction or other new construction or upgrades, and/or any other suitable factors).

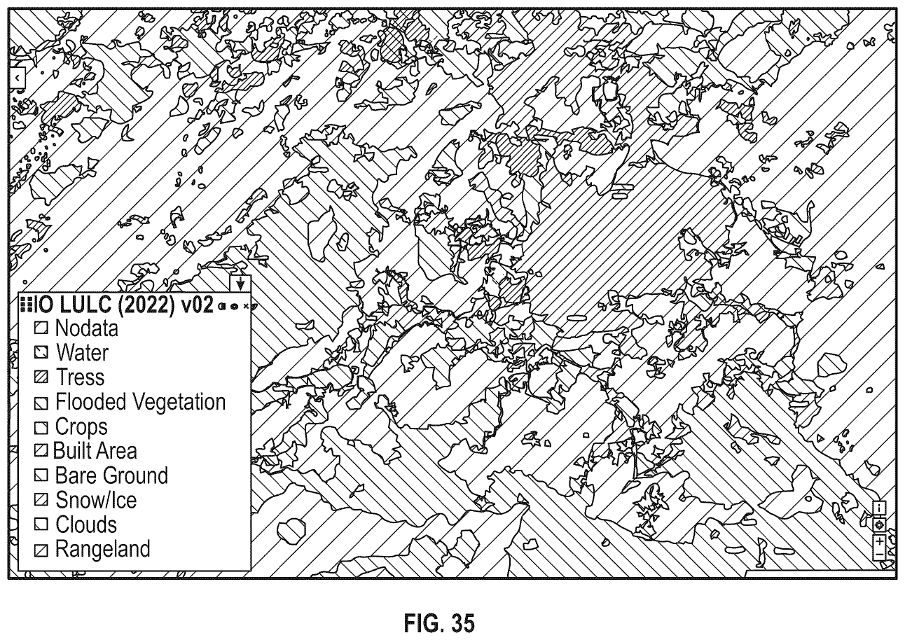

FIG. 35 shows an illustrative LULC map 3500, in accordance with some embodiments of this disclosure. Map 3500 depicts a geographic region corresponding to a portion of the middle east including Syria. The mapping system may receive user input of “Show me the earthquake in Syria in 2023.” A prompt to the LLM API based on such user input may be “what is the latitude and longitude of the earthquake in Syria in 202? Answer in the format of JSON.” The mapping system may receive a response from the LLM API of “On Feb. 6, 2023, at 04:17 TRT (01:17 UTC), a Mw 7.8 earthquake struck southern and central Turkey and northern and western Syria. The epicenter was 37 km (23 mi) west-northwest of Gaziantep 1. Here is its location in GeoJSON format: {“type”: “Point”, “coordinates”: [37.032, 37.166] } IO API Response from {“type”:“Point”,“coordinates”:[37.032, 37.166]}.” In some embodiments, the mapping system may provide relevant links related to the query (e.g., to a Wikipedia or New York Times article on the earthquake).

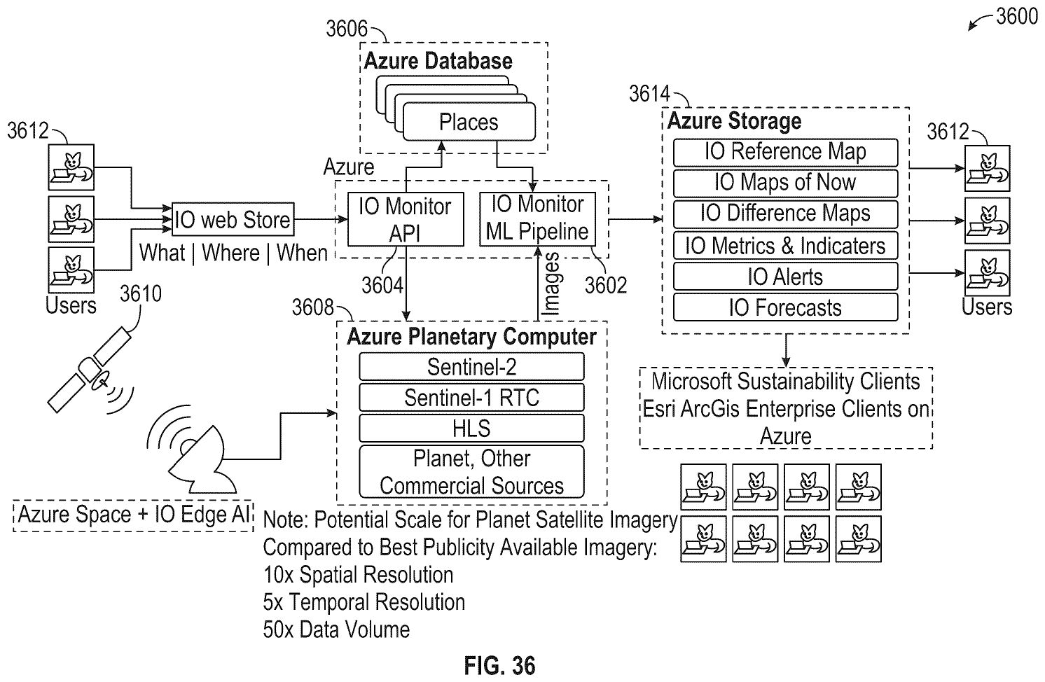

As shown in FIG. 36, in some embodiments, the mapping system can be implemented on Azure Cloud which uses Azure Batch to orchestrate execution of inference on individual chips of satellite images, with execution happening on a dynamically scaled cluster of compute nodes using any suitable cluster framework. FIG. 36 shows architecture for a system 3600 implanting a least a portion of the mapping system on a cloud-based system, such as, for example, Azure. In some embodiments, IO monitor ML pipeline 3602 may comprise one or more of the AI models of system 2300, and IO monitor ML pipeline 3602 and IO monitor API 3604 may communicate with database 2406 (e.g., storing place or locations on earth) and planetary computer 3608. Planetary computer 2408 may store overhead imagery obtained from sources 3610 (e.g., a satellite). User 3612 may be provided with data, e.g., output by IO monitor ML pipeline 3602. Storage 3614 may store maps of various geographic areas around the world, reference maps (e.g., expected distributions of mapping categories for geographic areas at given times), difference maps (e.g., between reference maps and maps of now), and system 3600 may alerts or forecasts, e.g., related to areas of interest to a user 3612.

FIG. 23C shows an illustrative flowchart for system 2300, in accordance with some embodiments of this disclosure. As shown in FIG. 23C, the mapping system enables (e.g., using AI-based techniques) a user to make a high level request in plain language, triggering automated monitoring, alerting, follow-up observations to confirm changes, and assisting with reporting and recommendations. In some embodiments, user guidance may inform automated improvement of the monitoring and alerting systems. For example, at 2330, the mapping system may receive input from a user of “where did China build its newest civilian space launch facility” and/or “when was the most recent expansion of Wenchang spaceport?” The mapping system may use an LLM to interpret and understand such queries, and the LLM may be used to provide answers to the queries (e.g., “China's newest civilian space launch facility is located near the coastal national Wenchang spaceport . . . the facility opened in 2014 and has been used for various launches since then.” As another example, the mapping system may provide the response “the most recent expansion of the Wenchang spaceport in China started in July 2022 and is expected to be completed in 2024. The expansion is part of China's efforts to increase its overall launch rate and establish new facilities needed for crewed lunar missions.” In some embodiments, such replies to queries may be provided based on the monitoring, alerting, following up and confirming, and reporting and recommending at 2332, 2334, 2336, and 2338, respectively.

At 2332, the mapping system may monitor the geographic areas indicated in the query, e.g., China or portions thereof (such as Wenchang), for mapping categories and/or changes in mapping categories over time related to the user query. At 2334, the mapping system may identify a portion of the monitored geographic area as relevant to the user query, and may alert or provide a notification to the user, e.g., via email, text message or via the mapping system platform user interface or in any other suitable manner. In some embodiments, providing the alert, and the following steps 2336 and 2338, may be performed based at least in part on detecting an anomaly in relation to the geographic area of interest related to the query. At 2336, the mapping system may suggest a follow up, or automatically perform a follow up, or receive a follow up query from the user, e.g., “what type of satellite images could I order to follow up on observations of construction at the Wenchang space port?” The mapping system may provide a response indicating that high-resolution imagery, multispectral imagery, and SAR imagery may be used for such observations. At 2338, the mapping system may provide a report (e.g., generated in an automated manner), such as, for example, “Report on Wenchang Spaceport” in response to the user query received at 2330.

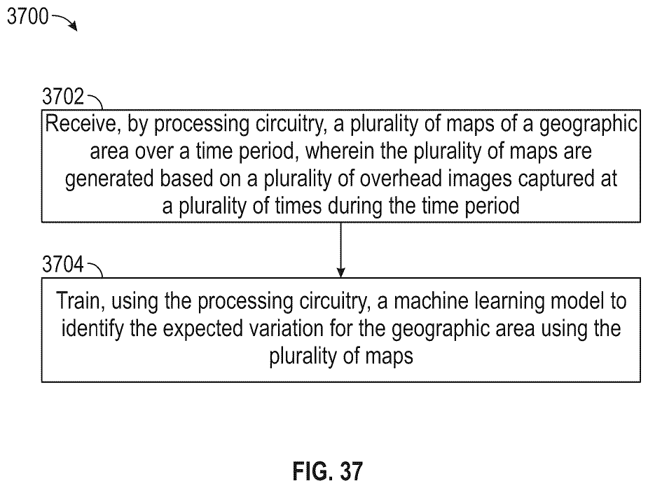

FIG. 37 is a flowchart of a detailed illustrative process for training a machine learning model to identify an expected distribution of mapping categories for a geographic area at a given time, in accordance with some embodiments of this disclosure. In various embodiments, the individual steps of process 3700 may be implemented by one or more components of the devices, methods, and systems of FIGS. 1-36 and 38 and may be performed in combination with any of the other processes and aspects described herein. Although the present disclosure may describe certain steps of process 3700 (and of other processes described herein) as being implemented by certain components of the devices, methods, and systems of FIGS. 1-36 and 38, this is for purposes of illustration only, and it should be understood that other components of the devices, methods, and systems of FIGS. 1-36 and 38 may implement those steps instead.

At 3702, the mapping system may receive, by processing circuitry (e.g., processing circuitry 210 of FIG. 2, processing circuitry 230 of FIG. 2, and/or processing circuitry 220 of FIG. 2), a plurality of maps of a geographic area (e.g., any suitable geographic area of earth). The plurality of maps may be generated based on a plurality of overhead images captured at a plurality of times during the time period, e.g., using the techniques described in FIGS. 1-22. In some embodiments, each map of the plurality of maps may be generated based on a respective plurality of overhead images captured during a respective portion of a time period (e.g., one or more days, weeks, months, years or any suitable portions thereof). In some embodiments, each overhead image of the respective pluralities of overhead images comprises a respective plurality of pixels, and each pixel is designated as being of a particular mapping category of a plurality of mapping categories (e.g., the mapping categories indicated at 2402 of FIG. 24).

At 3704, the mapping system may train, using the processing circuitry (e.g., processing circuitry 210 of FIG. 2, processing circuitry 230 of FIG. 2, and/or processing circuitry 220 of FIG. 2) and the plurality of maps, the machine learning model (e.g., second stage model 2302 of FIG. 23A) to identify the expected distribution for the mapping categories of the geographic area at the given time. For example, historical mapping category data at various previous times may be used to train the machine learning model (e.g., a statistical machine learning model, a Bayesian probabilistic model, a random forest model, a deep learning model, a transformer model using attention heads, or a combination thereof) to predict what mapping category distribution should be present in the geographic area at a past time, a current time or at a future time. As an example, the machine learning model may be trained to output an indication that, based on the training data, a geographic area (e.g., shown at 2400) at a given date (e.g., yesterday) is expected to correspond to 70% other built mapping category, 5% sparse rangeland, 8% active crops, 11% mixed vegetation, and 4% flooded vegetation. In some embodiments, the machine learning model may be trained at least in part using auxiliary geospatial data (e.g., weather data, topographic data, and/or signal emissions data for the geographic area). In some embodiments, the machine learning model may determine one or more trends for the mapping categories of the geographic area over the time period, and further train the machine learning model based at least in part on the determined one or more trends.

In some embodiments, the machine learning model may be trained on mapping category information for any suitable number of geographic areas over any suitable number of time points over any suitable number of and length of time periods. In some embodiments, the time periods may correspond to, e.g., a particular year, and each respective portion of the time period corresponds to a month of the particular year; a plurality of seasons comprising winter, spring, summer, and autumn, and each respective portion of the time period corresponds to a respective season of the plurality of seasons; or a plurality of years, and each respective portion of the time period corresponds to a respective year of the plurality of years. In some embodiments, training the machine learning model causes the machine learning model to learn a temporal distribution of mapping categories and confidences observed for the geographic area over the time period, and the mapping system may generate a vector, based on the temporal distribution of mapping categories and confidences observed for the geographic area over the time period, summarizing variability of mapping categories of the geographic area over the time period.

In some embodiments, the mapping system may further train the machine learning model by determining a set of hyperparameters of the machine learning model based on identifying spatial segments and temporal segments summarizing the respective pluralities of overhead images. The spatial segments may enable identifying a spatially continuous object from groups of the plurality of pixels. The temporal segments enable identifying patterns of nature, seasonal variation, or human activity over the time period.

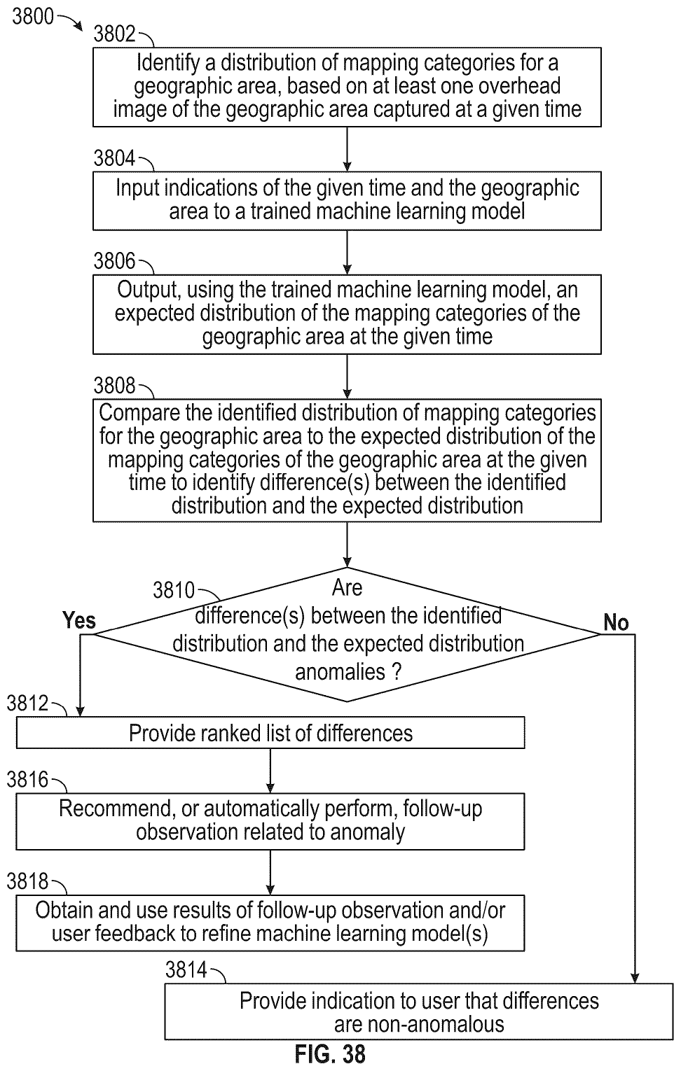

FIG. 38 is a flowchart of a detailed illustrative process 3800 for using a trained machine learning model to identify an anomaly in mapping categories for a geographic area, in accordance with some embodiments of this disclosure. In various embodiments, the individual steps of process 3800 may be implemented by one or more components of the devices, methods, and systems of FIGS. 1-37 and may be performed in combination with any of the other processes and aspects described herein. Although the present disclosure may describe certain steps of process 3800 (and of other processes described herein) as being implemented by certain components of the devices, methods, and systems of FIGS. 1-37, this is for purposes of illustration only, and it should be understood that other components of the devices, methods, and systems of FIGS. 1-37 may implement those steps instead. In some embodiments, process 3800 may be used to monitor changes in LULC in near-real-time, e.g., to enable users to identify dense forest and open woodlands, wet and dry areas, riparian areas, and vegetation health by season for a particular geographic area, and/or show both current water levels and persistent water channels that may be dry at certain times of the year.

At 3802, the mapping system may identify, by processing circuitry (e.g., processing circuitry 210 of FIG. 2, processing circuitry 230 of FIG. 2, and/or processing circuitry 220 of FIG. 2), a distribution of mapping categories for a geographic area, based on at least one overhead image of the geographic area captured at a given time (e.g., a current time, or a time in the past). For example, the mapping system may determine, for each pixel of the at least one overhead image and/or for groups of pixels, a mapping category the pixel or groups of pixel is likely to correspond to. For example, as shown in FIG. 30, the geographic area may correspond to geospatial region 3002 (e.g., the State of Maryland in the U.S.). In some embodiments, 3802 may be performed automatically or based at least in part on received user input.

At 3804, the mapping system may input indications of the given time (e.g., the current time or a time in the past or a time in the future) and the geographic area (e.g., Maryland or one or more portions thereof, or any other suitable geographic area to a trained machine learning model (e.g., the model trained using the process 3700 of FIG. 37). At 3806, the trained machine learning model may output an expected distribution of the mapping categories of the geographic area at the given time. For example, a date that is one month from a current date may be input to the trained machine learning model along with an indication of the geographic area “Maryland,” and the trained machine learning may output indications of expected mapping categories for pixels corresponding to such geographic area, e.g., based on historical trends, such as shown at 3404 of FIG. 34A, what the breakdown of percentages of mapping categories is expected to be at the given time. In some embodiment, an LLM may be used to process and interpret queries and formulate inputs to the trained machine learning model. In some embodiments, 3804-3806 may be performed automatically or based at least in part on received user input.

At 3808, the mapping system may compare the identified distribution of mapping categories for the geographic area to the expected distribution of the mapping categories of the geographic area at the given time to identify difference(s) between the identified distribution and the expected distribution, and at 3810, the mapping system may determine whether difference(s) between the identified distribution and the expected distribution are anomalies. For example, the mapping system may determine whether a difference in any of the mapping categories exceeds a threshold number (e.g., 10% or any other suitable number). In some embodiments, thresholds may be different for different mapping categories, and/or based on different geographical regions and/or based on a current season, temperature, weather patterns, or other events related to the given time and the geographic region. In some embodiments, the mapping system may identify candidate differences or candidate changes between the identified distribution and the expected distribution.

If no differences are determined to be an anomaly, processing may proceed to 3814, where an indication may be provided to the user that none of the difference rise to the level of an anomaly. Otherwise, processing may proceed to 3812.

At 3812, the mapping system may provide a ranked list of the differences, which may include only the differences determined to be anomalies, or all the differences including anomalies and non-anomalies. For example, the mapping system may apply additional analysis of the underlying imagery to characterize changes, e.g., apply additional tests for cloud/haze or shadows, test for other sensor artifacts, and/or any other suitable tests, to filter these candidate changes based on the degree to which they differ from expectations and may triage candidate changes into a set of categories based on their observed features, e.g., “unlikely—missing data”, “unlikely—observational artifact”, “unlikely—natural variability”, “unlikely—normal human activity”, “likely—unusual natural change”, or “likely—unusual man made change”, or “likely—unknown change,” or any other suitable categories, or any combination thereof.

At 3816, the mapping system may recommend, or automatically perform, follow-up observation(s) related to one or more of the anomalies. Any suitable number of factors may be used to determine whether, and if so what type, of follow-up observation to recommend or automatically perform. For example, the mapping system may use a mutable rule table combined with a database of available sensor platforms, time to the next observation for that sensor platform, estimate of the expected monetary cost and expected time to fulfillment of that observation, and expected weather conditions over the location of the candidate change (e.g., cloudy conditions at the location of the candidate change will require waiting longer or choosing a SAR observation), to recommend a follow-up observation, e.g., whether the follow-up observation should be performed.

In some embodiments, the mapping system may fine-tune an LLM that matches observed patterns of change (e.g., forest to crops, or built area to water) to follow-up observational strategies and the specific needs of the user, such as, for example, a time window in which a decision must be made. In some embodiments, the mapping system may employ follow-up observational strategies that take into account estimated cost and complexity of follow-up observations, e.g., an observed change may suggest a higher resolution follow-up which is available from several possible commercial space vendors with a range of data costs and time to delivery factors. In some embodiments, the mapping system may enable users to pre-specify existing image archives, preferred satellite vendors, cost constraints for new observations, and/or any other suitable data.

In some embodiments, the mapping system may receive input from a user of an area of interest (and a timer period the user desires to monitor), and may monitor such area for changes related to a user query (e.g., as shown in the example of FIG. 23C). The mapping system may receive reports and/or notifications notification on where and when changes (e.g., anomalies) are occurring in one or more areas of interest specified by the user.

At 3818, the mapping system may obtain and use results of follow-up observation and/or user feedback to refine machine learning model(s). For example, the mapping system may receive input accepting, modifying or rejecting a candidate difference as an anomaly, and/or accepting, modifying or rejecting a recommended follow-up observation as an anomaly. Such input may be used as feedback to refine and further train the AI models and machine learning models shown in FIG. 23A-23C.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method of training a machine learning model to identify an expected distribution of mapping categories for a geographic area at a given time, comprising:
receiving, by processing circuitry, a plurality of maps of the geographic area, wherein:
each map of the plurality of maps is generated based on a respective plurality of overhead images captured during a respective portion of a time period; and
each overhead image of the respective pluralities of overhead images comprises a respective plurality of pixels, and each pixel is designated as being of a particular mapping category of a plurality of mapping categories; and
training, using the processing circuitry and the plurality of maps, the machine learning model to identify the expected distribution for the mapping categories of the geographic area at the given time.

2. The method of claim 1, further comprising:
receiving, by the processing circuitry and for each geographic area of a plurality of geographic areas, a respective plurality of maps, wherein:
for each geographic area of the plurality of geographic areas, the respective plurality of maps is generated based on a respective plurality of overhead images captured during a respective portion of a time period; and
each pixel of each respective plurality of overhead images is designated as being of a particular mapping category of a plurality of mapping categories;
wherein training the machine learning model is further performed using the respective pluralities of maps for the plurality of geographic areas, to identify an expected distribution for mapping categories of a particular geographic area of the plurality of geographic areas at a particular time.

3. The method of claim 1, wherein training the machine learning model causes the machine learning model to learn a temporal distribution of mapping categories and confidences observed for the geographic area over the time period, and the method further comprises generating a vector, based on the temporal distribution of mapping categories and confidences observed for the geographic area over the time period, summarizing variability of mapping categories of the geographic area over the time period.

4. The method of claim 1, wherein the time period corresponds to:
a particular year, and each respective portion of the time period corresponds to a month of the particular year;
a plurality of seasons comprising winter, spring, summer, and autumn, and each respective portion of the time period corresponds to a respective season of the plurality of seasons; or
a plurality of years, and each respective portion of the time period corresponds to a respective year of the plurality of years.

5. The method of claim 1, wherein the machine learning model is a statistical machine learning model, a Bayesian probabilistic model, a random forest model, a deep learning model, a transformer model using attention heads, or a combination thereof.

6. The method of claim 1, wherein training the machine learning model further comprises:
using auxiliary geospatial data as a parameter during training of the machine learning model, wherein the auxiliary geospatial data comprises at least one of weather data, topographic data, or signal emissions data for the geographic area.

7. The method of claim 1, further comprising:
determining one or more trends for the mapping categories of the geographic area over the time period,
wherein training the machine learning model is further based on the determined one or more trends.

8. The method of claim 1, wherein training the machine learning model further comprises:
determining a set of hyperparameters of the machine learning model based on identifying spatial segments and temporal segments summarizing the respective pluralities of overhead images.

9.-14. (canceled)

15. A method comprising:
identifying a distribution of mapping categories for a geographic area, based on at least one overhead image of the geographic area captured at a given time;
inputting indications of the given time and the geographic area to a trained machine learning model;
outputting, using the trained machine learning model, an expected distribution of the mapping categories of the geographic area at the given time;
comparing the identified distribution of mapping categories for the geographic area to the expected distribution of the mapping categories of the geographic area at the given time to identify a difference between the identified distribution and the expected distribution; and
determining whether the difference between the identified distribution and the expected distribution is an anomaly.

16. The method of claim 15, wherein the trained machine learning model is trained using a plurality of maps of the geographic area, and wherein:
each map of the plurality of maps is generated based on a respective plurality of overhead images captured during a respective portion of a time period; and
each overhead image of the respective pluralities of overhead images comprises a respective plurality of pixels, and each pixel is designated as being of a particular mapping category of a plurality of mapping categories.

17. The method of claim 15, wherein:
the comparing comprises identifying a plurality of candidate differences between the identified distribution and the expected distribution; and
determining whether the difference between the identified distribution and the expected distribution is an anomaly comprises ranking the plurality of candidate differences based on a degree to which a respective candidate difference of the plurality of candidate differences differs from the expected distribution.

18. The method of claim 17, wherein the ranking further comprises:
categorizing each respective candidate difference of the plurality of candidate differences based on a likelihood that the respective candidate difference is an anomaly, each categorization including an indication of an observed feature related to whether the respective candidate difference is an anomaly.

19. The method of claim 18, further comprising:
storing the plurality of candidate differences, and each respective categorization, in an unstructured database.

20. The method of claim 15, wherein identifying the difference between the identified distribution and the expected distribution further comprises:
applying spatial clustering to segment spatially adjacent pixels of the at least one overhead image, likely to correspond to the difference between the identified distribution and the expected distribution, into an entity described by a vector.

21. The method of claim 15, further comprising:
based on whether the difference is determined to be an anomaly, recommending performance of, or automatically performing, a follow-up observation of the geographic area.

22. The method of claim 21, wherein the recommending of the performance of, or the automatic performance of, the follow-up observation of the geographic area is performed based on receiving user feedback accepting the difference as an anomaly.

23. The method of claim 21, wherein:
a type of the difference comprises a first mapping category indicated in the identified distribution for a portion of the geographic area being different from a second mapping category indicated in the expected distribution for the portion of the geographic area; and
the follow-up observation is identified based on the type of the difference.

24.-30. (canceled)

31. A system of training a machine learning model to identify an expected distribution of mapping categories for a geographic area at a given time, comprising:
processing circuitry configured to:
receive a plurality of maps of the geographic area, wherein:
each map of the plurality of maps is generated based on a respective plurality of overhead images captured during a respective portion of a time period; and
each overhead image of the respective pluralities of overhead images comprises a respective plurality of pixels, and each pixel is designated as being of a particular mapping category of a plurality of mapping categories; and
train, using the plurality of maps, the machine learning model to identify the expected distribution for the mapping categories of the geographic area at the given time.

32. The system of claim 31, wherein the processing circuitry is further configured to:
receive, for each geographic area of a plurality of geographic areas, a respective plurality of maps, wherein:
for each geographic area of the plurality of geographic areas, the respective plurality of maps is generated based on a respective plurality of overhead images captured during a respective portion of a time period; and
each pixel of each respective plurality of overhead images is designated as being of a particular mapping category of a plurality of mapping categories;
train the machine learning model further using the respective pluralities of maps for the plurality of geographic areas, to identify an expected distribution for mapping categories of a particular geographic area of the plurality of geographic areas at a particular time.

33. The system of claim 31, wherein training the machine learning model causes the machine learning model to learn a temporal distribution of mapping categories and confidences observed for the geographic area over the time period, and the processing circuitry is further configured to generate a vector, based on the temporal distribution of mapping categories and confidences observed for the geographic area over the time period, summarizing variability of mapping categories of the geographic area over the time period.

34.-90. (canceled)
